(19) United States
(12) Patent Application Publication
(10) Pub. No.: US 2022/0284470 A1
(43) Pub. Date: Sep. 8, 2022

(54) SYSTEM AND METHOD FOR ENHANCING VEHICLE PERFORMANCE USING MACHINE LEARNING

(71) Applicant: Continental Automotive Systems, Inc., Auburn Hills, MI (US)

(72) Inventors: Robert Allen Gee, Lake Barrington, IL (US); Robert F. D'Avello, Lake Zurich, IL (US); Brian Droessler, Grayslake, IL (US); Themi Anagnos, La Grange Park, IL (US); Tomasz J. Kaczmarski, Lake Forest, IL (US); Christopher Bezak, Milford, MI (US)

(21) Appl. No.: 17/692,835

(22) Filed: Mar. 11, 2022

Related U.S. Application Data
(63) Continuation-in-part of application No. 15/575,201, filed on Nov. 17, 2017, now Pat. No. 11,348,053.
(60) Provisional application No. 62/164,183, filed on May 20, 2015.
(60) Provisional application No. 62/164,187, filed on May 20, 2015.

(51) Int. Cl. G06Q 30/02; G06N 3/08

(52) U.S. Cl. CPC G06Q 30/0251; G06N 3/08

(57) ABSTRACT

A machine learning algorithm, for example, a neural network, is trained to offer predictions, recommendations, and/or insights regarding vehicle components, products or services that are customized to a particular driver. The trained machine learning algorithm is subsequently deployed.

### CROSS-REFERENCE TO RELATED APPLICATIONS

This application is a continuation-in-part of U.S. application Ser. No. 15/575,201 filed Nov. 17, 2017, which is a national stage entry of International Application No. PCT/US2016/032725, filed May 16, 2016, which claims priority to U.S. Provisional Application No. 62/164,183 filed on May 20, 2015, and U.S. Provisional Application No. 62/164,187 filed on May 20, 2015, all of which are herein incorporated by reference in their entireties.

### BACKGROUND

### 1. Technical Field

This application relates generally to the field of vehicle technology.

### 2. Description of Related Art

The application relates generally to the field of vehicle technology.

### SUMMARY

While the application is subject to various modifications and alternative forms, specific embodiments thereof are shown by way of example in the drawings and the accompanying detailed description. It should be understood, however, that the drawings and detailed description are not intended to limit the application to the particular embodiments. This disclosure is instead intended to cover all modifications, equivalents, and alternatives falling within the scope of the present application as defined by the appended claims.

In aspects, the approaches described herein offer options, recommendations, predictions, and insights to consumers of a vehicle (e.g., automobiles) and vehicle (e.g., automobile) components. In one specific example, predictive recommendations are made to provide specific offers, such as consumer recommendations for the purchase of tires, brake pads, rotors and similar products.

Today, consumers have little to no information on the wide array of vehicle product choices available and their suitability to the consumer. For example, if a consumer either needs or wants replacement tires on their vehicle the consumer can typically obtain little or no research information such as performance information. The consumer may review magazine testing of tires such as from “Consumer Reports,” “Motor Trend” and “Car and Driver” and from web search engine results and sites that might provide vague and inconsistent user reviews and information. However, the information on tire testing is limited to just a few tires of the potentially hundreds or thousands of potential tire brand and models. Also, the testing information provided is based on very limited driving conditions, such as only one temperature, and very limited conditions such as wet and dry, cornering or braking. Performance under wet conditions varies widely depending on the amount of standing water, the temperature, the speed, the tire size such as the width, height, and diameter the tread, the compound and many other variables affecting wet grip. Similarly, tire performance under other conditions such as dry, snow, cold and humidity for example significantly affect performance while the tire design significantly affects tire performance. A tire review or user recommendations does not cover performance across the spectrum of conditions and tire specifications the consumer requires. For example, a consumer may buy a tire in the summer that seems suitable but in ice or snow the tire is unsuitable and dangerous. The consumer will have no choice but to quickly buy tires in the winter at a time when selection and pricing are unfavorable.

Another problem with current tire performance information is that the tested tires are limited to one size. However, the same tire brand and model may perform very differently in another size, such as diameter, width, side wall height, speed rating and so forth. Many consumers simply ask a tire salesman for their recommendation who may only recommend tires they stock and can sell most profitably and not based on the optimal performance and price requirements of a consumer. Web search engines are biased by the advertisers paying the web search engine operator so even if a user types one name of a tire brand, advertisements for another brand is produced because that brand is a paid advertiser. User reviews like Amazon reviews can be faked and thus can be very unreliable sources of tire information. As a result, consumers have very little to no information and will select a tire that is not optimal in price and performance or unfortunately unsuitable for the consumer. Thus, this conventional method of manual researching, shopping and purchasing results in tires that do not meet the requirements of the consumer thus leading to suboptimal and dangerous tire performance, excessive replacement of tires, crash, collisions and unnecessary wasted time and money.

With the present invention and in some aspects, a data analytics engine comprehensively reviews a consumer's vehicle requirements and determines if a vehicle component either needs to be replaced or improved with a component that is better suited. The data analytics engine is trained by and can review highly detailed and extensive information on vehicle products described below. According to one embodiment, the data analytics engine provides optimal recommendations for components at the ideal price and performance requirements of the consumer. Currently commercial publications such as tire magazines rate tires very generally. However the advertisers of the publications can influence and bias the results to favor the advertiser rather than provide unbiased results and opinions. Moreover, component manufacturers perform extensive product testing of their own products as well as of their competitors. For example, a tire manufacturer may have extensive tire testing information of their tires. These manufacturers maintain their information in confidence and thus a consumer does not have access to this information for making a purchase decision. The data analytics engine can access the tire testing and performance data from each manufacture and maintain the information in confidence while assessing and matching the consumer's requirements to information to provide an optimal recommendation. The data analytics engine has extensive comprehensive product information from manufactures as well as actual real would performance data from consumers and vehicles and thus can match the optimal product to a consumer's requirements. Thus, the data analytics engine recommendations are superior to conventional magazine and web reviews.

The user can customize the recommendations based on a percentage relevancy score and select the desired products based on vehicle and driver data. For example, a data analytics engine can search for local shops and installers, make an appointment according to the user's calendar and apply coupons, rebates or incentives for the original equipment manufacturer (OEM), manufacturer, installer, dealer and/or repair facility. This comprehensive approach goes well beyond the on-board diagnostics (OBD) repair of problems, but further predicts replacement of wear parts and performs all the consumer due diligence of evaluating testing, performance and pricing of all relevant available options.

The various approaches use data models, vehicle data, and/or external data. Combinations of these elements are also utilized. A data analytics engine may be utilized to make predictions, recommendations, or insights based upon data models, vehicle data, and/or external data.

Products/services data models may include data structures that include performance information for products such as tires. Information on tires may include, for example, tire information such as wear patterns and other performance based on temperature, road surface, load, acceleration, and so forth. Other examples of such products/services data models may include brakes, engine oil, transmission oil, oil filters, air filters, spark plugs, fuel, engine-mapping units, turbo chargers, pressure and oxygen sensors, light bulbs, and superchargers to mention a few examples.

Vehicle data may include data collected from one or more sensors on a vehicle. Vehicle data may include road conditions, personal driving style data, wear indicators, and vehicle-related products/services. Other examples are possible.

Vehicle data may contain information associated with one or more vehicle-related products and/or services. Vehicle data may be provided to a data analytics engine for processing. In some examples, the data analytics engine may be configured to generate predictive information that is associated with vehicle data and/or the one or more products/services. It should be noted that vehicle data may be received from multiple vehicles/drivers and merged together by the data analytics engine.

When multiple drivers share a vehicle, each set of the vehicle data may be associated with the driver's identity and be used during the determination of the predictive information. For example, using data from a brake-wear sensor, an amount of brake-wear per mile may be attributed to each driver, etc.

Vehicle data may include data from sensors on the vehicle as well as other vehicle data (such as environmental data, vehicle history, etc.). Such vehicle data may include weather data, road conditions, personal driving style data, vehicle chassis conditions, wear indicators for several parts, etc. Other examples of vehicle data may include data from on-board radar, light decision and ranging (LIDAR), cameras, ultrasonic sensors, global navigation satellite system (GNSS), accelerometers, antilock braking system (ABS)/electronic stability control (ESC) sensors, and other vehicle environmental sensors. Other examples are possible.

External data may be related to the one or more products/services and may be data received from one or more external sources other than the vehicle(s). In some embodiments, external data may include map-based data such as road functional class, conditions of various segments of the road, construction areas, road curvature, altitude maps, typical average speeds of various road segments, reported incidents, etc. External data may include data that is related to the products/services, such as performance and test data of related products like tires, brake pads, rotors, gasoline, and environmental data for example.

In aspects, a data analytics engine is configured to combine products/services models with vehicle data and external data in determining predictive information. The data analytics engine may be implemented using various methods. Data analytics engine may utilize simple curve-fitting methods, neural networks, artificial intelligence methods, machine learning algorithms, and combinations of these approaches.

Predictive information may include information related to products/services that can be provided to the vehicle and/or the vehicle's driver. In some embodiments, the predictive information, based at least in part on provided vehicle data, may include products/services recommendations that are personalized to the driver/vehicle. Such personalized recommendations may include optimum equipment replacements, upgrade recommendations, service providers, and so forth.

In aspects, these approaches predict a consumer's needs, recommend and offer to consumers of automobiles and automobile components predictive recommendations to provide specific offers such as tires, brake pads, rotors and similar products. For example, the present approaches can provide owners and operators of vehicles optimal parts based on performance and cost. The operators benefit by avoiding the need to spend extensive time researching parts and wasting time for installation estimates. Another advantage is avoiding buying wrong, out of date or suboptimal parts. These approaches save the operator time and money and result in the best performance and cost customized for the operator.

Advantageously, the approaches described herein leverage existing extensive test data sets for components such as tires, brake pads, belts as well as data of or concerning competitors. The present approaches enable highly effective artificial intelligence (AI) powered user specific advertising and may utilize an extensive database of performance information, like consumer reports. Social responsibility is fostered by speaking up for disadvantaged and those unable or without resources to research the fast number of options. This reduces cost and helps those economically disadvantaged.

The present approaches provide new market insights in useful advertising directly to the automobile operator. New technology knowledge is created including AI based on extensive product performance and test information.

These approaches advantageously reduce waste by eliminating incorrect, suboptimal or needlessly expensive automotive parts. In aspects, a uniformed consumer buys tires from a retailer based on the retailer's old, expensive stock that is not optimized for the buyer resulting in an unhappy buyer. For example, once old tires are mounted on a car, the driver notices the tires have no traction in the winter or snow but after the warranty expired, forcing the driver to dispense of the ineffective tires that end up in a waste or dump. The present approaches eliminate or greatly reduce the risk of users buying the wrong car parts.

The present approaches offer specific products that specifically are ideal for the operator/user. This product and service also allows the development of requirements specifically tailored to a profitable market segment.

In many of these embodiments, first data is obtained from sensors of a vehicle, the vehicle being driven by a driver, the data being utilized to determine conditions of components of the vehicle and specifying or describing an individual driving pattern of the driver. Second data is obtained from other drivers, the data describing driving patterns of the other drivers. Third data concerning operating parameters of the components of the vehicle is also obtained.

A neural network (or other machine learning algorithm or approach) is trained based upon the first data, the second data, and/or the third data. The trained neural network makes predictions or recommendations, or offers insights concerning one or more of (1) vehicle components of the vehicle, (2) upgrades to the vehicle components, (3) and maintenance events related to the components.

The training process creates a trained neural network. The training of the neural network is accomplished by differently weighting the importance of the first data, the second data, and the third data.

Subsequently, the trained neural network is deployed. Subsequent to the deployment, one or more operational inputs are received from the sensors, from the driver, and/or from an external source. The one or more operational inputs are applied to the trained neural network, the processing of the trained neural network yielding an insight, recommendation, or prediction concerning one or more of: (1) the components of the vehicle, (2) the upgrades to the components, (3) and the maintenance events related to the components.

A control circuit determines an action based upon the insight or prediction. The action is one or more of: the control circuit determining an upgrade of a first selected one of the components of the vehicle and sending first signals to the driver describing the recommended upgrade, and the upgraded first selected one of the components is to be installed in the vehicle; the control circuit sending a control signal to a second selected vehicle component to control or change an operating parameter of the second vehicle component; the control circuit recommending or forming a recommendation for a product or service to the driver based upon the insight or prediction and sending second signals to the driver describing the recommended product or service; the control circuit recommending maintenance of the vehicle to the driver based upon the insight or prediction and sending third signals to the driver describing the maintenance and the vehicle is to be serviced and at least one of the components changed according to the maintenance event; the control circuit forming and sending an advertisement; and/or the control circuit forming a customer order for a part to be placed in the vehicle, the order transmitted to a manufacturer causing the part to be manufactured by a manufacturer.

In aspects and after the deployment of the trained neural network, the trained neural network may be refined, retrained, or restructured to reflect the continued changes to the driving pattern of the driver.

In examples, the first signals, second signals, and third signals are rendered to the driver using a smart phone, personal computer, laptop, or tablet. In other aspects, the first signals, second signals, and third signals are rendered to the driver using a display unit integrated with the vehicle.

In other examples, the weighting assigns the first data a greater importance than the second data or the third data.

In examples, the operational input comprises a request from the driver concerning a replacement part. In other examples, the operational input comprises data from the sensors.

In other aspects, the neural network is deployed at a central location. Other examples of deployment locations (or combinations of different deployment locations such as at the vehicle and/or at a central location) are possible.

In some other examples, the first data from the sensors includes one or more of weather data, road conditions, personal driving style data, vehicle chassis conditions, wear indicators for several parts. Other examples are possible.

In other examples, the sensors include one or more of radar, LIDAR sensors, cameras, ultrasonic sensors, GNSS sensors, accelerometers, ABS/ESC sensors, and vehicle environmental sensors. Other examples are possible.

In still others of these embodiments, a trained neural network (or other machine learning algorithm or approach) is deployed. Subsequently, one or more operational inputs are received from sensors of a vehicle, from a driver of the vehicle, or from an external source. The one or more operational inputs are applied to the trained neural network, the processing of the trained neural network yielding an insight, recommendation or prediction concerning one or more of: (1) the components of the vehicle, (2) the upgrades to the components, (3) and the maintenance events related to the components.

A control circuit determines an action based upon the insight or prediction, the action being one or more of: the control circuit determining an upgrade of a first selected one of the components of the vehicle and sending first signals to the driver describing the recommended upgrade, wherein the upgraded first selected one of the components is to be installed in the vehicle; the control circuit sending a control signal to a second selected vehicle component to control or change an operating parameter of the second vehicle component; the control circuit recommending a product or service to the driver based upon the insight or prediction and sending second signals to the driver describing the recommended product or service; the control circuit recommending maintenance of the vehicle to the driver based upon the insight or prediction and sending third signals to the driver describing the maintenance and the vehicle is to be serviced and at least one of the components changed according to the maintenance event; the control circuit forming and sending an advertisement; and/or the control circuit forming a customer order for a part to be placed in the vehicle, the order transmitted to a manufacturer causing the part to be manufactured by a manufacturer.

In aspects the trained neural network is obtained by training a neural network, the training comprising: receiving first data from the sensors of a vehicle, the vehicle being driven by a driver, the data describing conditions of components of and specifying an individual driving pattern of the driver; receiving second data from other drivers, the second data describing driving patterns of the other drivers; receiving third data concerning operating parameters of the components of the vehicle.

The neural network is trained based upon the first data, the second data, and the third data, the trained neural network making predictions, recommendations or insights concerning one or more of (1) vehicle components of the vehicle, (2) upgrades to the vehicle components, (3) and maintenance events related to the components, the training creating a trained neural network. The training of the neural network is accomplished by differently weighting the first data, the second data, and the third data.

In others of these embodiments, a system for enhancing vehicle performance includes a plurality of sensors, a neural network (or other machine learning algorithm or approach), and a control circuit.

The sensors are deployed at a vehicle and may be configured to obtain first data, the vehicle being driven by a driver, the first data describing conditions of components of and specifying an individual driving pattern of the driver. The control circuit is coupled to the sensors and the neural network.

The control circuit is configured to: receive the first data; receive second data from other drivers, the second data describing driving patterns of the other drivers; and receive third data concerning operating parameters of the components of the vehicle, the third data stored in a database; train a neural network based upon the first data, the second data, and the third data, the trained neural network making predictions concerning one or more of (1) vehicle components of the vehicle, (2) upgrades to the vehicle components, (3) and maintenance events related to the components

The training of the neural network is accomplished by differently weighting the first data, the second data, and the third data.

The control circuit is further configured to receive one or more operational inputs from the sensors, from the driver, or from an external source and applying the one or more operational inputs to the trained neural network, the application yielding an insight or prediction from the trained neural network concerning one or more of: (1) the components of the vehicle, (2) the upgrades to the components, (3) and the maintenance events related to the components.

The control circuit determines an action based upon the insight or prediction, the action being one or more of: the control circuit determining an upgrade of a first selected one of the components of the vehicle and sending first signals to the driver describing the recommended upgrade, wherein the upgraded first selected one of the components is to be installed in the vehicle; the control circuit transmitting a control signal to a second selected vehicle component to control or change an operating parameter of the second vehicle component; the control circuit recommending a product or service to the driver based upon the insight or prediction and transmitting second signals to the driver describing the recommended product or service; the control circuit recommending maintenance of the vehicle to the driver based upon the insight or prediction and transmitting third signals to the driver describing the maintenance and the vehicle is to be serviced and at least one of the components changed according to the maintenance event; the control circuit determining and outputting an advertisement; and the control circuit forming a customer order for a part to be placed in the vehicle, the order to be transmitted to a manufacturer causing the part to be manufactured by a manufacturer.

In aspects, the trained neural network is retrained to reflect the continued changes to the driving pattern of the driver.

In examples, the first signals, second signals, and third signals are rendered to the driver using a smart phone, personal computer, laptop, or tablet. In other examples, the first signals, second signals, and third signals are rendered to the driver using a display unit integrated with the vehicle.

In still other examples, the weighting assigns the first data a greater importance than the second data or the third data. In yet other examples, the operational input comprises a request from the driver concerning a replacement part.

In other examples, the operational input comprises data from the sensors.

In other aspects, the neural network is deployed at a central location.

In still other examples, the first data from the sensors includes one or more of weather data, road conditions, personal driving style data, vehicle chassis conditions, wear indicators for several parts.

In other examples, the sensors include one or more of radar, LIDAR sensors, cameras, ultrasonic sensors, GNSS sensors, accelerometers, ABS/ESC sensors, and vehicle environmental sensors.

In others of these embodiments, a server includes a transmitter and receiver device, a neural network (or other machine learning algorithm), and a control circuit. The neural network has been trained with training data sets.

The control circuit is coupled to the transmitter and receiver device and the neural network. The control circuit is configured to receive via the transmitter and receiver device one or more operational inputs from sensors of a vehicle, from a driver of the vehicle, or from an external source and apply the one or more operational inputs to the trained neural network. The applying yields an insight, recommendation, or prediction from the trained neural network concerning one or more of: (1) the components of the vehicle, (2) the upgrades to the components, (3) and the maintenance events related to the components.

The insight, recommendation, or prediction includes or identifies one or more actions for the control circuit to take. The one or more actions of the control circuit comprise: determining an upgrade of a first selected one of the components of the vehicle and sending first signals to the driver describing the recommended upgrade, wherein the upgraded first selected one of the components is to be installed in the vehicle; sending a control signal to a second selected vehicle component to control or change an operating parameter of the second vehicle component; recommending a product or service to the driver based upon the insight or prediction and sending second signals to the driver describing the recommended product or service; recommending maintenance of the vehicle to the driver based upon the insight or prediction and sending third signals to the driver describing the maintenance and the vehicle is serviced and at least one of the components changed according to the maintenance event; forming and sending an advertisement; or forming a customer order for a part to be placed in the vehicle, the order transmitted to a manufacturer causing the part to be manufactured by a manufacturer.

In aspects, the server is deployed at a central location to service a plurality of vehicles. In other aspects, the components of the vehicle comprise tires, brakes, brake pads, or electronic components. Other examples are possible.

In still others of these embodiments, user equipment includes a transmitter and receiver device, a user interface, an electronic memory device, and control circuit.

The control circuit is coupled to the transmitter and receiver device and the user interface. The control circuit is configured to receive via the transmitter and receiver device one or more operational inputs from sensors of a vehicle, from a driver of the vehicle, or from an external source; store the data in the electronic memory; cause the one or more operational inputs to be applied to a trained neural network, the processing of the trained neural network yielding an insight, recommendation, or prediction concerning one or more of: (1) the components of the vehicle, (2) the upgrades to the components, (3) and the maintenance events related to the components.

The insight, recommendation, or prediction identify one or more actions and the one or more actions comprise: determining an upgrade of a first selected one of the components of the vehicle and displaying the suggested upgrade to the driver via user interface; sending a control signal to a selected vehicle component to control or change an operating parameter of the vehicle component; recommending a product or service to the driver based upon the insight or prediction and displaying the recommended product or service to the driver via the user interface; recommending maintenance of the vehicle to the driver based upon the insight or prediction and displaying the recommended maintenance to the driver via the user interface; forming and sending an advertisement; or forming a customer order for a part to be placed in the vehicle, the order transmitted to a manufacturer causing the part to be manufactured by a manufacturer.

In aspects, the data stored in the electronic memory is selectively made available or transmitted to third parties. In other aspects, the neural network is deployed at a central location and inputs are sent to the central location.

In yet other examples, the neural network is deployed at the vehicle. In still other examples, the user equipment is a smartphone, cellular phone or other mobile phone device.

In still other aspects, the user equipment comprises an automobile subsystem selected from the group comprising: a telematics device or system, an infotainment system, or a screen mirror.

In yet other examples, the user equipment is implemented at least partially virtually. In still other examples, the neural network is trained according to a trial-and-error approach.

Many of the approaches described herein utilize machine learning approaches and structures. It will be appreciated that these approaches may also be implemented by using fixed algorithms and are algorithmic in nature. By “fixed algorithms” or by “algorithmic,” it is meant, that functions are implemented according to a fixed algorithm and not by a machine learning approach. These fixed algorithms are typically implemented by hard-coded software or computer instructions and no training using test data is needed or required. It will also be appreciated that the approaches described herein may be implemented as combinations of algorithms and machine learning approaches where some functions are implemented algorithmically and others are implemented according to machine learning approaches.

In still other aspects, pre-processing of the operational inputs is performed. In examples, the pre-processing may include organizing, compressing, aggregating, or normalizing the operational inputs before the data is ingested by the data analytics engine. Other examples of pre-processing the data are possible.

### BRIEF DESCRIPTION OF THE DRAWINGS

Other objects and advantages of the application may become apparent upon reading the detailed description and upon reference to the accompanying drawings, in which:

FIG. 1 is a diagram illustrating a system configured to predict information associated with vehicle products/services, in accordance with some embodiments;

FIG. 2 is a diagram illustrating an alternative system configured to predict information associated with vehicle products/services, in accordance with some embodiments;

FIG. 3 is a diagram illustrating a system configured to create and/or improve products/services models associated with one or more vehicle products/services, in accordance with some embodiments;

FIG. 4 is a diagram illustrating a vehicle and a server configured to predict information associated with vehicle products/services, in accordance with some embodiments;

FIG. 5 is a flow diagram illustrating a method for predicting information associated with vehicle products/services, in accordance with some embodiments;

FIG. 6 is a flow diagram illustrating an alternative method for predicting information associated with vehicle products/services, in accordance with some embodiments;

FIG. 7 is a flow diagram illustrating a method for creating and/or improving products/services models associated with vehicle products/services, in accordance with some embodiments;

FIG. 8 is a flow diagram illustrating an alternative method for creating and/or improving products/services models associated with vehicle products/services, in accordance with some embodiments;

FIG. 9 is a diagram of a system that makes predictions, recommendations and/or control of vehicle products, components, and services in accordance with some embodiments;

FIG. 10 is a flowchart of an approach for training a machine learning algorithm in accordance with some embodiments;

FIG. 11 is a flowchart of an approach for training a machine learning algorithm in accordance with some embodiments;

FIG. 12 is a diagram of a structure of a machine learning algorithm in accordance with some embodiments;

FIG. 13 is a flowchart of an approach for operating a machine learning algorithm in accordance with some embodiments;

FIG. 14 is a flowchart of an approach for making predictions, recommendations and/or control of vehicle products, components, and services in accordance with some embodiments;

FIG. 15 is a diagram of a structure of a system in accordance with some embodiments;

FIG. 16 is a diagram of a structure of a system in accordance with some embodiments;

FIG. 17 is a diagram of a system in accordance with some embodiments;

FIG. 18 is a diagram of communication sequences in accordance with some embodiments;

FIG. 19 is a flowchart real-time bidding in accordance with some embodiments;

FIG. 20 is a flowchart of real-time bidding in accordance with some embodiments;

FIG. 21 is a flowchart of real-time bidding in accordance with some embodiments;

FIG. 22 is a flowchart of real-time bidding in accordance with some embodiments;

FIG. 23 is a flowchart of real-time bidding in accordance with some embodiments;

FIG. 24 is a diagram of a vehicle in accordance with some embodiments;

FIG. 25 is a diagram of providing a service in accordance with some embodiments;

FIG. 26 is a diagram of sharing information in accordance with some embodiments;

FIG. 27 is a diagram of creating advertising in accordance with some embodiments;

FIG. 28 is a diagram of identifying trends in accordance with some embodiments;

FIG. 29 is a diagram of providing different levels of service in accordance with some embodiments;

FIG. 30 is a diagram of data pooling in accordance with some embodiments;

FIG. 31 is a diagram of a server in accordance with some embodiments;

FIG. 32 is a diagram of a server in accordance with some embodiments;

FIG. 33 is a diagram of a server in accordance with some embodiments;

FIG. 34 is a diagram of one example of a server in accordance with some embodiments;

FIG. 35 is a diagram showing an example neural network in accordance with some embodiments; and

FIG. 36 is a flowchart showing on approach for training a neural network in accordance with some embodiments;

FIG. 37 is a flowchart in accordance with some embodiments;

FIG. 38 is a flowchart in accordance with some embodiments;

FIG. 39 is a flowchart in accordance with some embodiments;

FIG. 40 is a flowchart of an approach for pre-processing data in accordance with some embodiments.

### DETAILED DESCRIPTION

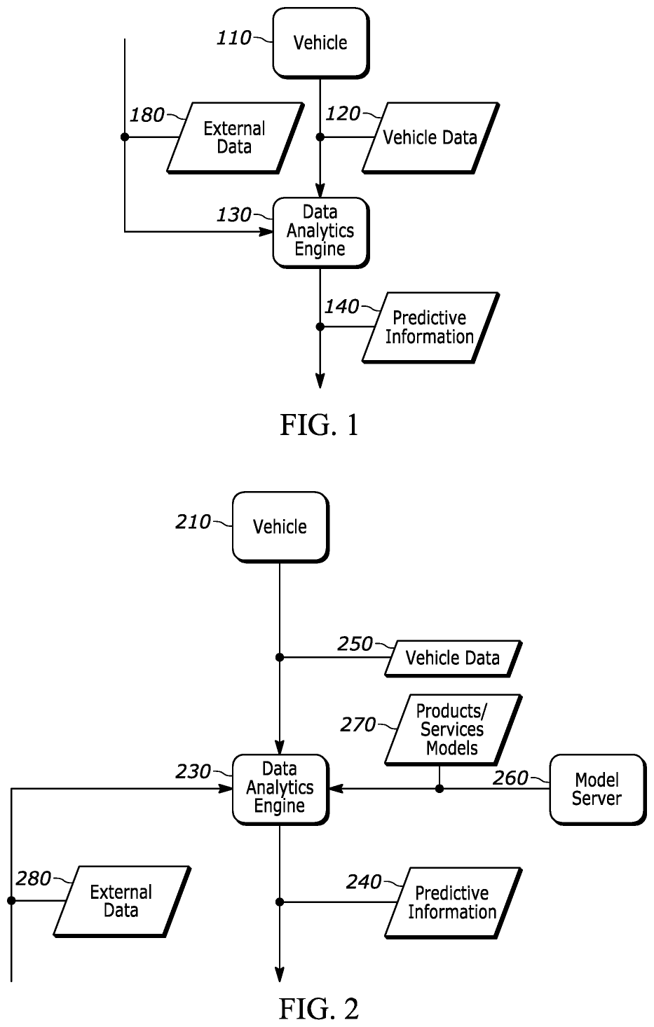

FIG. 1 is a diagram illustrating a system configured to predict information associated with vehicle products/services, in accordance with some embodiments.

In some embodiments, vehicle 110 is configured to collect vehicle data 120. Vehicle data 120 may contain information associated with one or more vehicle-related products/services. Vehicle data 120 may be provided to data analytics engine 130 for processing. In some embodiments, data analytics engine 130 may be configured to generate predictive information 140 that is associated with vehicle data 120 and/or the one or more products/services. It should be noted that vehicle data may be received from multiple vehicles/drivers and merged together by data analytics engine 130.

Generally, vehicle data 120 may include data from one or more sensors on a vehicle, as well as other vehicle data that may be associated with the one or more products/services such as vehicle identification details (make, model, miles, age, etc.), vehicle diagnostics data, and vehicle history. In some embodiments, vehicle data 120 may also be correlated with other types of data, such as map data and date/time data, for example.

In some embodiments, external data 180 may also be provided to data analytics engine 130. External data 180 may be related to the one or more products/services and may be data received from one or more external sources other than the vehicle(s). In some embodiments, external data 180 may include map-based data such as weather information, road functional class, conditions of various segments of the road, construction areas, road curvature, altitude maps, typical average speeds of various road segments, and/or reported incidents to mention a few examples. External data may generally include examples such as those discussed in relation to other figures here.

In some embodiments, certain types of data may be received as both external data 180 and vehicle data 120. For example, weather data may be received as external data from a weather prediction service and may also be received from a vehicle as the weather data may be detected by one or more sensors on the vehicle.

Vehicle data 120 may include data on the components of the vehicle such as chassis conditions, chassis settings, various engine metrics, etc. Vehicle data 120 may also include operational data, such as related to a driver's personal driving style. Such data may include g-vehicle data (indicating acceleration, in some embodiments, in all three directions), accelerator pedal input, brake pedal input, transmission selection input (optionally, clutch pedal input), steering input, gear shifting input, mode choices (sport mode, racing mode, city driving mode, launch, track, etc.), etc.

In some embodiments, vehicle data may also include various details about the specific vehicle, such as the vehicle year, make, model, trim, extra options, number of miles, etc. In addition, vehicle data may include general information about the driver or drivers of a specific vehicle. For example, vehicle data may include information identifying the current driver, the driver's sex, age, and other personal information that may influence or identify a driver's driving style, and such data may be associated with operational data of the vehicle 110.

Another type of vehicle data 120 may be weather data. Such data may include temperature, humidity, altitude (barometric pressure), rainfall, etc. It should be noted that weather data may be provided from sensors on the vehicle and/or as external data (which may also include historical weather data).

Yet another type of vehicle data 120 provided may be road conditions. Such data may include road functional class, road surface type, road surface condition, amount of turns and general curvature, altitude, average driving speeds (which may be obtained across multiple drivers and cars), road in the city or highway, construction and repair status, lane closure, accident, reported road incidents history and characteristics (such as potholes, ice, snow, mud, etc.), etc. Road condition data may again be provided from sensors on the vehicle and/or as external data 180. For example, such external data may be obtained from regional government roadway-management agencies. Vehicle data may generally include examples as those discussed in relation to other figures here.

In some embodiments, data analytics engine 130 may be implemented using various methods. Data analytics engine may utilize, for example, simple curve-fitting methods, neural networks, forms of artificial intelligence, including machine learning, etc.

In one embodiment, the data analytics engine 130 may be implemented as an artificial neural network. The artificial neural network may be an example of an artificial neural system or a parallel distributed processing system.

The artificial neural network may include a plurality of interconnected nodes or neurons. Each node of the interconnected nodes may be a node specialized to perform a particular task given one or more inputs.

The artificial neural network may include one or more layers of nodes. Each layer may include a plurality of nodes, which may be connected to nodes of a previous layer that provide inputs via connections to the nodes of the layer. Additionally, each node within a layer may be configured to generate an output, which may be provided as an input to one or more nodes of a subsequent layer. In this regard, each layer of the artificial neural network may be partially connected or fully connected to one or more other layers of the artificial neural network.

Each connection or input of the one or more inputs to a node may be associated with a weight. The weight may represent a relative importance of the input to the node for performing the task of the node. The weights of the inputs or connections to the node may be recursively, iteratively adapted, or optimized based on repetitive operation of the artificial neural network, such that a predictive output of each node and the artificial neural network may be improved. In this regard, the artificial neural network may be trained according to supervised learning, unsupervised learning, or reinforcement learning.

In one embodiment, the one or more inputs to nodes of the artificial neural network may include values corresponding to the vehicle data 120 and the external data 180. For example, vehicle data 120 from one or more sensors on a vehicle may be provided as inputs to one or more nodes configured to analyze vehicle speed, steering, braking, acceleration, suspension, etc. for generating the predictive information 140. In some embodiments, predictive information 140 may include any information that may be learned and predicted by data analytics engine 130 when data analytics engine 130 is provided with vehicle data 120 and/or external data 180. Generally, predictive information 140 may include information related to products/services that can be provided for the vehicle and/or for the vehicle's driver. In an embodiment, the predictive information 140 may include a prediction that a component of the vehicle 110 should be replaced based on the vehicle data 120 and the external data 180, as well as data relating to the vehicle component, such as an expected operational lifespan of the component according to technical parameters and operational specifications of the component.

According to one embodiment, the external data 180 is the manufacturer test data described previously. Further, the external data 180 could be data from other consumers and their vehicles relating to the products and the specific configuration of their vehicle. The external data 180 may thus be training data for training the data analytics engine 130. For example, the predictive information 140 may include information indicating that a tire of a vehicle should be replaced when a driver operates the vehicle according to one or more of high acceleration, high speed, aggressive cornering, high vehicle loads, high towing loads, high temperatures, abrasive road surfaces, and other factors that contribute to decreased tire endurance. Accordingly, in generating the predictive information 140, the data analytics engine 130 may increase weights of inputs corresponding to the vehicle data 120 and external data to better correlate with inputs indicative that a tire should be replaced more quicky than in absence of such conditions. As a result, the predictive information 140 may take into account the technical specifications of the tire, the pattern of driving as determined by the vehicle data, and all other possible external data 180.

In one example of a training process, customer requirements are matched with the product information. In aspects, the training process is a supervised training process in which the input(s) such as all tire parameters, all driving behaviors, car parameters, and so forth are correlated with the preferred output (e.g., the recommended tire, or other part/component). One example of a training may be accomplished according to the table below:

| | Sports Car, | | SUV, |
|---|---|---|---|
| | high speeds, | Minivan, | off-road |
| Parameters | hard braking | low speeds | conditions |
| Tire 1 (high | Recommended | ControlContact ™ | SportContact ™ 6 |
| speed rating, | Output | Sport | |
| cornering | ExtremeContact ™ | | |
| rating, tire | Force | | |
| hardness) | | | |
| Tire 2 (fuel | ExtremeContact ™ | Recommended | TerrainContact ™ |
| economy rating, | DWS06 Plus | Output | A/T |
| mileage lifetime) | | PureContact ™ LS | |
| Tire 3 | ExtremeContact ™ | TrueContact ™ | Recommended |
| (durability, | Sport | Tour | Output |
| wall thickness, | | | CrossContact ™ LX |
| radius) | | | |

Tire performance and other tire information may also be found at https:/continentaltire.com/tires, the content of which is incorporated herein.

It should be noted that, in some embodiments, vehicle data may be obtained from multiple vehicles as well as multiple drivers. In such embodiments, data analytics engine 130 may be configured to combine/correlate the data from the multiple vehicles and drivers. For example, road data from multiple vehicles may be combined and averaged in order to determine road conditions for specific road segments.

In some embodiments, the predictive information, based at least in part on provided vehicle data 120 and/or external data 180, may include products/services recommendations that are personalized to a particular driver/vehicle. Such personalized recommendations may include optimum equipment replacements and/or upgrades given the particular driver, vehicle, driving conditions/style, etc. For example, data analytics engine 130 may be configured to determine optimum replacements for brakes, tires, engine oil, transmission oil, oil filter, air filter, spark plugs, fuel type, sensors (pressure and oxygen), fuel octane rating, electric (hybrid electric vehicle (HEV)) drain and charge levels and charging and draining times, windshield wipers, wax, external protective coatings, body panels, floor mats, (adjustable) shock absorbers, bull bars, road debris shields, mud flaps, etc.

In some embodiments, data analytics engine 130 may be configured to generate upgrade recommendations based on, among other things the optimal level of performance, reliability and cost for a specific driver. For example, if the data analytics engine 130 predicts that the driver of a specific vehicle could benefit from more performance, a better engine-mapping unit, a better turbo charger, or the addition of a supercharger may be recommended.

In some embodiments, data analytics engine 130 may be configured to recommend specific service providers, based at least in part on the provided information. For example, if data analytics engine 130 determines that performance upgrades are needed/appropriate, a suitable high-performance shop may be recommended. Alternatively, if the vehicle requires only routine maintenance, such as an oil change, an inexpensive oil-change shop may be recommended.

In some embodiments, certain recommendations/predictive information may be given higher ranking based on other reasons. For example, a certain brake manufacturer may provide incentives in order for brakes made by that manufacturer to be given a higher ranking (i.e., performance, reliability, and cost) in the generated predictive information.

FIG. 2 is a diagram illustrating an alternative system configured to predict information associated with vehicle products/services, in accordance with some embodiments.

In some embodiments, vehicle 210 is configured to collect vehicle data 250. Vehicle data 250 may contain information associated with one or more vehicle-related products/services. Vehicle data 250 may then be provided to data analytics engine 230 for processing. In some embodiments, data analytics engine 230 may be configured to generate predictive information 240 that is associated with vehicle data 250.

Generally, vehicle data 250 may include data from sensors on the vehicle as well as other vehicle data (such as environmental data, vehicle history, etc.). Such vehicle data may include weather data, road conditions, personal driving style data, vehicle chassis conditions, wear indicators for several parts, etc. Other examples of vehicle data may include data from on-board radar, LIDAR, cameras, ultrasonic sensors, GNSS, accelerometers, ABS/ESC sensors, knock sensors, pressure sensors (MAP, fuel, air flow, knock, octane, combustion, ignition, timing), HEV sensors (i.e., current, coulomb counters, voltage, temperature, range), and other vehicle environmental sensors. Vehicle data may also include derivative data that results from the fusion of the sensor data (from any vehicle sensors) and potentially other on-board vehicle data, such as map data or date/time data. For example, various data from on-board sensors may be correlated and associated with the map data and/or with the date/time data. Vehicle data may generally include examples such as those discussed in relation to other figures herein.

In some embodiments, data analytics engine 230 may be implemented using various methods. Data analytics engine may utilize simple curve-fitting methods, neural networks, or any other type of artificial intelligence methods.

In some embodiments, external data 280 may also be provided to data analytics engine 130. External data 280 may be related to the one or more products/services and may be data received from one or more external sources other than the vehicle(s). In some embodiments, external data 280 may include map-based data such as road functional class, conditions of various segments of the road, construction areas, road curvature, altitude maps, typical average speeds of various road segments, reported incidents, etc. External data may generally include examples such as those discussed in relation to other figures here.

In some embodiments, additional vehicle data from additional vehicles/drivers may be supplied to data analytics engine 230. In some embodiments, the additional data may be used by data analytics engine to enhance the predictive information with the information collected from the additional vehicles/drivers. Data with similar attributes may be combined (whether in a statistical manner, through neural networks, or otherwise) in order to enhance the predictions. Attributes may include the year, make, and model of the vehicle, the type of brakes on the vehicle, the type of tires on the vehicle, etc. Attributes may also include driving conditions such as weather, road condition, traffic conditions, load, etc. In addition, attributes may also include specific information about the driver or drivers of each vehicle. Data analytics engine 230 may attribute relatively more significance to additional vehicle data from the same types, or a similar type, of vehicles/drivers. For example, such vehicles/drivers may include, but are not limited to: same or similar vehicle type (e.g., compact car with front-wheel drive, all-wheel drive sport sedan, roadster, hybrid and SUV, hybrid and electric vehicle, performance-oriented vehicle, vehicle optimized for high gas mileage, etc.), similar driving style (e.g., aggressive, race, sport, performance, tour, street, relaxed, defensive, hypermiling, high/low loads, etc.), similar driving environment (e.g., environmental conditions, such as road conditions, weather conditions, etc.), and the like. As used herein, the phrase “substantially the same” is intended to mean the same, almost the same, approximately the same, or any combination or permutation of those intended meanings. The analytics engine 230 may be used to predict tire wear and predict when new tires may be needed. Among other advantages and in this example, the data analytics engine 230 significantly improves tire wear prediction and thus significantly improves tire replacement prediction compared to conventional rule of thumb such as rating tires based on a generic mileage, such as a 50,000-mile tire, or based on using a penny or other coin to roughly measure tire tread depth.

In embodiments where multiple drivers share a vehicle, each set of the vehicle data may be associated with the driver's identity and be used during the determination of the predictive information. For example, using data from a brake-wear sensor, it can be determined how much brake-wear per mile may be attributed to each driver, etc.

In some embodiments, model server 260 may be configured to provide data analytics engine 230 with products/services models 270. Data analytics engine 230 is configured to combine products/services models 270 with vehicle data 250 and external data 280 in determining predictive information 240. In some embodiments, products/services models 270 may comprise collected and/or processed information about products and services that are being predicted by data analytics engine 230 and are related to the collected vehicle data 250.

Generally, predictive information 240 may include information related to products/services that can be provided to the vehicle and/or the vehicle's driver. In some embodiments, the predictive information, based at least in part on provided vehicle data 250, may include products/services recommendations that are personalized to the driver/vehicle. Such personalized recommendations may include optimum equipment replacements, upgrade recommendations, service providers, etc.

Products/services models 270 may include information that was previously collected and processed. For example, products/services models 270 may include performance, reliability, and cost information for products such as tires. Information on tires may include, for example, tire information such as wear patterns and other performance based on temperature, road surface, load, acceleration, etc. Other examples of such products/services models may include brakes, engine oil, transmission oil, oil filters, air filters, spark plugs, fuel, engine-mapping units, turbo chargers, superchargers, REV electric motor maintenance such as bearings, winding, magnet, contacts, brushes, commutator, inverter, etc.

Information and characteristics about tires can be include performance information from tests and from review of actual driving data. For example, automobile tires can be categorized as ultra-high performance, touring, all-terrain and winter and so forth. Tire models within a tire category such as ultra-high performance can include: ExtremeContact™ DWS06 Plus, ExtremeContact™ Sport, ExtremeContact™ DWS06, and ExtremeContact™ Force. Tire models within the TOURING category may include CrossContact™ LX25, PureContact™ LS, TrueContact™ Tour, and TerrainContact™ H/T for example as other models may apply.

Exemplary performance information for each tire may include the following performance information. Different performance information can be associated for each tire size, for each model and for each make of tire. Exemplary information for a particular tire is provided below:

| | 0-1 G | | | |
|---|---|---|---|---|
| | Dry | | Wet | Snow |
| Braking | 0.9 | | 0.6 | 0.5 |
| Acceleration | 0.8 | | 0.6 | 0.4 |
| Skid pad | 0.95 | | 0.7 | 0.6 |
| Slalom Time | 5 | seconds | 6 seconds | |
| Lap time | 30 | seconds | 35 seconds | |

| | |
|---|---|
| Treadwear | 40,000 (0 to 100K) miles |

| Noise Comfort | (0-10) or dB | |
|---|---|---|
| Handling | (0-10) | |
| Evasive maneuver | 50 | MPH |

| | |
|---|---|
| Ride quality | (0-10) |

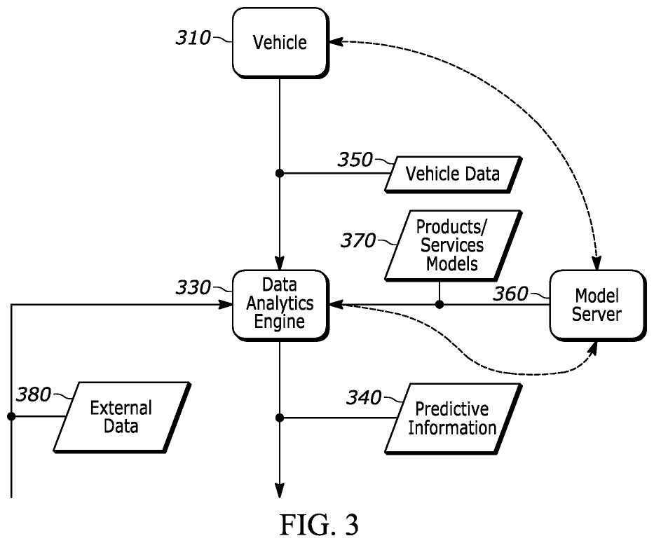

FIG. 3 is a diagram illustrating a system configured to create and/or improve products/services models associated with one or more vehicle products/services, in accordance with some embodiments.

In some embodiments, vehicle 310 is configured to collect vehicle data 350, which contains information associated with one or more vehicle-related products/services. Vehicle data 350 may then be provided to data analytics engine 330 for processing. In some embodiments, data analytics engine 330 may be configured to generate predictive information 340 that is associated with vehicle data 350.

Generally, vehicle data 350 may include data collected from one or more sensors on a vehicle. Vehicle data may include road conditions, personal driving style data, wear indicators, etc. Vehicle data may generally include examples as those discussed in relation to other figures here.

In addition, data analytics engine 330 may also be configured to receive external data 380. External data 380 may include data that is related to the products/services, such as environmental data for example. External data may generally include examples such as those discussed in relation to other figures here.

In some embodiments, data analytics engine 330 may be implemented using various methods. Data analytics engine may utilize simple curve-fitting methods, neural networks, artificial intelligence methods, etc.

In some embodiments, model server 360 may be configured to provide to data analytics engine 330 products/services models 370. Data analytics engine 330 may be configured to combine products/services models 370 with vehicle data 350 in determining predictive information 340.

In some embodiments, products/services models 370 may comprise collected and/or processed information, related to vehicle data 350, that is being predicted by data analytics engine 330.

Generally, predictive information 340 may include information related to products/services that can be provided to the vehicle and the vehicle's driver. In some embodiments, the predictive information, based at least in part on provided vehicle data 350, may include products/services recommendations that are personalized to the driver/vehicle. Such personalized recommendations may include optimum equipment replacements, upgrade recommendations, service providers, etc.

According, to another exemplary embodiment, in response to driver and vehicle data, the vehicle 310 provides the data analytics engine 230, 330 produces vehicle data 350 that can train and be further pre-processed as driver and vehicle tire requirements to a model server 360 to create requirement data unique to the driver and vehicle for a “designer tire” type of products/services models 370. The vehicle data 350 and driver and vehicle requirements can include performance data similar to the above criteria such as speed, high and low speed cornering, braking, temperature operating range, treadwear, noise, wet, dry, front/back/left/right position, suspension setting, other chassis tuning information, driving modes, driving style (level of aggressiveness/comfort) and so forth. The driver and vehicle requirements to the model server 360 will learn the specific and unique mix and tire rubber composition recipe.

Tire rubber compositions may be developed by selecting from a wide variety of compounds used to make tires, such as carbon black, silica, sulfur, natural and synthetic rubber, as well as any other suitable or conventionally used materials. For example, zinc oxide can be used as a colorant, a vulcanization activator, and/or a plasticizer, which may impart heat conductivity, tack and adhesive properties to a cured rubber composition. Similarly, red iron oxide can be used as colorant and as a stabilizer against heat aging. Carbon black provides rubber compositions with electrical conductivity, and is an additive and colorant that is known to provide moderate reinforcement. Thus, training data may be based on thousands or more combinations of the different compounds for a particular recipe, along with the performance characteristics of the vulcanized and cured rubber. Lab testing for each rubber compound can include measurements for characteristics such as stretch curves on a strain gauge, coefficient of friction testing under a load on a friction surface like a wheel, compression, elasticity, yield point measurements for a wide range of suitable temperatures from −25 C to 125 C in any suitable increments. As a result, thousands, millions or more compounds and their corresponding characteristics can be fed into and train the data analytics engine 330. Thus the data analytics engine 330 in response to the driver and vehicle tire requirements generates a customized compound mix and recipe as predictive information 340 in this example. The recipe and the mix of ingredients may then be provided to a tire manufacturing facility having a tire rubber composition mixing machine.

In some embodiments, the tire rubber composition mixing machine may have the ingredients in separate containers, similar to a beverage or coffee machine that mixes and heats the compounds according to a recipe, to produce a specific rubber composition to be used to ultimately form a designer tire according to the driver and vehicle's unique performance characteristics. In addition to tires, a similar process may be used to produce other components like brake pads, wiper blades, belts, batteries, gasoline and other suitable products. Among other advantages, a custom tire may be manufactured according to unique driver and vehicle requirements. There are several technical improvements to the production of a tire or suitable product:

The pre-processing of training data (e.g., unique datasets for the driver and vehicle tire requirements generates a customized compound mix and recipe as predictive information 340).

The training process (e.g., the analytics engine trains to predict the properties and characteristics of the materials like rubber is used and/or improvements a machine learning or neural network algorithm). The AI (artificial intelligence) neural network has weighting values that are determined by learning the material science of rubber such that the trained model server 360 learns a large number of mix or recipes and their associated characteristics described above and as a result can generate a new mix and recipe in response to unique driver and vehicle tire requirements.

The use of the trained model server 360 (e.g., to control a particular machine to predict the mix and recipe or to provide unique results, namely a tire may be manufactured according to unique driver and vehicle requirements).

Products/services models 370 may include information that was previously collected and processed. For example, products/services models 370 may include performance information for products such as tires. Information on tires may include, for example, wear patterns and other performance indicators that are based on temperature, road surface, load, acceleration, etc. Other examples of such products/services models may include brakes, engine oil, transmission oil, oil filters, air filters, spark plugs, fuel, engine-mapping units, turbo chargers, superchargers, electric charging, REV inverters, etc.

In some embodiments, data from the data analytics engine 330 may be used to provide feedback to model server 360 in order for model server 360 to improve products/services models 370. In some embodiments, if no model exits for a particular product or service, the model may be created for that particular product or service using information/feedback received from data analytics engine 330. In other embodiments, information/feedback provided by services/product models 370 may be added to and improve products/services 370.

In some embodiments, additional vehicle data from additional vehicles/drivers may be supplied to data analytics engine 330. In some embodiments, the additional data may be used by data analytics engine to enhance predictive information 340 with the information collected from the additional vehicles/drivers. Data with similar attributes may be combined (whether in a statistical manner, through neural networks, or otherwise) in order to enhance the predictions. Attributes may include the year, make, and model of the vehicle, the type of brakes on the vehicle, the type of tires, fuel octane, REV charge rate, state, range, battery rating, condition, aging and capacity, operating temperature, and performance level (plaid, ludicrous, range plus “REV”) on the vehicle, etc. Attributes may also include driving conditions such as weather, road condition, traffic conditions, etc. In addition, attributes may also include specific information about the driver or drivers of each vehicle.

In embodiments where multiple drivers share a vehicle, each set of the vehicle data may be associated with the driver's identity and be used during the determination of the predictive information. For example, using data from a brake wear sensor, it can be determined how much brake wear can be attributed to each driver per mile, etc.

In some embodiments, model server 360 may be configured to provide feedback information for improving sensors 310. The feedback information may be provided, for example, from the products/services models that were created and updated/improved at model server 360. In some embodiments, feedback provided by model server 360 may be used, for example, in choosing what type of sensors to set up on a vehicle, what type of data to collect from those sensors, how to distill the data before transmission, etc.

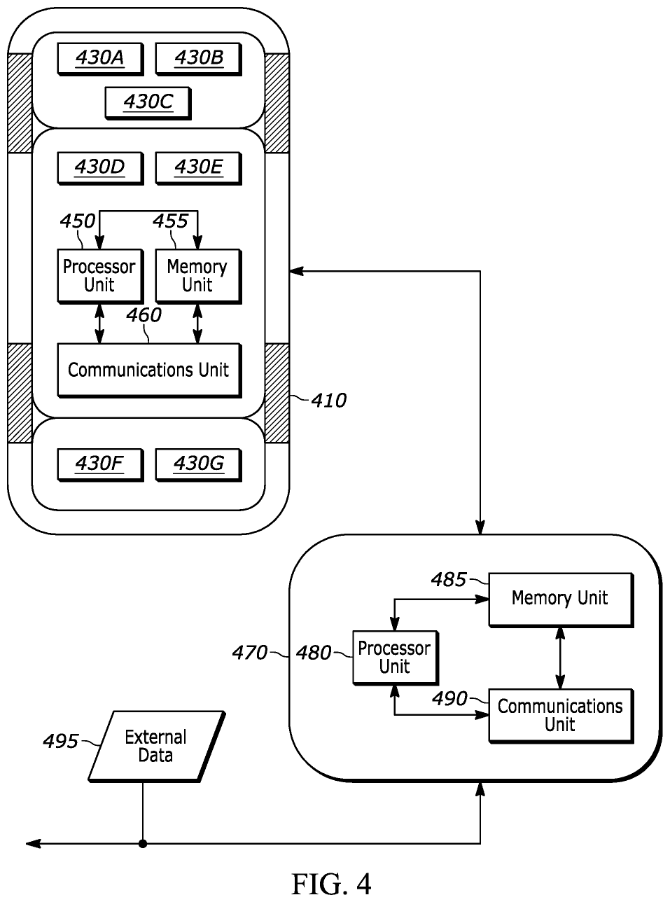

FIG. 4 is a diagram illustrating a vehicle and a server configured to predict information associated with vehicle products/services, in accordance with some embodiments.

In some embodiments, vehicle 410 may include one or more processor units (such as processor unit 450), one or more memory units (such as memory unit 455, which are coupled to processor unit 450), and one or more communications units (such as communications unit 460, which is also coupled to processor 450 and/or memory unit 455). In some embodiments, vehicle 410 may also include one or more sensors, such as sensors 430A-G.

In some embodiments, sensors 430A-G are configured to collect information associated with one or more vehicle-related products/services. Vehicle data, which may include data other than the sensor data, may be provided to processor unit 450 and/or stored in memory unit 455. Processor unit 450 may be configured to pre-process the vehicle data before the vehicle data is transmitted to another location (such as server 470) for additional processing.

In some embodiments, some pre-processing of the data may occur in order to distill the data to a smaller size prior to transmission. For example, there may be vehicle data obtained from two different sensors that contains the same or very similar information. In such a case, only data from one of the sensors may be sent. Additional types of pre-processing, such as general compression, may also be performed locally on the vehicle before the vehicle data is transmitted to server 470.

In some embodiments, communications unit 460 is configured to establish a connection, either direct or indirect, with communications unit 490 of server 470. In some embodiments, server 470 may also include one or more processor units (such as processor unit 480), one or more memory units (such as memory unit 485, which is coupled to processor unit 480), and one or more communications units (such as communications unit 490, which is also coupled to processor 480 and/or memory unit 485).

In some embodiments, server 470 may be configured to generate predictive information that is associated with the vehicle data received from vehicle 410. In some embodiments, server 470 may also be configured to receive external data 495 that may include other data related to the vehicle data (such as environmental data).

In some embodiments, server 470 may be configured to apply various methods in generating predictive information. For example, server 470 may utilize simple curve-fitting methods, neural networks, artificial intelligence methods, etc.

In some embodiments, server 470 may be configured to store, generate, and/or update products/services models. In some embodiments, server 470 may be configured to combine products/services models with the vehicle data and the external data in determining the predictive information. In some embodiments, the products/services models may comprise collected and/or processed information about products and services that are being predicted by server 470 and are related to the vehicle data. In some embodiments, server 470 may be configured to improve the products/services models using the vehicle data and other external data provided to the server.

Generally, the predictive information may include information related to products/services that can then be provided to the vehicle and the vehicle's driver. The information may be sent back to the vehicle or the information may be sent to a designated email address, phone number, dealership, service provider, retail store, etc.

In some embodiments, the predictive information, based at least in part on the provided vehicle data, may include products/services recommendations that are personalized to the driver/vehicle. Such personalized recommendations may include optimum equipment replacements, upgrade recommendations, service providers, etc.

The products/services models may include information that was previously collected and processed. For example, the products/services models may include performance information for products such as tires. Information on tires may include, for example, tire information such as wear patterns and other performance based on temperature, road surface, load, acceleration, etc. Other examples of such products/services models may include brakes, engine oil, transmission oil, oil filters, air filters, spark plugs, fuel, engine-mapping units, turbo chargers, superchargers, HEV, etc. and other previously described. In some embodiments, server 470 may be configured to create and/or improve the products/services models using the information provided to server 470 (such as the vehicle data and the external data).

In some embodiments, additional vehicle data from additional vehicles/drivers may be supplied to server 470. In some embodiments, the additional data may be combined with the other information provided to server 470 in order to enhance the generated predictive information and/or the products/services models.

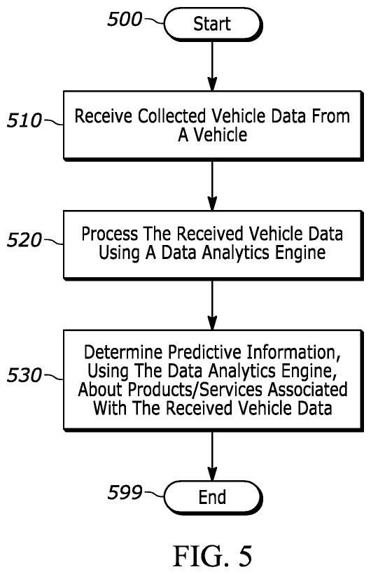

FIG. 5 is a flow diagram illustrating a method for predicting information associated with vehicle products/services, in accordance with some embodiments.

In some embodiments, the method described here may be performed by one or more of the systems described in FIGS. 1-4.

Processing begins at 500 where, at block 510, collected vehicle data from a vehicle is received. In some embodiments, the collected data may be related to one or more products/services associated with a vehicle.

At block 520, the received processed data is processed using a data analytics engine. In some embodiments, data analytics engine may be implemented using various methods. Data analytics engine may utilize simple curve-fitting methods, neural networks, and artificial intelligence methods. As described elsewhere herein and when a neural network is used, the neural network may be trained for usage using training data. Once trained, the neural network can be further refined as new data is received or as specifications change (to mention two examples). In examples, the neural network can periodically be retrained or refined, but in other examples the retraining is asynchronous in time and, as such, may be triggered by asynchronous events such as the arrival of new testing data.

At block 530, the data analytics engine determines predictive information about the products/services associated with the received vehicle data.

Processing subsequently ends at 599.

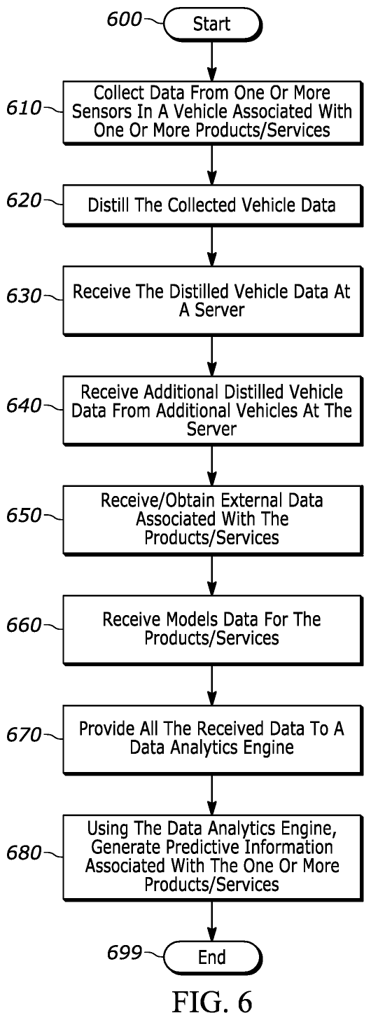

FIG. 6 is a flow diagram illustrating an alternative method for predicting information associated with vehicle products/services, in accordance with some embodiments.

In some embodiments, the method described here may be performed by one or more of the systems described in FIGS. 1-4.

Processing begins at 600 where, at block 610, data is collected from one or more sensors on a vehicle. The vehicle data is associated with one or more vehicle-related products/services.

At block 620, the collected vehicle data is distilled. In some embodiments, the vehicle data is reduced in size to better facilitate the transmission of the data. For example, duplicate data may be removed. Generally, a compression of the data may be performed.

At block 630, the distilled vehicle data is received at a server where the vehicle data is to be combined with additional data and/or go through additional processing.

At block 640, additional vehicle data from additional vehicles/drivers is received at the server. In some embodiments, the additional vehicle data further enhances the results determined at the server when the vehicle data is processed.

According to one embodiment, collected vehicle data and/or distilled vehicle data and/or additional vehicle data is processed for example, for the particular product of interest. Using the tire example, the particular sensor data could be accelerometer(s) data providing braking, forward, lateral, and yaw acceleration information to characterize the required static and dynamic coefficient of friction requirement for the tire, odometer information relating to wear, speed information to characterize the tire speed capability, temperature information to characterize the temperature operating range of the tire such as winter, summer and all-season, wet, rain and hydroplaning detection to characterize wet tire grip requirements, stability controller events to determine and characterize the requirements for a tire to perform under sliding or slipping conditions such as in track events and the individual car's settings: suspension stiffness, steering ratio, transmission shifting curves, engine performance (high performance, sport, economy) and any other suitable vehicle, driver and customer data. This vehicle data may be pre-processed in order to provide a requirements profile for the tire. For example, if the performance requirements best match extreme or high-performance driving behavior, then tire requirements may be identified such as those previously described.

At block 650, external data, associated with the one or more products/services, is received/obtained at the server. In some embodiments, external data may be any data that may enhance the results generated by the server that are associated with the products/services and/or the vehicle data. The server may store test data for the products and services. The test data for each product or service may be based on lab testing, controlled track testing, real world data collection from actual vehicles on the road and simulations. For example, testing of several, many or most tires on the market can be stored on the sever. The test data can include treadwear, traction for wet and dry braking and cornering, cost, noise and comfort, data for each tire. Data can be updated with real world information collected from vehicles on the road.

At block 660, models for the products/services are received at the server. In some embodiments, products/services models may include information that was previously collected and processed about the products/services. For example, the products/services models may include performance information for products such as tires, brakes, engine oil, transmission oil, oil filters, air filters, spark plugs, fuel, engine-mapping units, turbo chargers, superchargers, REV, etc.

At block 680, the data analytics engine generates predictive information associated with the one or more products and services. In the tire example, the engine identifies the criteria such as performance, reliability and cost requirements for the vehicle and driver and searches the database for a product or service the most closely matches the performance, reliability and cost requirements. The data analytics engine then ranks the products according to the required criteria. The products can then be provided to the user as a custom recommendation of products the best suits the user's criteria. For example, a user may want to know if their a vehicle is best suited with a single set of all-season tires or a set of summer tires and a set of winter tires. The analytics engine can evaluate the performance, cost and treadwear advantages of the summer and winter tires compared to all season tires. If the user drives aggressively and prematurely wear out the all-season tires requiring frequent replacement, then a dedicated set of summer and winter tires may provide better performance and at less costs than frequently replacing all season tires. In this case the analytics engine can provide objective data to the user to quantify the improvement in performance with the summer and winter tires by providing traction data for summer and winter conditions and overall cost of tire ownership over the life of the vehicle. On the other hand, if a user's performance requirements are within the capability of an all-season tire such as a performance all season tire, then the all-season tire may be optimal thus avoiding the initial up front expense of purchasing summer and winter tires, wheels and storage. The user can then decide the best option: all-season or summer and winter tires based on objective personalized recommendations derived from actual user criteria and professional test results. This rather than the conventional methodology of relying on a salesperson's opinion or on inaccurate information from internet blogs. Among other advantages, the proprietary testing information say from a manufacturer or from an independent tester may stay confidential and proprietary since the test results need not be provided to the user or the public. Since only the ratings and resulting recommendations are provided to the user, all proprietary testing information remains protected and confidential. The analytics engine may optionally offer the user a discount or coupon (see step 2106 below) for the recommended product and service and can even schedule repairs, maintenance or installation according to the user's calendar availability.

According to one embodiment, the customer performance requirements described at block 640 may be correlated or matched with a product profile described at step 660. For example, tire requirements may be identified such as those previously described. These pre-processed requirements can be correlated with the pre-processed product information at step 680. The prediction performed by the analytics engine may be a correlation or degree of match on a scale of 0-100%. Since price or cost is usually a significant factor, the options may be presented to the customer along with the associated costs. The top options may then be presented to the consumer in order to easily facilitate a sales and service transaction.

Processing subsequently ends at 699.

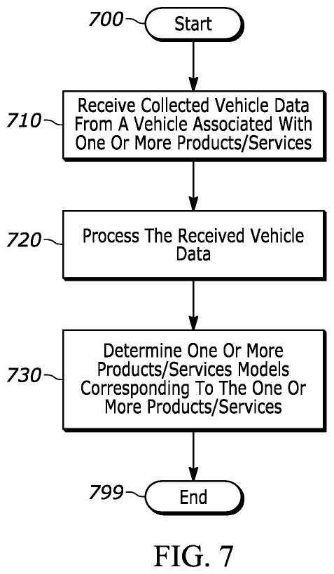

FIG. 7 is a flow diagram illustrating a method for creating and/or improving products/services models associated with vehicle products/services, in accordance with some embodiments.

In some embodiments, the method described here may be performed by one or more of the systems described in FIGS. 1-4.

Processing begins at 700 where, at block 710, collected vehicle data from a vehicle is received. In some embodiments, the vehicle data is associated with one or more vehicle-related products/services.

At block 720, the received vehicle data is analyzed and processed, and at block 730, one or more models corresponding to the one or more products/services are determined. In some embodiments, products/services models may include information that was previously collected and processed. For example, the products/services models may include performance information for products such as tires, brakes, engine oil, transmission oil, oil filters, air filters, spark plugs, fuel, engine-mapping units, turbo chargers, superchargers, REV, etc. Block 730 may function as described.

Processing subsequently ends at 799.

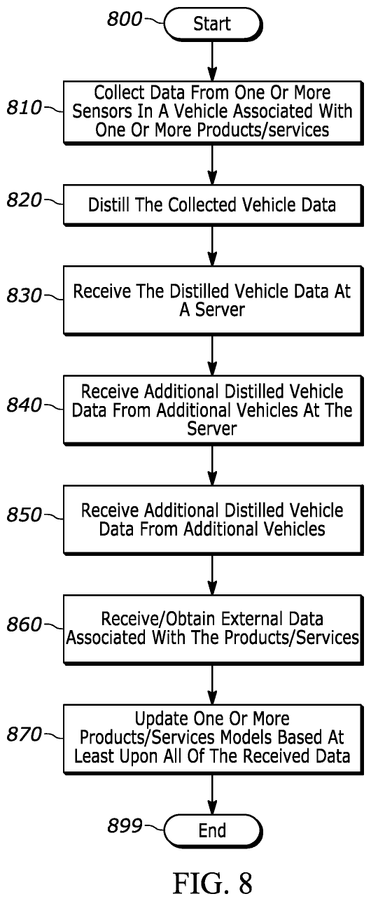

FIG. 8 is a flow diagram illustrating an alternative method for creating and/or improving products/services models associated with vehicle products/services, in accordance with some embodiments.

In some embodiments, the method described here may be performed by one or more of the systems described in FIGS. 1-4.

Processing begins at 800 where, at block 810, data is collected from one or more sensors in a vehicle associated with one or more vehicle-related products/services.

At block 820, the collected vehicle data is distilled. In some embodiments, the vehicle data is reduced in size to better facilitate the transmission of the data. For example, duplicate data may be removed. Generally, a compression of the data may be performed. At block 830, the distilled vehicle data is received at a server.

At block 840, additional distilled data is received at the server from additional vehicles/drivers. In some embodiments, the additional vehicle data further enhances the results determined at the server when the vehicle data is processed.

At block 860, external data associated with the one or more products/services is received/obtained at the server. In some embodiments, external data may be any data that may enhance the results generated by the server that are associated with the products/services and/or the vehicle data.

At block 870, one or more products/services models are updated based at least upon the received data. In some embodiments, products/services models may include information that was previously collected and processed. For example, the products/services models may include performance information for products such as tires, brakes, engine oil, transmission oil, oil filters, air filters, spark plugs, fuel, engine-mapping units, turbo chargers, superchargers, REV, etc.

Processing subsequently ends at 899.

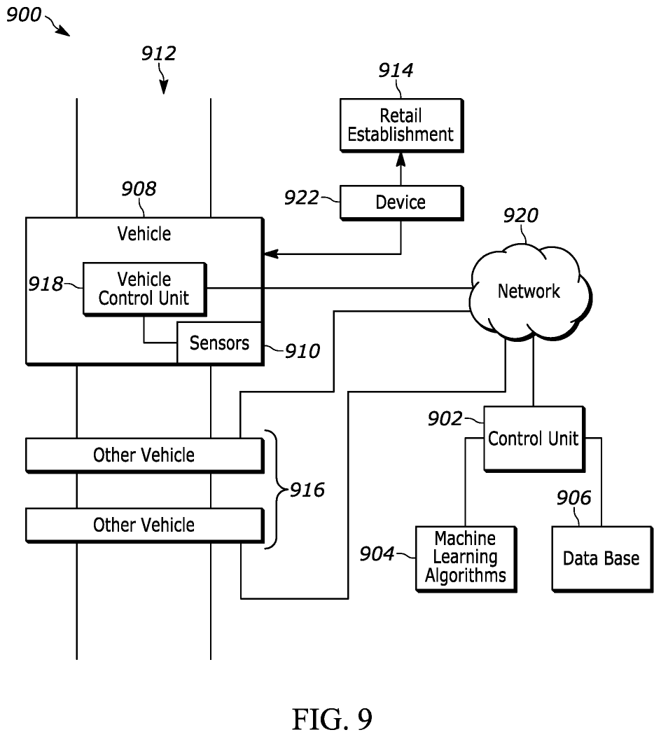

FIG. 9 is a diagram of a system that makes predictions, recommendations and/or control of vehicle products, components, and services in accordance with some embodiments.

Referring now to FIG. 9, one example of vehicle products and services system 900 that offers predictions, recommendations, and insights to drivers is illustrated. The system 900 includes a control circuit 902, machine learning algorithms (and/or machine learning models) 904, a database 906, and a vehicle 908 (including sensors 910). The vehicle 908 traverses roads 912 and the driver of the vehicle 908 may visit a retail establishment 914 to purchase retail products. Other vehicles 916 also operate in the roads 912. These other vehicles 916 also have sensors. The sensors 910 in the vehicle 908 communicate with a vehicle control unit 918 that disposed in the vehicle 908. The vehicle control unit 918 communicates with the control circuit 902 via an electronic communication network 920. The other vehicles 916 and their sensors also communicate with the control circuit 902 via the network 920 using their vehicle control units or similar devices. In some examples, the control circuit 902 and the machine learning algorithms 904 form a data analytics engine. The control circuit 902, machine learning algorithms 904, and/or database 906 may be disposed at a central location such as a headquarters or home office. Alternatively, the control circuit 902, machine learning algorithms 904, and/or database 906 may be disposed at the vehicle 908 or split between the central location and the vehicle 908.

The control circuit 902 is coupled to machine learning algorithms 904, the database 906, and the network 920. The control circuit 902 performs various functions including directing or assisting training of a neural network when the machine learning models and/or algorithms 904 are neural networks, executing some or all of the machine learning models and/or algorithms 904 when these are algorithms, inputting data into the neural networks, receiving the output of the neural networks, and performing other functions as a result of the output. Other examples of functions are possible.

It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here.

It will be appreciated that the machine learning algorithms and/or models 904 may include an algorithm (implemented as a neural network) that produces a model. The model may be analyzed by other software at the control circuit 902 or by other control circuits, processes, processors, computers, human personable, or other entities.

In other aspects, the machine learning algorithms 904 may include an algorithm (implemented as a neural network) that produces an output. The output may be some sort of mathematical representation such as a vector, graph, matrix, algorithm, code, or signal. The output may be transformed, converted, analyzed, or further processed by other software at the control circuit 902 or by other control circuits, processes, processors, computers, human personable, or other entities. The output may be in the form of a file (in any format with any type of contents including those mentioned above) and, as mentioned, may itself be considered a model. The output may be sent to other entities such as the control circuit 902 or vehicle control unit 918, where the output is further utilized, used, processed, refined, or interpreted and further actions taken based upon this usage, processing, refining, or interpreting.

Machine learning algorithms 904 may be of any structure or combination of or usage of structures such as files, data structures (within the files), code, pseudocode, graphs, vectors, weightings, equations, mathematical constructs, or algorithms to mention a few examples. These structures, in one example, are neural networks. In one specific example, machine learning algorithms 904 comprise a convolution neural network. As mentioned and in some examples, the machine learning algorithms 904 may be implemented at least in part by the control circuit 902 and memory (or other electronic processing devices and memories).

In aspects, the machine learning algorithms 904 are trained using training data and perform pattern recognition on the training data to build a model and/or train the algorithm. Examples of machine learning algorithms included artificial neural network/backpropagation-based algorithms, regression-based algorithms, and decision tree-based algorithms. Other examples of machine learning algorithms are possible. The machine learning algorithms 904 may be stored in the control circuit 902, database 906, combinations of these locations, or at any other location (e.g., some other electronic device or memory), or in any combination of locations).

In one example, the machine learning algorithm 904 is a neural network and the training of neural networks involves applying training data to the neural network. The training data may be based upon data from sensors of the vehicle being driven by a driver, data describing the driving patterns of the other drivers, data describing vehicle parameters of vehicles driven by the other drivers, and/or data concerning the components of the vehicle. Other examples are possible. In aspects, a neural network is stored in an electronic memory device and may include or represent different layers, weightings, algorithms, computer instructions, other structures, and/or data representing these or other features. It will be understood that the neural networks described herein are stored in electronic memory.

In aspects, the neural network is trained using an optimization algorithm and weights of the neural network are updated using a backpropagation of error algorithm or function. The network with a given set of weights is used to make predictions and the error for those predictions is calculated. The error algorithm seeks to change the weights so that the next evaluation reduces the error, meaning the optimization algorithm is navigating down a gradient (or slope) of error. In examples, it is desired to minimize the error and a loss function is used to calculate an error or loss.

The machine learning algorithm 904 may be trained in a supervised or unsupervised way. Supervised algorithms select target or desired results, which are predicted from a given set of predictors (independent variables). Using these set of variables, a function or structure is generated that maps inputs to desired outputs. The training process continues until the algorithm achieves a desired level of accuracy on the training data. Examples of supervised learning algorithms include regression, decision tree, random forest, k-nearest neighbors (KNN), and logistic regression approaches. In aspects, supervised learning can use labeled data.

In unsupervised learning, no targets are used. Instead, these approaches cluster populations into different groups according to pattens. Examples of unsupervised learning approaches include the Apriori algorithm and the K-means approach.

As mentioned, the training of the neural network may be made by labeled or unlabeled data. Labeling typically takes a set of unlabeled data and attaches or associate each piece of it with a tag or label. For example, a data label might indicate whether data is from a particular component, person, vehicle, time, or operation condition to mention a few examples. An operator makes judgments about a given piece of unlabeled data. Training may be accomplished using unlabeled data as well.

It will be appreciated that the structure of the neural network is physically changed or transformed as the neural network is trained. In examples, weightings used by the network are changed. In other words, the neural network as represented in electronic memory is physically changed.

As mentioned, the machine learning algorithms 904 may be of any structure or combination of or usage of structures such as files, data structures (within the files), computer code, pseudocode, graphs, vectors, weightings, mathematical equations, mathematical constructs, or algorithms to mention a few examples. These structures, in one example, are used to form neural networks. As mentioned, these structures may be stored in electronic memory. After the neural network is trained, a control circuit or other electronic processing device may apply inputs to the neural network in the memory, and the processing device or control circuit generates outputs from the neural network.

It will also be appreciated that multiple machine learning algorithms 904 can be utilized. For example, multiple neural networks can be used with each neural network assigned to a driver. On the other hand, a single neural network that models all drivers may be utilized. In other examples, separate and multiple neural networks may each be assigned to or make predictions concerning a particular geographical location, a particular vehicle component, particular intended actions (suggestions as to vehicle services, predictions as to vehicle parts, predictions that are used to control signals). The neural networks can be deployed at a central location, multiple central locations, at retail stores, at the vehicles, or combinations of these locations. It will be appreciated that the neural networks may be coupled together used any appropriate electronic communication network structure.

As mentioned and in one specific example, the machine learning models 904 are neural networks. The neural networks can have various layers and each of the layers performs one or more specific functions. In some aspects, these layers form a graph structure with vectors or matrices of weights with specific values. For instance, an input layer receives input signals or data and transfers this information to the next layer. One or more other layers perform calculations or make determinations on or involving the data. An output layer transmits the result of the calculations or determinations. If the network is a convolution neural network (CNN), one or multiple convolutional layers are included in the network structure. In aspects, the convolutional layers apply a convolutional function on the input before transferring it to the next layer.

In other aspects, the neural networks include neurons, which are interconnected by connections or edges. In some examples, the neurons are formed into layers. Different layers may perform different transformations on their inputs. Signals travel through the neural network from the input layer, through other layers, and then through the output layer.

Each connection transmits a signal to other neurons. A neuron receives a signal then processes it and can signal neurons connected to it. In examples, the signal at a connection is a number (e.g., a real number). The output of each neuron is computed by a function of the sum of its inputs. Neurons and edges may have a weight that changes as the neural network is trained. In aspects, the weight increases or decreases the strength of the signal at a connection.

It will be appreciated that neural networks are one example of machine learning algorithms. Other examples include linear regression, logistic regression, decision tree, Bayer, and random forest algorithms. Still other examples are possible. These algorithms can be substituted for the neural networks described herein.

The database 906 is any type of electronic memory storage device. In aspects, the database 906 stores data relating to vehicle components such as products/services data models. The data models (as described above) may comprise data structures that include performance information for products such as tires. Performance information on tires may include, for example, tire information such as wear patterns and other performance based on temperature, road surface, load, acceleration, range, etc. Other examples of such products/services data models may include models for brakes, engine oil, transmission oil, oil filters, air filters, spark plugs, fuel, engine-mapping units, turbo chargers, superchargers, REV, etc. Optimum operating parameters, pricing, test results, and other information may be included with these data models. The data models may be updated over time, for examples, as test results change or new test results are added or incorporated.

Neural networks and Artificial Intelligent (AI) systems generally train their AI engine at least via trial and error. The error can be measured based on buyer satisfaction, advertising revenue, successful transactions completed withing a product or market or any suitable performance indicator. For example, if the performance indicator indicates a high degree of success then the system 900 may not need training or may be protected from potentially harmful training. If, however, the performance indicator indicates a low degree of success, then self-training and improvements can be performed. For example, scenarios of selected training data can be parsed and analyzed to identify faulty or poorly correlated training data. Scenarios that show removal of a subset of data result in a higher degree of success then the system 900 may revise the data accordingly.

The vehicle 908 is any type of vehicle such as an automobile, truck, aircraft, train, or ship to mention a few examples. Other examples of vehicles are possible.

The sensors 910 in the vehicle communicate with a vehicle control unit 918. The sensors 910 are deployed at components of the vehicle such as tires, brakes, brake pads, windshield wipers, radios, entertainment systems, engines, to mention a few examples. Examples of the sensors 910 include radar, LIDAR, cameras, ultrasonic sensors, GNSS, accelerometers, ABS/ESC sensors, and other vehicle environmental sensors. Other examples are possible.

The vehicle components mentioned herein may be tuned, changed, exchanged, or altered. In some examples, electronic control signals from the control circuit 902 may tune, change, or alter operating parameters of the components (e.g., tuning a radio). The vehicle control unit 918 also communicates with and in some cases controls components of the vehicle. In other cases, control signals from the control circuit 902 are received at the vehicle control unit 918 and forwarded to the components. In other examples, the vehicle control unit 918 includes, is associated with, or is incorporated with a display and signals from the control circuit 902 are forwarded to the vehicle control unit 918 for rendering on the display. In still other examples, the vehicle control unit 918 receives the signals, and the signals are transmitted or forwarded to mobile electronic devices of the driver or passengers in the vehicle 908.

The sensors 910 obtain various type of data including data concerning or describing road conditions, personal driving style data, wear indicators, etc. and vehicle-related products/services. For example, excessive brake wear and fast speeds define an aggressive driving style. That is, the data taken together can signify the aggressive style of driving. Other styles of driving may include conservative, frequent, occasional, infrequent, safe, or reckless to mention a few examples. The approaches herein do not have to label the style expressly. Instead, the style (whatever it is) may be associated with a particular driver and, for example, may be associated with certain results (e.g., component wear).

The other vehicle 916 includes the same or similar components and functions in a similar way as described above. The other vehicles have sensors that are the same or similar to the sensors 910.

The roads 912 are any type of transportation structure that can be driven by vehicles such as roads used by automobiles and trucks. However, the roads 912 may include other transportation structures such as railways or waterways as well.

The retail establishment 914 is any type of retail establishment such as a retail store, a distribution center, or a warehouse.

The vehicle control unit 918 is a unit deployed in the vehicle that communicates with the control circuit 902 via a network 920. In some examples, the other vehicles 916 and their sensors also communicate with the control unit 918 via the network 920. The vehicle control unit 918 may comprise an electronic processing device, memory, a transmitter (e.g., to send messages over the network 920), and a receiver (e.g., to receive messages from the network 920).

The driver may have or utilize an electronic device 922. The electronic device 922 may comprise a screen (e.g., to display messages), an electronic processing device, memory, a camera, other sensors, a transmitter (e.g., to send messages over the network 920), and a receiver (e.g., to receive messages from the network 920). In aspects, the electronic device 922 allows the drivers to receive messages from the control circuit 902. In examples, the electronic device 922 is an HMI system such as an infotainment, telematics system or service, smartphone, laptop, tablet, or personal computer and appropriate application(s). The control circuit 902 may communicate with the electronic device 922 using the vehicle control unit 918 or using the electronic communication network 920.

In one example of the operation of the system of FIG. 9 and once the machine learning algorithm(s) 904 is trained or formed, a driver arrives at the retail establishment 914. The driver enters or indicates into the electronic device 922 an inquiry involving tires. In one specific example, the driver takes a picture of one of the tires of the vehicle 908 with the camera on the electronic device 922 since they are interested in determining whether the product such as tires need to be replaced, upgraded, or changed. This image is sent to the control circuit 902 via the network 920. Alternatively, it may be automatically sensed (e.g., using geo-tracking systems to determine the location of the driver or vehicle 908) that the driver enters the retail establishment 914 and an inquiry message is automatically generated. The camera images may include information indicating the identity of the driver, the vehicle 908, or the images may themselves uniquely identify a tire as belonging to the vehicle 908 (e.g., the images of the tire may include visual cues or images of scratches, marks, lettering, numerals, or other visual cues on the tire that associate the tire to the driver or vehicle 908).

In examples, the images from the camera from the device 922 are sent via the network 920 and control circuit 902 and applied to the machine learning algorithm 904. In this example, the machine learning algorithm 904 is a neural network. The neural network has been trained to personalize product recommendations, predictions, or insights for customers. As mentioned, the factors influencing the recommendation may be weighted due to importance of different factors. In aspects, the neural network has been trained with the user criteria such as particular driving style, patterns, tire wear patterns of the specific driver of the vehicle 908. Data models contained in the database 906 may also be used to train the neural network. For example, the particular components or component models (e.g., tire brand or manufacturer) may have physical specifications, dimensions, or characteristics that can be used to train the machine learning algorithm 904 (e.g., neural network).

The neural network has learned what optimal, sub-optimal, defective and properly operating tires look like (based upon the training) and makes a recommendation or prediction based upon the applied inputs and how the network has been trained. For instance, images of flat tires, tires with nails impaled in the tires, and properly inflated tires have been used to train the neural network. In addition, the neural network has been trained with data (e.g., possibly including images) concerning the driving pattens of the driver often vehicle (e.g., how often they drive the vehicle 908, the speeds employed by the driver, the distances traveled, specific wear on the brake pads, and maximum accelerations of the vehicle 908 to mention a few examples). In addition to the images, the neural network may receive the actual tire pressure data from the tires of the vehicle 908 for training purposes.

Applying the images from the camera of the device 922 to the trained neural network obtains an output or result (e.g., the tires need to be replaced), a recommendation (replace tire with brand X), and/or a timing (replace your tires in the next month since they are predicted to go bad in the next month). The output is processed by the control circuit 902 and may be used to control or instigate specific physical actions including ordering a product (e.g., a tire), installing the tire on the vehicle 908, or modifying a component on a vehicle 908. The control circuit 902 can utilize the output to accomplish these results, for example, by forming control signals or other signals that send or communicate images or messages to the driver (e.g., being displayed to the driver via their device 922), instigate a product order (e.g., that causes a product such as a tire to be manufactured), or communicate a message to a store employee that causes the employee to change the tire.

In other examples, the approaches described herein enhance the driver experience as the driver operates the vehicle 908 in real-time. In one particular example, the machine learning algorithm 904 is a neural network that has been trained to set, define, refine, and/or tune the entertainment system or other components of the vehicle 908 (e.g., backlighting of the instrument panel of the vehicle 908).

As mentioned and in this example, the machine learning algorithm 904 is a neural network. The neural network has been trained according to the driving patterns of the driver. For example, the driver operates the vehicle a certain way on certain types of roads, at certain speeds, or travels at certain times of the day to certain locations or has taken trips of certain lengths. These patterns maybe indicated by the detected speeds, accelerations, or component wear (to mention a few examples) of the vehicle 908. In still another example, the driver prefers certain music at certain times of day or lights the instrument panel at a certain brightness under certain environmental conditions or times of days. Data from other drivers of the other vehicles 916 may also be considered and used to train the neural network but is not given the same weight as data from the vehicle 908 (e.g., the data from the vehicle 908 may be given more weight). The financial ability of the customer to pay (e.g., from credit records from one of the data models in the database 906 and to direct advertising described in more detail below) may also be used to train the neural network. All of this data is used to train the neural network to produce outputs that may include, in aspects, music and instrument panel brightness recommendations, or actually control one or more components of the vehicle 908.

In this specific example, the driver is driving the vehicle 908 on roads 912 and sensors (e.g., cameras) on the data obtain images of the road 912 or the time of day. This information is applied to the neural network to produce a recommendation for music and instrument panel brightness. The images and the time are ingested by the neural network to make a prediction not only as to what the image is, but using the trained neural network, to determine what the inputs mean or signify thereby forming a prediction, recommendation, insight, or some other output. If the driver accepts the recommendation or prediction, the control circuit 902 forms a message or control signals concerning, describing, or informing the recommendation, prediction, or insight that are sent to the vehicle control unit 918, which in turn forms control signals that control the entertainment system and backlighting of instrument panels of the vehicle 908 accordingly. In some examples, the driver approves the recommendations by indicating improved into an interface at the vehicle control unit 918. In some other examples, the driver does not have to approve the recommendations and control by the control circuit 902 of the vehicle components occurs automatically.

In another specific example, images of the road 912 and other vehicles on the road 912 are ingested by the neural network. The neural network has been trained not only with data concerning the driving style of the driver, but also to recognize unsafe driving conditions (e.g., the vehicle 908 passing over the center line or other vehicles passing within a predetermined distance that is too close, e.g., hazardous, to the vehicle 908). In this case, the neural network produces recommendations for changing the course of the vehicle 908. These recommendations by the control circuit 902 can be sent to the vehicle control unit 918, and the vehicle control unit 918 forms control signals that actuates (or deactivates) components such as steering components (e.g., to steer the vehicle 908 away from a hazard) or apply the brakes.

In still other examples, the output of the machine learning algorithm 904 can be used to form a control signal to control a component of a vehicle (flash a warning light, instruct the driver to do something) or may be a customized prediction based upon habits of the driver (e.g., a customer facing product recommendation based upon the customized use of a particular driver predictions) as to component wear based upon driving patterns. In yet other examples, the vehicle 908 includes multiple drivers and recommendations are formed for each of the drivers and/or based upon which driver is operating the vehicle 908 at a current moment in time. To determine driver identity, information such as the identity of the device 922 used (which indicates the driver) may be utilized. Other examples are possible.

In still other examples, data (e.g., time and brake wear data) is obtained as the vehicle 908 is operated. The data is applied to the machine learning algorithms 904 (a neural network) and a prediction as to brake condition is made. For example, the neural network predicts that the brakes will wear out based upon the style of the driver (as reflected by the trained neural network). The neural network may then recommend the optimal type of brake pad best suited for the user and vehicle, such as street, low dust, high performance, track and racing brake pads. The neural network can also have been trained with information from the data models in the database 906 and this information may include testing results of tires, and physical characteristics of particular tires. It will be appreciated that the neural network can be refined over time as the driver's driving patterns change, as components, as test results changes, and as tire specifications change. Consequently, the machine leaning algorithms 904 (e.g., neural networks) described herein and in aspects are dynamic and changeable over time.

It will be appreciated that the approaches described herein can also be applied to digital advertising. For example, the output of the machine learning algorithms 904 (e.g., a neural network) can be used to create advertisements based personalized recommendations for a specific driver. Advertising can be created by the control circuit 902 and pushed to the device 922 via the network 920 to inform the driver of recommendations. In one example, an “operator” of the vehicle products and services system 900 (control circuit 902, machine learning algorithms 904, database 906) generates personalized recommendations in the form of personalized advertisements for tires to drivers before the drivers are even considering tire replacements. Tire manufacturers, distributors, retailers (web and brick and mortar/physical), could pay an advertising fee to the operator for providing product and service recommendations. Based on the output of the machine learning algorithms 904 the top choices, for instance, the top 1, 2, 5, 10 or 20 product recommendations may be reduced to a single product recommendation. The manufacturer of that product could offer or contract to pay advertising revenue to the operator of the machine learning algorithms 904 for the recommending the manufacture's product(s). The operator thus generates revenue by advertising their products when recommended to buyers such as drivers and vehicle owners. Advertisements for vehicle entertainment system upgrades can be sent to the driver and these are personalized based upon the driving patterns of the driver. The buyer can provide verified purchaser reviews to further improve the training and performance of the system 900. System 900 may also similarly recommend other products such as brake pads, rotors, gasoline, fluids such as brake fluid, wiper fluid, coolant, gear lubricant, transmission fluid, REV charging time, rates and locations, or other products in exchange for advertising revenue for these recommendations. The advertising rate can be based on whether the sale was completed, the frequency of referrals, buyer reviews, a ratio of purchases per recommendations, an effectiveness of recommendation score or any other suitable payment basis or combination. Among other advantages, the product recommendations are much more effective than conventional search engine recommendations because the product recommendations are highly customized based on extensive product testing, consumer and driver driving data and preferences and as described. As such system 900 provides an optimal and thus a superior form of advertising and thus higher advertising revenue and monetization than conventional advertising. Other product and monetization business examples are possible.

It will be appreciated that the approaches herein result in changes, modifications, and transformations to physical objects, components, and devices. For example, vehicles are serviced and parts replaced based upon recommendations made by the machine learning algorithms 904. Orders for parts are created and sent to manufacturers, which manufacture the parts and deliver them to customers. Components of vehicles are controlled based upon the output of the machine learning algorithms 904. The machine learning algorithms 904 may themselves be refined, modified, and changed (e.g., during a training process or afterward during operation).

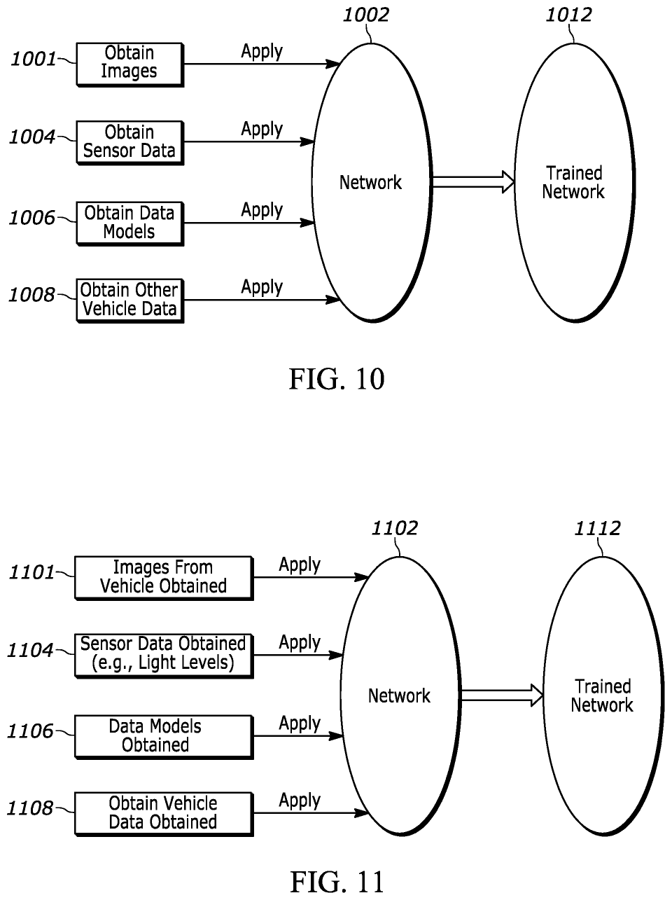

FIG. 10 is a flowchart of an approach for training a machine learning algorithm in accordance with some embodiments.

Referring now to FIG. 10, one example of training machine learning algorithms when the machine learning algorithm is a neural network 1002 (and is trained to produce a trained network 1012) is described. In this example, the neural network 1002 is trained to become trained neural network 1012 based upon a specific driver and is trained to offer recommendations for purchasing products such as tires and services such as tire mounting services. It will be appreciated that this is one example and that other examples are possible. It will also be appreciated that the example training data may also be changed as can the weighting approach for training the network 1002 using this data.

In this example, the neural network 1002 is trained using training data sets that include images and/or other sensor data. The images may be obtained by cameras or other sensors and may be in any appropriate format. The other data may be obtained by other sensors at the vehicle, from other vehicles, or product specifications to mention a few examples. At step 1001, images are obtained from a vehicle as the driver operates the vehicle. In one example, the images are of the tires of the vehicle. The images can be supplemented with other sensor data in the training process. A user may label these as pictures of the tires or road, as being from the driver, or as showing particular road conditions to mention a few examples. In other examples, the images may be unlabeled. In aspects, these images show the type of roads travelled and the type of tire wear occurring. This data may be given a first weight.

At step 1004, sensor data from the vehicle showing wear or usage pattern of a product such as a tire is obtained. In examples, this data may show specific wear patterns on tires. In another example, this data shows the speeds travelled by the vehicle. This data may be given a second weight and may be labeled or unlabeled. This data may be correlated with the data of step 1001.

At step 1006, information from data models representing the tires is obtained from a database. In example, this data shows testing results associated with a product such as tires and the wear patterns of the tires. The data may also indicate physical characteristics (e.g., dimensions, construction materials or weight to mention a few examples) of the tires on the vehicle. Testing results for particular tires may also be included. This data may be given a third weight and may be labeled or unlabeled. Tire testing criteria may include tread wear, dry/wet/snow braking cornering and maximum lateral acceleration normalized as a unit of g-force. The database may contain testing criteria covering most tires in various categories, such as high-performance/max/extreme summer, touring/GT/standard/passenger/crossover/SUV/high performance all-season, winter/snow/performance winter/snow, track, drag, racing or any suitable category or market.

At step 1008, data from other vehicles and/or other drivers of the same vehicle is obtained. This data may show specific wear patterns on tires. In another example, this data shows the speeds travelled by the other vehicles. This data may be given a fourth weight and may be labeled or unlabeled. The fourth weight may be less than the other weights are selected ones of the weights.

The weights indicate the importance of the particular information associated with the weight and the significance of that information in making the recommendation. For example, the weight of information from the driver of the vehicle may be given much more significance in the neural network 1002 in making the recommendation than information from other drivers.

In aspects, the trained network 1012 has been trained to produce outputs of (1) recommendations for replacement parts based upon the inputs, and (2) recommendations for service patterns based upon receipt of certain inputs. In aspects, these inputs are selected so that the network 1012 is triggered to produces a prediction upon receipt of these inputs. For example, a time or date (e.g., in the case where a customer desires a periodic prediction to be produced) or image (showing potential wear of a product such as a tire) is ingested into the neural network 1012 and this causes the network 1012 to produce a prediction as to the wear of the tire and/or a recommendation as to servicing the tire (e.g., replacing the tire). The recommendation may be for certain brands, types, or kinds of tires. The outcome of the training process is the trained neural network 1012.

In aspects, the neural network 1002 (and trained network 1012) includes various layers, edges, and weights. In examples, the neural network 1002 is trained using an optimization algorithm and weights are updated using a backpropagation of error algorithm or function. The network 1002 with a given set of weights is used to make predictions and the error for those predictions is calculated. The error algorithm seeks to change the weights so that the next evaluation reduces the error, meaning the optimization algorithm reduces the error. In examples, it is desired to minimize the error and a loss function is used to calculate an error or loss. As the training occurs, the neural network 1002 is changed and optimized as its weights and potentially other features are optimized.

FIG. 11 is a flowchart of an approach for training a machine learning algorithm in accordance with some embodiments.

Referring now to FIG. 11, one example of training machine learning algorithms when the machine learning algorithm is a neural network 1102 is described. In this example, the neural network 1102 is trained to become trained neural network 1112 based upon a specific driver and is trained to offer recommendations for changing the setting of the entertainment system and instrument panel background lighting as the driver operates the vehicle in real-time. It will be appreciated that this is one example and that other examples are possible. It will also be appreciated that the example training data may also be changed as can the weighting approach for training the network 1102 using this data.

At step 1101, images are obtained from a vehicle as the driver operates the vehicle. The images may be obtained by cameras or other sensors and may be in any appropriate format. The images may show the lighting conditions at the vehicle, the activities of the driver, particular settings of the entertainment system made by the driver, or the number and characteristics of passengers in the vehicle to mention a few examples. A user may label these as pictures (as being from the driver or as showing particular lighting conditions) or the images may be unlabeled. This data may be given a first weight.

At step 1104, sensor data from the vehicle is obtained. In an example, the data shows the light level of the environment in which the vehicle is operating. The light level may indicate the intensity, amount, brightness of light (e.g., visible light), generally describes the illumination at, in, or around the vehicle, and may be in any appropriate units. In yet another example, the data shows the time of day from a clock (e.g., on board the vehicle or at a central location). In other examples, this data shows settings of the entertainment system (e.g., sound volume levels during certain time periods, radio stations tuned to for listening and for how long). This data may be given a second weight and may be labeled or unlabeled. This data may be correlated with data received at step 1101.

At step 1106, information from data models showing specifications of the entertainment system and financial information of the customer (e.g., credit card details or previous purchases) is obtained from a database. This data may be given a third weight and may be labeled or unlabeled.

At step 1108, data from other vehicles and/or other drivers of the same vehicle is obtained. The data may show the light levels used by other customers and for which conditions the lighting levels are used. In other examples, this data shows settings of the entertainment system of other drivers (e.g., sound volume levels, radio stations tuned to and for how long). This data may be given a fourth weight and may be labeled or unlabeled. The fourth weight may be less than the other weights are selected ones of the weights. The weights indicate the importance of the particular information associated with the weight and the significance of that information in making the recommendation. For example, the weight of information from the driver of the vehicle may be given much more significance in the neural network 1102 in making the recommendation than information from other drivers.

In aspects, the trained neural network 1102 has been trained to produce outputs of (1) recommendations for entertainment system settings, and (2) recommendations for lighting levels. For example, a time or image is ingested into the neural network 1112 and this causes the network to produce a recommendation as to the setting of the entertainment system and settings of the back panel lighting. In examples, these are presented the user on a screen, e.g., a screen on a user device or on the vehicle control unit). In other examples, the recommendations are received by a vehicle control unit or other processing device at the vehicle and control signals are formed to implement the recommendation (e.g., issue a control signal that adjusts the back panel lighting). It will be appreciated that the outcome of the training process is the trained neural network 1112.

In aspects, the neural network 1102 (and the trained neural network 1112) includes various layers, edges, and weights. In examples, the neural network 1102 is trained using an optimization algorithm and weights are updated using a backpropagation of error algorithm or function. The network 1102 includes a given set of weights is used to make predictions and the error for those predictions is calculated. The error algorithm seeks to change the weights so that the next evaluation reduces the error, meaning the optimization algorithm reduces the error. In examples, it is desired to minimize the error and a loss function is used to calculate an error or loss. As the training occurs, the neural network 1102 is changed and optimized as its weights and potentially other features are optimized.

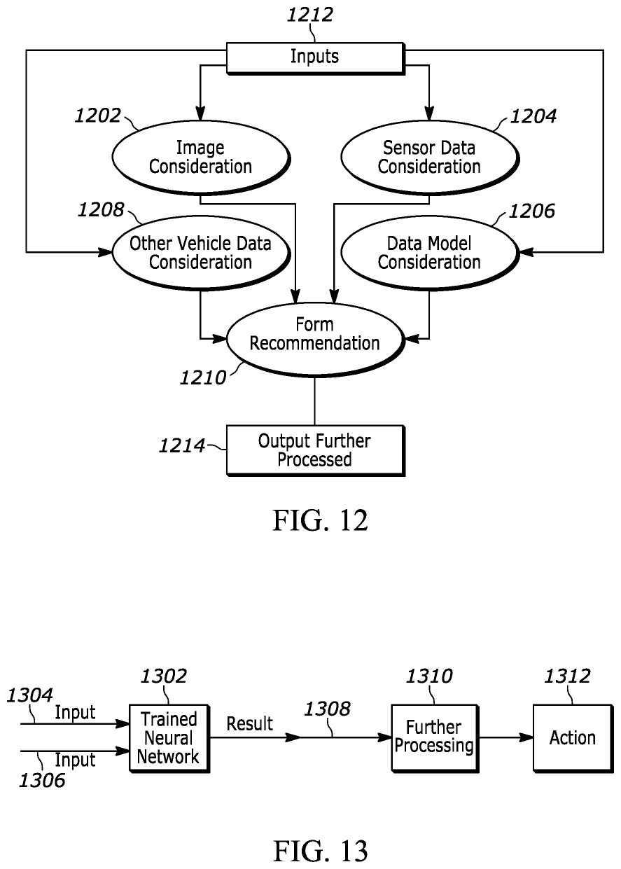

FIG. 12 is a diagram of a structure of a machine learning algorithm in accordance with some embodiments.

Referring now to FIG. 12, one example of a structure of a machine learning algorithm is described. The structure of FIG. 12 may be implemented as a neural network, model, or some other machine learning algorithm or approach. It will be appreciated that the example of FIG. 12 shows one example of the logic and decision-making process of a machine learning algorithm and does not specify an exact structure. For example, if the structure of FIG. 12 is implemented as a neural network one skilled in the art would understand how to implement this particular structure as a neural network including input, output, and intermediate layers, weights, edges, and other components.

At a high level, step 1212 is an input step where inputs can be, for example received and routed to other steps. Steps 1202, 1204, 1206, 1208, and 1210 process and evaluate the input to form (at step 1210) a recommendation as described. Step 1214 transmits the output to another entity for further processing.

More specifically, step 1202 considers and has been trained with information such as tire forces, temperature miles and wear and optionally video images showing tire wear and is given a first weight W1. At this step, it is determined whether information and optional current images supplied by the customer indicate wear, and if so, a positive weight W1 is assigned. The weight W1 may be adjustable based upon how certain the determination is. If there is no excessive wear, then a negative or zero weight is assigned. In aspects, training refines this step to more correctly identify images with tire wear as more images are processed.

Step 1204 considers and has been trained with tire wear from sensor data and is given a second weight W2. At this step, it is determined whether the current sensor data indicates wear, and if so, a positive weight W2 is assigned. If there is no excessive wear as indicated by the sensor data, then a negative or zero weight is assigned. In aspects, training refines this step to correctly identify certain data as indicating tire wear.

Step 1206 considers and has been trained with information from data models representing previous customer purchases and preferences. For example, the brand the tires the customer prefers may be specified. In aspects, training refines this step to correctly identify information that defines a customer's purchase history accurately.

At step 1208, considers and has been trained with data from other vehicles and/or other drivers of the same vehicle and is given a second weight W3. At this step, it is determined whether the data matches data from the customer indicating wear, and if so, a positive weight W3 is assigned. Otherwise, the weight may be zero or negative. In aspects, training refines this step to correctly identify certain data as indicating tire wear in the other vehicles.

At step 1210, a recommendation to replace the tire is formed if W1+W2+W3 is greater than a threshold is formed. The recommendation may identify the tires for replacement from step 1206.

Inputs 1212 (which themselves may be tire images of the customers tire in its present state, a message from a customer, tire data, or other information) are received and cause the steps 1202-1210 to be executed. It will be appreciated that not all the steps 1202-1208 need be executed and that other intermediate steps (e.g., routing data) may also occur.

At step 1214, the output is transmitted or output for further processing or consideration, for example, by the control circuits described herein.

FIG. 13 is a flowchart of an approach for operating a machine learning algorithm in accordance with some embodiments.

Referring now to FIG. 13, one example of operating the machine learning algorithm when the algorithm is a neural network is described. Various inputs are applied to a trained neural network 1302.

At step 1304, images are obtained from a driver or customer (e.g., a photo of their tire made using their smartphone camera) and are applied to the trained network 1302. These images may be used to cause the trained model 1302 to produce a result.

At step 1306, sensor data (e.g., from sensors on a vehicle or from other devices) is applied to the trained model 1302. This data may be a time of day or information that identifies the customer or driver.

At step 1308, the trained model produces a recommendation, prediction, or insight as described elsewhere herein.

At step 1310, the recommendation, prediction, or insight may be further processed, e.g., by a control circuit, to perform a physical action.

At step 1312, an action may be taken as described elsewhere herein.

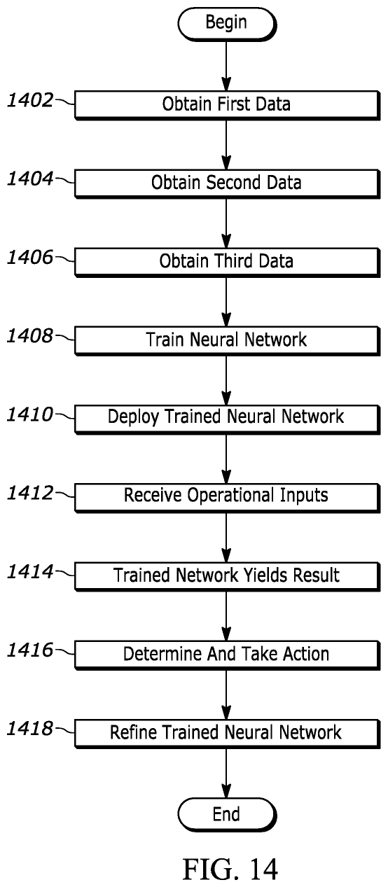

FIG. 14 is a flowchart of an approach for making predictions, recommendations and/or control of vehicle products, components, and services in accordance with some embodiments.

Referring now to FIG. 14, one example of an approach for training and then using trained algorithms such as neural network is described.

At step 1402, first data from sensors of a vehicle is obtained. The vehicle is driven by a driver and the data describes describing conditions of components of and specifies an individual driving pattern or style of the driver. The pattern defined includes habits of the driver (e.g., driving at high rates of speed or constantly braking the vehicle), but also may define temporal-related habits (driving slow at night or during rainy conditions).

At step 1404, second data from other drivers is obtained. The data describes driving patterns of the other drivers.

At step 1406, third data concerning operating parameters of the components of the vehicle is obtained. For example, these may include dimensions, size, testing results concerning the vehicle components. In a specific example, it may include the size, make, model, and manufacturer of the tires of the vehicle as well as testing results concerning the tires. Other examples are possible.

At step 1408, a neural network (or other machine learning algorithm) is trained based upon the first data, the second data, and the third data. The trained neural network makes predictions concerning one or more of (1) vehicle components of the vehicle, (2) upgrades to the vehicle components, (3) and maintenance events related to the components, the training creating a trained neural network. Other examples are possible.

The training of the neural network is accomplished by weighting differently the importance of the first data, the second data, and the third data.

At step 1410 and subsequently, the trained neural network is deployed. The deployment may be at a central location, at the vehicle, split between these locations, or at some other location or combination of locations.

Subsequently, at step 1412, one or more operational inputs are received from the sensors, from the driver, or from an external source and, at step 1412, the one or more operational inputs are applied to the trained neural network.

At step 1414, the applied inputs cause the network to yield an insight or prediction from the trained neural network concerning one or more of: (1) the components of the vehicle, (2) the upgrades to the components, (3) and the maintenance events related to the components. Other examples are possible.

At step 1416, a control circuit determines an action based upon the insight or prediction. The action is one or more of the control circuit determining an upgrade of a first selected one of the components of the vehicle and sending first signals to the driver describing the recommended upgrade, the upgraded first selected one of the components is installed in the vehicle; the control circuit sending a control signal to a second selected vehicle component to control or change an operating parameter of the second vehicle component; the control circuit recommending a product or service to the driver based upon the insight or prediction and sending second signals to the driver describing the recommended product or service; the control circuit recommending maintenance of the vehicle to the driver based upon the insight or prediction and sending third signals to the driver describing the maintenance and the vehicle is serviced and at least one of the components changed according to the maintenance event; the control circuit forming and sending an advertisement; or the control circuit forming a customer order for a part to be placed in the vehicle, the order transmitted to a manufacturer causing the part to be manufactured by a manufacturer. Other examples of actions are possible.

At step 1418, after the deployment of the trained neural network, the trained neural network is retained, refined, or changed to reflect the continued changes to the driving pattern of the driver. Other data (e.g., testing results) may be updated and used to refine the trained neural network to account for the changes and making the recommendations and predictions made by the trained neural network more effective or accurate.

Secured sales transactions and communication in the network between resources may occur or be performed over a blockchain network. For example, the user equipment at various vehicles, devices within vehicles, and a central server may be nodes in this network. A blockchain is a data structure that stories a list of transactions and can be thought of as a distributed electronic ledger that records transactions between source identifier(s) and destination identifiers(s). The transactions are bundled into blocks and every block (except for the first block) refers to or is linked to a prior block in the blockchain. Computer resources or nodes maintain the blockchain and cryptographically validate each new block and the transactions contained in the corresponding bloc. Such a validation process includes computationally solving a resource intensive problem that is also easy to verify and is itself a proof of work, such as a hash function. Security may further be provided for example for the testing information as appropriate to maintain the confidential and proprietary nature of the testing information.

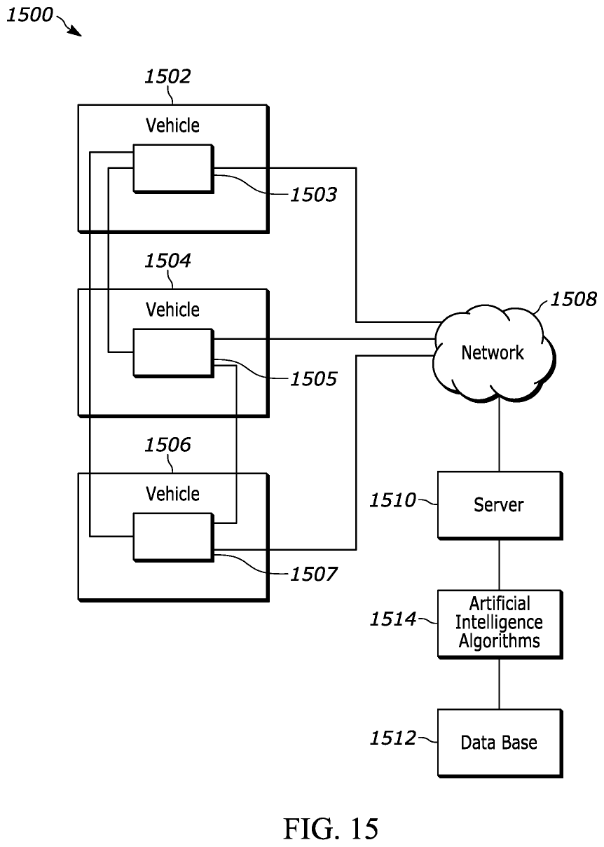

FIG. 15 is a diagram of a structure of a system in accordance with some embodiments.

Referring now to FIG. 15, one example of a system 1500 according to embodiments of the present application is described. The system includes vehicles 1502, 1504, and 1506, an electronic communication network 1508, a central server 1510, a database 1512, and artificial intelligence algorithms 1514.

The vehicles 1502, 1504, and 1506 are any type of vehicles such as cars or trucks. Other types of vehicles are possible. The vehicles 1502, 1504, and 1506 include various sensors. The sensors could be brake sensors, brake wear sensors, temperature sensors, or tire pressure sensors to mention a few examples. The vehicles 1502, 1504, and 1506 include user equipment 1503, 1505, and 1507 that is utilized by the driver or passenger of the vehicle. The user equipment 1503, 1505, and 1507 may be infotainment, telematics, cellular phones, smartphones, tablets, laptops, personal computers, or other types or combinations of user devices. The user equipment 1503, 1505, and 1507 may also be a vehicle control unit that is included or incorporated into the vehicle. The vehicle control unit may have a user interface including a display and may also communicate with the central server 1510.

In aspects, the vehicle control unit may perform various functions that monitor, determine and/or control vehicle operations. In other aspects, the user equipment 1502, 1505, and 1507 may be a combination of user devices (e.g., smartphones) and the vehicle control unit.

The vehicles 1502, 1504, and 1506 include local memories at each of the vehicles 1502, 1504, and 1506 that store information that may be transmitted to the artificial intelligence algorithms 1514. The user equipment 1503, 1505, and 1507 may also have memories that store information that may be transmitted to the artificial intelligence algorithms 1514.

The electronic communication network 1508 is any type of electronic communication network such as a wireless network, cellular network, the internet, wide area networks, local area networks, or combinations of these or other networks.

The central server 1510 may include a control circuit or other electronic processing device. The central server 1510 may incorporate or include the database 1512 and artificial intelligence algorithms 1514.

The database 1512 is any type of electronic memory storage device. In one example, the database 1512 stores historical information concerning the driving history of the drivers, and past sensor readings of sensors on the vehicles 1502, 1504, and 1506 to mention two examples.

The artificial intelligence algorithms 1514 may be any type of artificial intelligence algorithm or combination of algorithms such as neural networks, other machine learning approaches, or other algorithms, or combinations of these approaches. If neural networks are used, then these may take the form and supply the functionality as described with the neural networks described elsewhere herein. The artificial intelligence algorithms 1514 may be a single algorithm or structure of multiple algorithms or structures. It will be appreciated that the terms artificial intelligence algorithms and machine learning algorithms are used interchangeably herein.

In one example of the system of FIG. 15, the vehicles 1502, 1504, and 1506 communicate with each other and with the server 1510. These types of interactions are described in greater detail below and generally describe the exchange of selected information between the vehicles 1502, 1504, and 1506 without the involvement of the central server 1510. Information from a first vehicle can be sent to a second vehicle, via transmitters/receivers in each of the vehicles. For instance, information regarding incentives can be sent from the first vehicle to the second vehicle to encourage an occupant in the second vehicle to take advantage of the incentive. An incentive may be used to encourage the occupant to sign up for a service or purchase a product. An incentive could also be used to encourage the sharing of data. As shown in FIG. 15, communications may be directly between user equipment in each vehicle or via the network 1508.

In other examples, information may be distributed across memories or databases in the system. Some information (e.g., of a first importance) may be stored locally at the vehicles 1502, 1504, and 1506 while other information (of a second importance) stored at the central server 1510 or database 1512. In one example, the first importance is greater than the second importance. Importance may be determined based upon various factors such as the source or age of the information.

The central server 1510 may execute or assist in execution of the artificial intelligence algorithms 1514. For example, data gathered from the vehicles 1502, 1504, and 1506 and from the database 1512 may be used or processed by the artificial intelligence algorithms 1514 to make predictions, recommendations, or instigate actions with respect to individual ones of the vehicles 1502, 1504, and 1506 or the drivers of these vehicles. The artificial intelligence algorithms 1514 can also form, create, and/or direct advertising to the vehicles 1502, 1504, and 1506. Other actions and approaches can be taken by the central server 1510 as discussed elsewhere herein.

It will be appreciated that the approaches described herein create a dynamically changing body of knowledge for the system 1500 from which the artificial intelligence algorithms 1514 (e.g., neural networks) can make decisions. This knowledge base depends upon which devices or vehicles/are currently powered-on and connected to the artificial intelligence algorithms 1514 (e.g., neural network). This changes the functionality of the artificial intelligence algorithms 1514 (e.g., neural network) because the available knowledge will change from moment to moment as devices are turned on or off and thus change their contributions to the overall body of available knowledge. Advantageously, real-time trends and positions of vehicles are taken into account by the artificial intelligence algorithms 1514 (e.g., neural network) for producing recommendations or insights.

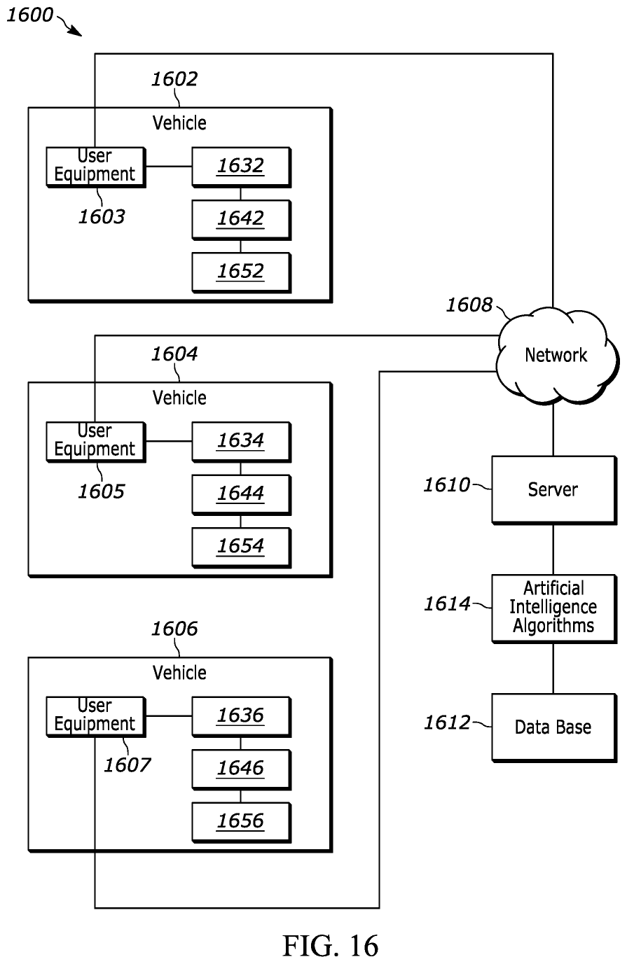

FIG. 16 is a diagram of a structure of a system in accordance with some embodiments.

Referring now to FIG. 16, one example of a system 1600 according to embodiments of the present application is described. The system includes vehicles 1602, 1604, and 1606, an electronic communication network 1608, a central server 1610 (that executes an artificial intelligence algorithm 1614), and a database 1612. Each vehicle has a processor 1632, 1634, and 1636, and each vehicle has a memory 1642, 1644, and 1646. Each vehicle 1602, 1604, and 1606 has artificial intelligence algorithms 1652, 1654, and 1656. In some examples, the central server 1610 and database 1612 are omitted. In some aspects, the processors 1632, 1634, 1636, memories 1642, 1644, 1646, and artificial intelligence algorithms 1652, 1654, and 1656 are separate from the user equipment 1603, 1605, and 1607. In other examples, the processors 1632, 1634, 1636, memories 1642, 1644, 1646, and artificial intelligence algorithms 1652, 1654, and 1656 are incorporated into the user equipment 1603, 1605, and 1607. As shown in FIG. 16, the elements are separate and the user equipment 1603, 1605, and 1607 communicates with the processors 1632, 1634, 1636, which in turn communicate with the memories 1642, 1644, 1646, and artificial intelligence algorithms 1652, 1654, and 1656. Also as shown in FIG. 16, the processors 1632, 1634, 1636 and user equipment communicate with the server 1610.

The vehicles 1602, 1604, and 1606 are any type of vehicles such as cars or trucks. Other types of vehicles are possible. The vehicles 1602, 1604, and 1606 include various sensors. The sensors could be brake sensors, brake wear sensors, temperature sensors, or tire pressure sensors to mention a few examples. The vehicles 1602, 1604, and 1606 include or a driver (or passengers) has with them associated user equipment 1603, 1605, and 1607. The user equipment 1603, 1605, and 1607 may be cellular phones, smartphones, tablets, laptops, personal computers, or other user devices. The user equipment 1603, 1605, and 1607 may also be a vehicle control unit. The vehicle control unit may have a user interface including a display and may communicate with the central server 1610. In aspects, the vehicle control unit may perform various functions that control vehicle operation. In other aspects, the vehicle control unit may perform other processing functions. In still other aspects, the user equipment 1603, 1605, and 1607 may be a combination of the user devices and the vehicle control unit.

The memories 1642, 1644, and 1646 are any type of electronic storage device and store information that may be used at each vehicle and/or be transmitted to the artificial intelligence algorithms 1614 (or to the artificial intelligence algorithms 1652, 1654, and 1656 of other vehicles). The user equipment 1603, 1605, and 1607 may also have memories that store information that may be transmitted to the artificial intelligence algorithms 1614 (or to the artificial intelligence algorithms 1652, 1654, and 1656 of other vehicles).

The electronic communication network 1608 is any type of electronic communication network such as a wireless network, cellular network, the internet, wide area networks, local area networks, or combinations of these or other networks. The network 1608 can be used by vehicles to communicate with each other or the vehicles can communicate directly with each other (e.g., send/receive transmissions directly to each other).

The central server 1610 may include a control circuit or other electronic processing device. The processing devices 1632, 1634, and 1636 may be any type of electronic processing device such as a microprocessor, microcontroller, digital computer, to any other such device. As mentioned, in some aspects the central server 1610 is omitted completely resulting in a completely distributed processing system. Even when the central server 1610 is retained and in some examples, the central server 1610 does not make predictions, recommendations, or suggest actions but may provide administrative or backup functions for elements of the system 1600.

The database 1612 is any type of electronic memory storage device. In one example, the database 1612 stores historical information for all drivers and vehicles. In some examples, the central server 1610 may communicate selective information (the most relevant information) to individual ones of the vehicles 1602, 1604, and 1606. The information selected may be from certain users or of a certain age or time period to mention a few examples.

The artificial intelligence algorithms 1614, 1652, 1654, and 1656 may be any type of artificial intelligence algorithm or combination of algorithms such as neural networks, other machine learning approaches, or other algorithms, or combinations of these approaches. If neural networks are used, then these may take the form and supply the functionality as described with the neural networks described elsewhere herein.

In one example of the operation of the system of FIG. 16, only select information is sent from the central server 1610 (and other vehicles) to each of the vehicles 1602, 1604, and 1606. For example, only the most relevant trend information (as determined by the central server 1610) is sent by the central server 1610 to each of the vehicles 1602, 1604, and 1606. The artificial intelligence algorithm at a particular vehicle 1602, 1604, and 1606 makes recommendations, and/or predicts or suggests actions that is responsive to the vehicle 1602, 1604, and 1606 and/or the drivers of the vehicle 1602, 1604, and 1606. In other words, the central server 1610 does not make recommendations directly for a particular vehicle. One advantage for this approach is that not only could privacy be maintained at the local user equipment or device 1603, 1605, and 1607 (e.g., infotainment, telematics, smart phone, cellular phone, vehicle control unit) because the local device's stored data is not sent for aggregation to the server 1610, but the user equipment or local devices 1603, 1605, and 1607 can still benefit from the most relevant trends known across multiple devices. In other words, a massive database (i.e., testing information) need not be sent to the vehicles by the central server, but only those data elements that are most likely relevant. Furthermore, a recent version of this data from the server can be stored on the local device and used if connectivity is unavailable when a decision needs to be made.

The vehicle 1602 also collects data. The artificial intelligence algorithm 1652 is a neural network and this makes recommendations to the driver of the vehicle 1602 through a graphical user interface in their user equipment 1603, 1605, or 1607.

In another example, the artificial intelligence algorithm 1614 makes all recommendations, but the artificial intelligence algorithms 1652, 1654, and 1656 may be used as back-up algorithms if connectivity with the artificial intelligence algorithm 1614 is lost.

In still other examples, the artificial intelligence algorithms 1614, 1652, 1654, and 1656 cooperate to make decisions. In aspects, functionality is split or divided between the artificial intelligence algorithms 1614, 1652, 1654, and 1656. In other aspects, the artificial intelligence algorithms 1614, 1652, 1654, and 1656 collectively make decisions (e.g., each may have a vote as to a proposed decision or action with the largest number of votes from all of the artificial intelligence algorithms 1614, 1652, 1654, and 1656 validating a proposed decision or action).

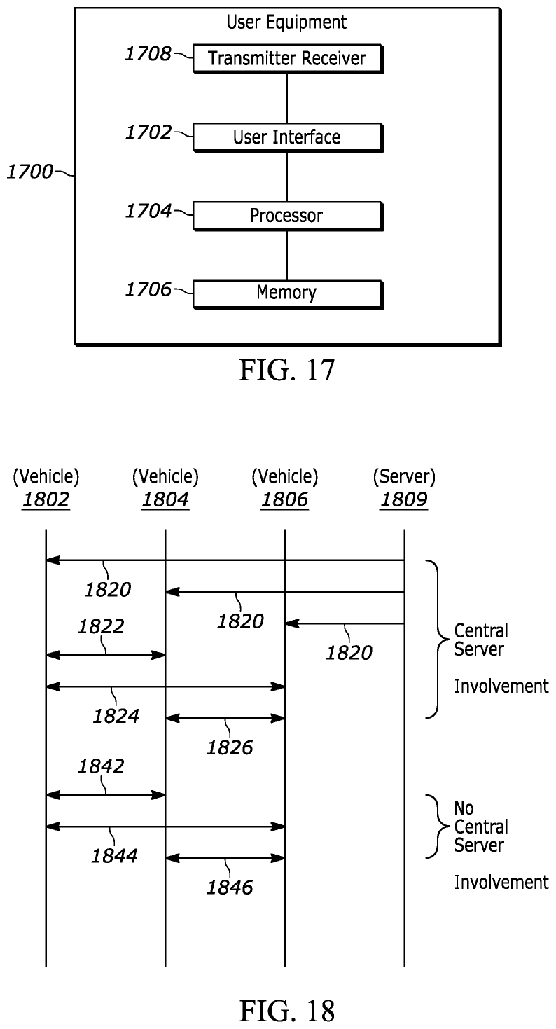

FIG. 17 is a diagram of a system in accordance with some embodiments.

Referring now FIG. 17, one example of user equipment 1700 is described. The user equipment 1700 may be an infotainment device or system, telematics, a smartphone, a cellular phone, a personal computer, a laptop, a tablet, a vehicle control unit, or other electronic devices. The user equipment 1700 includes a user interface 1702, a processor or control circuit 1704, a memory 1706, and a transmitter/receiver 1708. The memory 1706, in aspects, may include one or more programs (vehicle control programs that monitor, control or otherwise interact with components of the vehicle such as a tire pressure monitor system, the engine, the vehicle instrument panel, the vehicle entertainment system, or the vehicle lighting system to mention a few examples), applications, apps, artificial intelligence algorithms (e.g., neural networks), algorithms, or other structures. When the user equipment 1700 is a vehicle control unit, the memory 1706 may include other control programs that control, operate, or monitor vehicle components. The vehicle control unit may also gather data from sensors in or at the vehicle that include brake sensors, engine sensors, and tire sensors to mention a few examples. In still other examples and when the user equipment is a user device such as a smartphone, the user equipment 1700 may also gather sensor data from the vehicle.

The user interface 1702 may be a screen, graphical user interface, touchscreen, or combination of these or other elements. The processor 1704 may be any type of processing device such as a microprocessor, microcontroller, or other type of processing device. The memory 1706 may be any type of electronic memory. The transmitter/receiver 1708 transmits and/or receives data, command, and/or other information to other entities (e.g., a network, a central server, other vehicles). The transmitter/receiver device 1708 may be implemented as any combination of hardware or software. In examples, the transmitter/receiver device 1708 may include an antenna, and processing circuitry that receives messages, transmits messages, and performs formatting operations and conversions to mention a few examples.

In aspects, the user equipment is deployed at the vehicle, for example, a vehicle control unit. In some cases, the user equipment 1700 may be a mobile or portable device carried by a user or driver. In other examples, the user equipment may be permanently or semi-permanently attached or secured to or at a vehicle. If carried by the user, for example, a smartphone, the user equipment may include other functionality such as the ability to make and receive cellular phone calls, send text messages, execute apps, and render video content to the owner of the user equipment.

In one example of the operation of the system of FIG. 17, sensors gather data from the vehicle and the data is stored at least temporarily at the user equipment 1700, for example, in the memory 1706. The data is sent from the user equipment 1700 to a central server and the central server includes artificial intelligence algorithms as described herein. In examples, the central server makes a prediction or recommendation, or suggest or takes some other action. This prediction, recommendation, or action may then be presented to the user at the user interface 1702. The user may confirm that the action is to be taken, for example by interacting at the user interface 1702 and then the action is taken.

In another example of the operation of the system of FIG. 17, sensors gather data from the vehicle and the data is stored at least temporarily at the user equipment 1700, for example, in the memory 1706. The user equipment 1700 may also receive selected data from a central server, such as the most relevant data (e.g., data from a particular time period or data from selected other vehicles). Based upon the data from the vehicle and/or selected data received from the central server, the artificial intelligence algorithm stored in the memory 1706 and executed, instigated, or assisted by the processor 1704 makes a prediction or recommendation, or takes some other action. This action may be presented to the user at the user interface 1702. The user may confirm that the action is to be taken, for example by interacting at the user interface 1702 and then the action is taken.

In still other examples and as described herein, the user equipment 1700 communicates (directly or indirectly) with other vehicles. Data may be received and/or exchanged with these vehicles, in one example. This data may be used by the artificial intelligence algorithms to make more accurate or effective recommendations, predictions, or suggested actions.

In other examples, the user equipment 1700 may gather and store data that is associated with the user or a particular vehicle. The data may be stored in the memory 1706. This data may be selectively shared with others such as with other vehicles or with a central server. For example, the user may receive an incentive from others to share the data and the data may be shared with the other entity.

FIG. 18 is a diagram of communication sequences in accordance with some embodiments.

Referring now to FIG. 18, one example of a system that includes the vehicle-to-vehicle exchange of information is described. In this example, there are three vehicles 1802, 1804, and 1806. Each of the vehicles 1802, 1804, and 1806 may include user equipment (e.g., smartphones, cellular phones and/or vehicle control units to mention a few examples). The vehicles 1802, 1804, and 1806 may also communicate with a central server 1808. It will be appreciated that this is one example showing only three vehicles and that examples with any number of vehicles are possible.

The example of FIG. 18 shows two communication sequences and processing steps that can occur. It will be appreciated that both of these sequences may not occur within the same system.

A first sequence is now described where the central server 1808 is involved in communications. At step 1820, the server 1808 sends information to each of the vehicles 1802, 1804, and 1806. In examples, the vehicles may selectively process the information and the processed information is exchanged between the first vehicle 1802 and the second vehicle 1804 at step 1822. In other examples, the information that is exchanged is data gathered by sensors at a particular vehicle.

Information is exchanged between the first vehicle 1802 and the third vehicle 1806 at step 1824. Information is exchanged between the second vehicle 1804 and the third vehicle 1806 at step 1826. The exchanges 1820, 1822, 1824, and 1826 may allow a particular artificial intelligence algorithm at a specific one of the vehicles 1802, 1804, and 1806 to make more accurate predictions, recommendations, and instigate particular actions. The information exchanged in these exchanges 1820, 1822, 1824, and 1826 may be different. In examples and as mentioned, the information exchanged can include sensor readings of a vehicle, driver identity, predictions or recommendations made by a particular artificial intelligence algorithm, and vehicle location. In examples, individual drivers agree to the exchange of information and the type of information to be exchanged before an exchange occurs.

A second sequence is now described where the central server 1808 is not involved. Information is exchanged between the first vehicle 1802 and the second vehicle 1804 at step 1842. Information is exchanged between the first vehicle 1802 and the third vehicle 1806 at step 1844. Information is exchanged between the second vehicle 1804 and the third vehicle 1806 at step 1846.

Various types of information can be exchanged. In one example, information from a first vehicle may be sent to a second vehicle to encourage the second vehicle to allow the first vehicle to use its information. For example, the first vehicle's artificial intelligence algorithm (e.g., a neural network) may more accurately predict the wear on a component (e.g., a tire) if it has sensed information from the second vehicle. In aspects, the first vehicle may offer to pay the owner or driver of the second vehicle for that type of information. In another example, the first vehicle may offer its own information to the owner or driver of the second vehicle in exchange for the sensor information of the second vehicle.

In another example, multiple vehicles may be grouped together and form a group where information can be exchanged. These communities may resemble social networks with groups of vehicles communicating with each other according to certain privileges. Membership in a group by a vehicle or driver may be based upon common data, interests, or other factors and potentially sharing of information from the community to others including businesses. Once the multiple vehicles are accepted as being part of the group, information can be exchanged freely in one example. Admittance to a group may be made according to various approaches such as acceptance by one member, or a majority vote by all members. Besides sharing information, other actions can be allowed or permitted as between group members.

Security may be provided with any of the above-mentioned communication sequences. For example, security credentials such as passwords, and/or block chain credentials may be exchanged before the communications are allowed to occur.

In many of the approaches described herein, various information is collected and is typically (all not always) owned by the creator of the information. However, this information may be desired to be obtained and used by others. One way of obtaining the information is by bidding for the information.

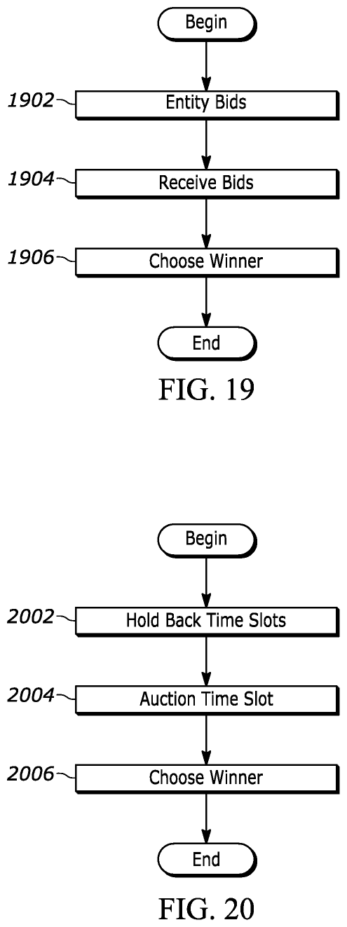

FIG. 19 is a flowchart for bidding in accordance with some embodiments.

Referring now to FIG. 19, an example of an approach for bidding is described. In aspects, the bidding is real-time bidding where advertisements are bought and sold on an instantaneous basis. Advertising buyers bid on an advertising “impression” and if they win the bid, the advertisement is instantly rendered to the customer. At step 1902, an entity bids for access/use of data. In examples, the entity may be a business, shop, or service center. In another example, the entity may be other drivers. The information may be from a vehicle or from user equipment as has been described herein.

At step 1904, the bid is received at a central server. The information may be held at the central server as described herein. One goal of the advertisers or businesses may be to selectively target customers to purchase the goods or services of the advertiser or businesses so that the advertisers or businesses do not need to send out mass blasts, advertisements or mailings.

At step 1906, the advertiser or business is selected by the server. In examples, the advertiser or business that is willing to pay the highest price for the data gets to send an advertisement and target customers. In other examples, other factors besides the highest price bid may be used by the server to determine the winning bidder. For example, the credit standing of the bidder, the volume of previous bids or winning bids, the suitability of the advertisements for a particular customer, and other factors may be considered in a weighted calculation (with each factor receiving a weight and summing to a weighted amount) to determine the winning bidder (with the winning bidder having the greatest weighted amount).

In one example of this approach, a driver indicates or has a need such as servicing their vehicle, indicates that he or she has availability in his schedule on a certain day and time and a recommendation is determined by a central server using artificial intelligence approaches. Information concerning the driver is bid on successfully by a business and is obtained by the business. The business can direct advertisements to the driver. In response to the advertisement, the driver may go to the business, obtain the product, purchase the product, and remove the product from the business. If the product is an automobile component, then the driver (or some other person including the business) may install the product in the vehicle.

FIG. 20 is a flowchart of bidding in accordance with some embodiments.

Referring now to FIG. 20, another example of bidding is described with respect to media advertising. As with the example of FIG. 19, the bidding may be real-time bidding. At step 2002, commercial time slots are held back, not offered for sale ahead of time (when the advertisement would be broadcast). For example, television advertisements for a particular time slot (in a particular program with a scheduled broadcast time) such as at a particular spot during the Super Bowl are held back and not sold to any particular advertiser.

At step 2004 and during the event (e.g., during the Super Bowl), the time slot is auctioned off in real-time. That is, before the time slot is allocated an auction is held. A central server may collect bids from interested advertisers and the central server may store advertisements (e.g., video commercials) that are supplied by the advertisers and so that the advertisement of the winning bidder can be readily played during the time slot. The central server may execute the bids in a competitive fashion with, in some examples, the highest bid prevailing. In other examples, other factors such as the credit standing of the advertiser, the volume of previous advertisements purchased by the advertiser, the suitability of the advertisements for a particular time slot, and other factors may be considered in a weighted calculation to determine the winning bidder. It will be appreciated that the bidding processes described herein may rely upon the electronic transfer of bids via electronic communication networks or combinations of these networks.

At step 2006, the time slots are sold to the highest bidder (or by using this factor or other factors) and their advertisements posted. In the example of the Super Bowl, if the game or the commercials are exciting, the price for the time slot increases. Conversely, if the game (or the surrounding commercials) is boring, the price for the time slot would be expected to go down. In response to the advertisement, the driver may go to the business, obtain the product, purchase the product, and remove the product from the business. If the product is an automobile component, then the driver (or some other person including the business) may install the product in the vehicle. The increasing or decreasing bid amounts are determined by the potential advertisers as they bid.

The owner of the central server (the service) may charge for the service it provides based on a variety of factors. For example, it may charge under a fixed fee arrangement with a particular business, on the number of offers made by a particular business, or on the popularity of an event. Other examples of pricing arrangements are possible.

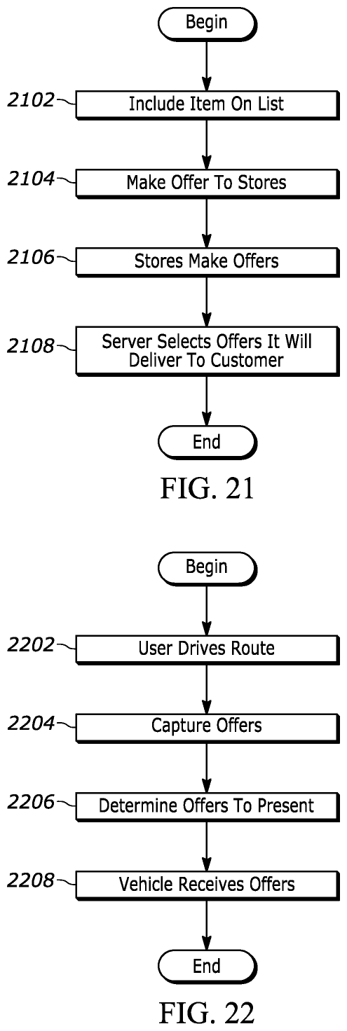

FIG. 21 is a flowchart of real-time bidding in accordance with some embodiments.

Another example of real-time auctioning or bidding service is described in the approach of FIG. 21. At step 2102, a user includes or already has an item (e.g., milk) on his or her shopping list.

At step 2104 and on the way to a store (or in some location such as the parking lot at the store), a first offer is made to the retailers that there is a customer who is intending to buy milk. A central server may have gathered data concerning the customer, the customer's movements and a prediction made that the customer is going to the store to purchase milk. These predictions (in the form of the first offer) may be sent by the central server to stores via one or more electronic communication networks where these stores have indicated interest and who may pay a premium or fee to the owner of the central server and the artificial intelligence algorithms deployed at the central server. The stores may indicate their interest to the central server previously and may include the criteria of the customers they are looking to attract (e.g., customers looking for milk).

At step 2106, and in response to receiving the first offer, stores make second offers to the server for the customer. In other words, the second offer to the service amounts to an opportunity to send advertisements or otherwise make the offer to a customer. The second offer may include the offer to the end user, in the way of an offer price, a discount, or a coupon. The second offer may be in any form including electronic advertisements, electronic text messages, emails, or any other suitable form or format that is sent to customers.

At step 2108, the server determines which of the second offers that it will deliver to the customer and then delivers one (or more) of the second offers it selects to the end customer. The server can decide which second offer (or second offers) to present to the end user based on the better offer for the end user, a pre-existing arrangement with the retailer to promote the retailer above other retailers, or by a real-time bidding process by the retailers to have their second offer delivered to the user. Better offers may be offers with more significant financial rewards as compared to other offers, greater incentives as compared to other offers, or other factors. These factors may be weighted with the more heavily weighted factors having greater importance. As mentioned, the second offer may identify the product or service and include an offer price, a discount, or a coupon to mention a few examples. In response to the second offers, the driver may go to the business, obtain the product, purchase the product, and remove the product from the business. If the product is an automobile component, then the driver (or some other person including the business) may install the product in the vehicle.

The owner of the central server (the service) may charge for the service it provides based on a variety of factors. For example, it may charge under a fixed fee arrangement with a particular business, based upon the number of offers made by a particular business, or on the number of offers accepted by drivers. Other examples of pricing arrangements are possible.

FIG. 22 is a flowchart of real-time bidding in accordance with some embodiments.

Referring now to FIG. 22, another example of real-time bidding based on a user's driving habits is described.

At step 2202, the user drives the same route to work every morning (or during some other predefined time period). The vehicle driven by the driver may include sensors that allow the location, direction, speed, relative position, and acceleration of the vehicle or driver (to mention a few examples) to be determined or measured. The driver may also have access to, carry, or possess user equipment such as infotainment devices or systems, telematics, cellular phones, smart phones, laps tops, tablets that obtain or determine this information. Similarly, the vehicle may include a vehicle control unit that obtains or determines this information. Combinations of these or other devices may also be used to obtain the information. An external service such as a GPS tracking service may also be used.

At step 2204, an artificial intelligence algorithm (e.g., implemented at a server) captures offers while the user drives their route. The system may include a central server, which obtains data from the above-mentioned entities and uses this information to determine information concerning the driver such as the driver's location, direction, speed, relative position, and acceleration or other factors. The server may also utilize information concerning the driver's credit history or purchasing history and this may be obtained from a database that stores the information at a central location.

At step 2206, the artificial intelligence algorithms determine which offers to present to the user. The determination may be based on the better offer for the end user, a pre-existing arrangement with the retailer to promote him above others, by a real-time bid by the retailer to have his or her offer delivered to the user. The offer may include the offer to the end user, in the way of an offer price, a discount, or a coupon to mention a few examples. The better offers may offer the most financial rewards to a customer, the most benefits to customers, or an optimal combination of benefits that are tailored to a particular customer. In determining what is the best offer, the different considerations may be weighted with factors of greater importance having the greater weight in the determination.

At step 2208, the vehicle obtains offers for the consumer from businesses along the route, such as a restaurant or food shop. The offers may be sent directly by the business or by the central server via appropriate electronic communication networks. The offers may appear on user equipment of the driver. The owner of the central server may charge a fee or commission based upon a variety of factors such as a fixed fee arrangement with the business, the number of offers made by the business, the number of offers accepted by drivers, or other factors. The gas, oil, auto service or charging station, restaurant or food shop could make an offer for discount or a free item to the user. In response to the offer, the driver may go to the business, obtain the product, purchase the product, and remove the product from the business. If the product is an automobile component, then the driver (or some other person including the business) may install the product in the vehicle.

The artificial intelligence system may charge for the service it provides based on a variety of factors. For example, it may charge under a fixed fee arrangement with a particular business, on the number of offers made by a particular business, or on the number of offers accepted by drivers. Other examples of pricing arrangements are possible.

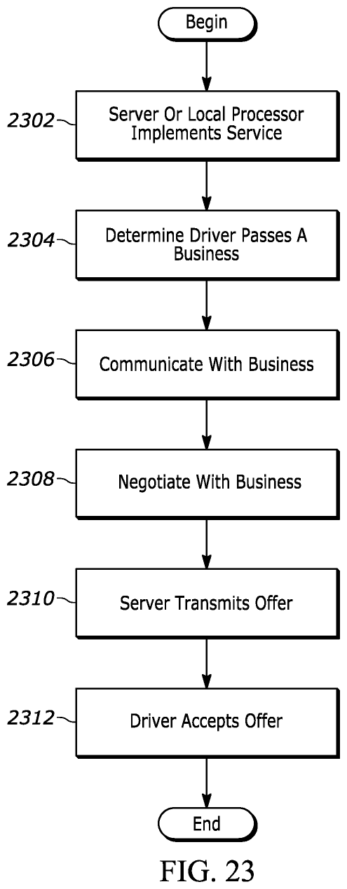

FIG. 23 is a flowchart of real-time bidding in accordance with some embodiments.

Referring now to FIG. 23, another example of real-time bidding is described. At step 2302, a central server or local processor implements a service that determines that servicing of a vehicle is required and/or identifies components of vehicles that should be replaced or upgraded. The determination may be made based upon data gathered from the vehicle, other vehicles, or information concerning a component (component specifications). For example, the vehicle or service determines that vehicle servicing is needed, now or in the near future, such as an oil change, changing tires, or changing brake pads. This may be determined based upon component wear of the component-in-question, the service history for the component, miles driven by the driver with the component, the technical specifications of the component (e.g., expected service life), the experience of other drivers with the same or similar type components, and other factors.

At step 2304, the server determines based on the user's driving habits that he or she passes a service provider, business, or shop on the way to the office every morning. This determination may be obtained by monitoring the speed, direction, or location of the vehicle with sensors at the vehicle, with user equipment traveling with the vehicle, or with an external service such as a GPS satellite-based tracking service. Other examples are possible. The server may predict where the vehicle is located and when it is at or near a business.

At step 2306, the service communicates with the service provider, business, or shop to offer the opportunity to the service provider to provide a product or service to the driver. The communication may be made via one or more electronic communication networks and the communication may include a prediction, suggestion, or determination of the type of service needed or believe to be needed by the driver.

At step 2308, the service and the service provider, business, or shop negotiate and, in some examples, a discount offer from the shop may be obtained. The shop may bid for the service and offer various incentives. In other aspects, the service accesses the user's calendar and the shops calendar and offers a possible time to the driver or schedules a service appointment for the user. The service may also compare offers from multiple services providers, businesses, or shop and select what the service determines to be the best offer. As with the other examples described herein, the better offer may be selected based upon financial or other considerations.

Its step 2310, the server that provides the services transmits the selected offer to the driver. The offer may be made in electronic form such as by email, electronic text, or some electronic advertisement. The driver may receive the electronic offer at user equipment such as a cellular phone, smart phone, personal computer, tablet, or the vehicle control unit of the vehicle to mention a few examples.

At step 2312, the driver accepts the offer from the service provider, business, or shop and the product or service is provided by the service to the user. After accepting the offer, the driver may go to the business, obtain the product, purchase the product, and remove the product from the business. If the product is an automobile component, then the driver (or some other person including the business) may install the product in the vehicle. If the offer is a service, then the service may be provided to the vehicle. For example, the oil may be changed in the vehicle, the tires may be rotated, the tires may be replaced, or the brake pads may be replaced to mention a few examples.

The owner of the central server (the service) may charge for the service it provides based on a variety of factors. For example, it may charge under a fixed fee arrangement with a particular business, on the number of offers made by a particular business, or on the number of offers accepted by drivers. Other examples of pricing arrangements are possible.

It will be appreciated that not all vehicles include an embedded communication system. Alternatively, the original equipment manufacturer (OEM) has decided not to make the data available to the service that is interested in data related to this user or vehicle.

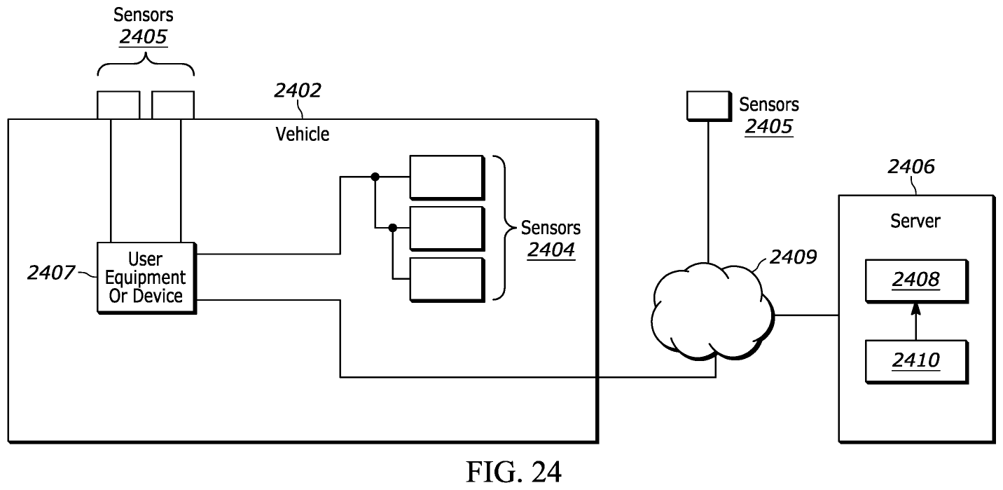

FIG. 24 is a diagram including a vehicle in accordance with some embodiments.

Referring now to FIG. 24, one example of a vehicle 2402 that does not utilize an embedded communication system is described.

The vehicle 2402 may be any type of vehicle such as a car, truck, ship, or aircraft. Other examples are possible.

Sensors 2404 are disposed inside the vehicle 2402. The sensors 2404, in examples, can determine that the vehicle is moving, the location of the vehicle 2402. Sensors 2405 are disposed outside the vehicle 2402 and could be GPS sensors, in an example.

A central server 2406 includes a memory 2408. The memory 2408 stores artificial intelligence algorithms 2410, for example, neural networks, which can be executed or managed by the central server 2406. The user or driver also carries a user device or user equipment 2407 (e.g., a smartphone, cellular phone, or tablet to mention a few examples) within the vehicle 2402. The user device 2407 communicates with the central server 2606 via an electronic communication network 2409 (e.g., the internet, a wireless network, a cellular network, a local area network, or a wide area network or combinations of these or other networks). The sensors 2404 and 2405 are coupled to the user equipment 2407 and the user equipment 2407 gathers data and stores the data at the user equipment. The server 2406 gathers other data from others of the sensors 2405 via the network 2409.

In one example of the operation of the system of FIG. 24, the server 2406 determines that the user has their user equipment or device 2407 in the car. The server 2406 knows or is aware of the location and speed of the vehicle 2402. This information can be used to determine that the user equipment 2407 is likely in a vehicle 2402. For example, the server 2406 may track communications with the user equipment and imply that these communications occur as the vehicle moves. Hence, an implication can be made that the user has their user equipment in the car.

Some of the various services or products that are enabled for users in vehicles could be enabled by the user having their user equipment or device 2407 with them in the vehicle. For example, a tracking and alarm service may be enabled by the user device 2407.

The central server 2406 (implementing a service) could still have access to the data related to the vehicle (e.g., obtained from the sensors 2404 and/or 2405) or user. The central server 2406 would still be able make recommendations, predicts, suggestions, or offer insights to the user.

The owner of the server 2406 may charge a fee for the service it provides based on a variety of factors. For example, it may charge under a fixed fee arrangement with a particular business, on the number of offers made by a particular business, or on the number of offers accepted by drivers. Other examples of pricing arrangements are possible.

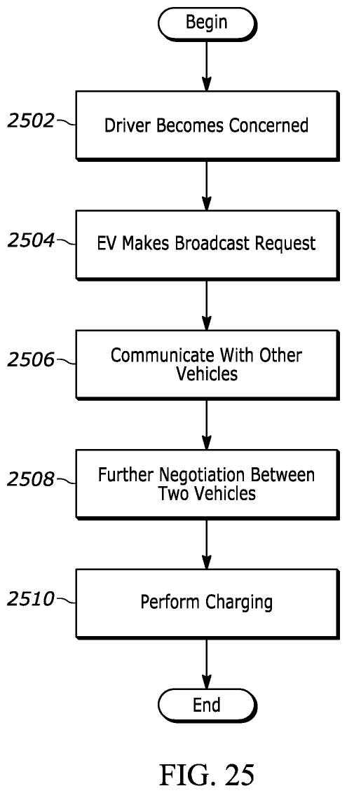

FIG. 25 is a diagram of providing an electric vehicle charging or recharging service in accordance with some embodiments.

Referring now to FIG. 25, an example of providing an electric vehicle (EV) recharging service is described. In this example, EVs (e.g., cars, trucks, or other vehicles) travel (e.g., using roadways). One issue associated with EVs is “range anxiety” meaning concern that the EV will run out of power when away from home or away from a home charging station. One way to alleviate this is to enable charging one EV from another EV that has sufficient charge according to the present approach. It will be appreciated that the approach described with respect to FIG. 25 could be extended to other items, products, services, or materials that one vehicle could provide to another vehicle whether or not the vehicles are electric vehicles.

At step 2502 and while driving on a roadway, the driver of an EV becomes concerned about whether there is sufficient electrical charge in the batteries of the EV to get the EV to the driver's destination. In aspects, this determination is made automatically by the vehicle (e.g., by an artificial intelligence or other algorithm), based upon, in examples, the anticipated destination, anticipated miles yet to drive to the destination, traffic conditions in route to the destination, weather conditions, conditions of vehicle components, and/or the current electrical charge level of the battery. In examples, a neural network that has be appropriately trained is utilized to make these determinations.

At step 2504, the EV then makes a broadcast request for charging. The broadcast request may be, in examples, broadcast from user equipment (e.g., the vehicle control unit, some other vehicle device, a transmitter in the vehicle, a user smartphone, a user cellular phone, or some other user equipment). The broadcast is intended to be received by other vehicles and, in some examples, a central server. Alternatively, other vehicles could offer this service where the other vehicles broadcast advertisement messages (specifying that these other vehicles are available for charging purposes) and the EV responds to their messages.

At step 2506, the vehicle communicates with one or more other vehicles. The other vehicles make offers in terms or price or other conditions. The artificial intelligence or other algorithm of the EV (or at the central server) can compare offers, for example based on price per kilowatt hour, amount of charge available, charge rate available and so forth. The criteria for choosing the best offer can also change over time and the artificial intelligence algorithm can make these changes. For example, an artificial intelligence algorithm at the EV can make these comparisons. In other examples, the artificial intelligence algorithm is disposed at a central server and the EV communicates with the central server. In examples, there is a negotiating phase, with this vehicle offering a lower price per kilowatt hour.

At step 2508 and once a suitable charging vehicle is selected, the two vehicles or drivers could further negotiate where to stop and perform the recharging, such as the next available rest area on a highway. This step could also be included in step 2506. Similarly, for a driver pulling off at a rest area, or pulling into a restaurant parking lot, the communication and negotiation could take place with vehicles already parked. Negotiations may include person-to-person negotiations and/or may include machine learning algorithms (in each vehicle) negotiating by exchanging information.

At step 2510 and once a suitable charging vehicle is selected, the vehicle could park next to the charging vehicle to allow a charging cable to be connected to the charging vehicle.

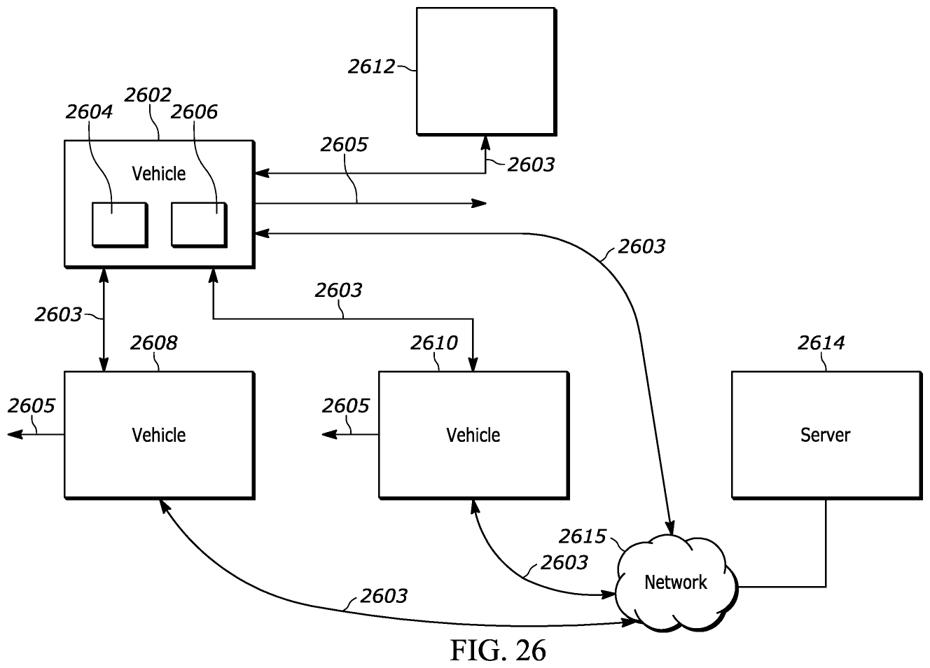

FIG. 26 is a diagram of sharing information in accordance with some embodiments.

Referring now to FIG. 26, one example of sharing information between vehicles and other entities is described. When artificial intelligence or machine learning approaches are used within vehicles, it is expected that the gathered data sets would be different for each vehicle. This data could have been captured individually by this vehicle and may include other data the vehicle has received from other sources.

In this example, a vehicle 2602 gathers and assembles data sets 2604 and 2606. As mentioned, this data could have been captured individually by this vehicle and may include other data the vehicle has received from other sources.

As the vehicle 2602 travels (travel movement is shown with arrows labeled 2605), it could come into communications with other vehicles 2608 and 2610, and other infrastructure elements 2612 (communications are shown with arrows labeled 2603). The vehicle 2602 could then exchange various types of data associated used by artificial intelligence algorithms or machine learning approaches at a central server 2614 (or deployed at the other vehicles). For example, data used for training the machine learning (ML) algorithm at the central server 2614 could be exchanged with the vehicles 2602, 2608, and 2610. The trained models produced or maintained at the central server 2614 could similarly be exchanged between the central server 2614 and the vehicles 2602, 2608, and 2610. Locally trained models created by artificial intelligence algorithms/machine learning algorithms deployed at the vehicles 2602, 2608, and 2610 could be exchanged with the central server 2614 and/or directly with other vehicles. Communications between the central server 2614 and the vehicles 2602, 2608, and 2610 (or between and the vehicles 2602, 2608, and 2610) may be made using an electronic communication network 2615 (or in other cases may be made directly).

In this way, data sets obtained at particular vehicles could be shared and distributed more broadly with different entities over time. The drivers of the vehicles 2602, 2608, and 2610 could pay to receive information and/or could receive incentives to share their information.

Allowing entities to exchange data may be determined by various factors. In one example, payment of a fee (e.g., from the driver of a vehicle and the central server 2614) may permit sharing to occur. In another example, drivers may select certain vehicles for which they allow the sharing of the data, e.g., between friends, family members, or community members. Various security protocols can be utilized to allow or provide sharing. In these regards, security information (e.g., passwords or other security credentials) are directly exchanged between vehicles (e.g., using the vehicle control units in the vehicles) to determine whether one vehicle will share information with another vehicle or with the central server 2614.

In still another example, groups of vehicles can be formed and members of the groups can freely share information with each other or with the central server 2614. In aspects, the central server 2614 can at least in part manage interactions of members of the group and can manage the inclusion in the group of new group members or the expulsion of group members from the group, e.g., when a group member violates policies of the group such as security policies. Machine learning algorithms may be used to select group members and/or used to predict when members should be deleted from the group.

The sharing of data may allow the creation of broader communities of vehicles/drivers and these communities grow and expand over time as the number of vehicles in the communities grows and expands. Such growth happens organically as vehicles travel to new locations interacting with new vehicles from these new locations to have their data made available to all vehicles in the community and/or the central server 2614. Within these communities, sub-communities may also be formed where subsets of data may be shared amongst members of the sub-community. Sharing may also be one-way or two-way. In one-way sharing a first vehicle shares its data with a second vehicle, but the second vehicle does not share its data with the first vehicle. In two-way sharing, both vehicles share their data with the other vehicle.

It will be appreciated that various incentives can be utilized to cause a driver to want to share their information. Such incentives may include monetary incentives, or product or service discounts to mention a few examples.

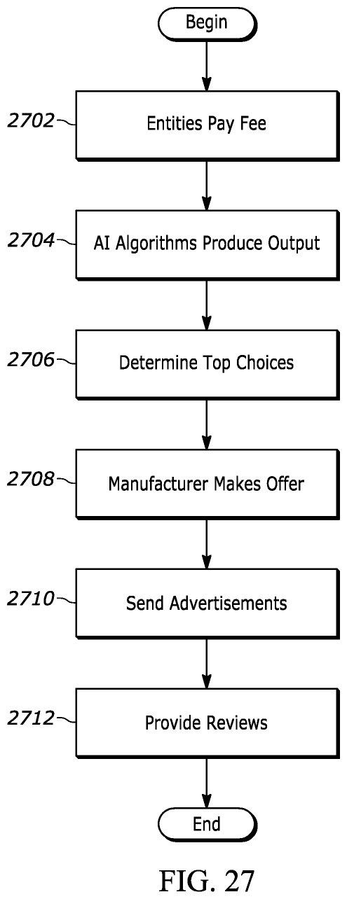

FIG. 27 is a diagram of creating advertising in accordance with some embodiments.

Referring now to FIG. 27, one example of creating advertising is described. Instead of making predictions, advertisements targeting specific customers or groups of customers can be created. It will be appreciated that the approach of FIG. 27 is one example and that other examples are possible.

At step 2702, entities such as tire manufacturers, distributors, retailers (e.g., web and/or brick-and-mortar/physical entities), pay an advertising fee to the operator for providing product and service recommendations. The operator may determine customers or buyers that may wish to purchase products or services from the entities. In other examples, the entities determine the identities of potential customers.

At step 2704, the artificial intelligence/machine learning algorithms of the operator or others produce an output and the output is used to create (or is) an advertisement specific to a specific driver. In one example, the operator of the artificial intelligence/machine learning algorithms generates personalized recommendations in the form of personalized advertisements (e.g., for tires to drivers before the drivers are even considering tire replacements). The output may be produced in response to an advertisement generation request. The advertisement generation request may include the identity of the driver, a photo of the driver, a photo of the car, or other types of information to give a few examples. The advertisement generation request may originate from a manufacturer (who wants to sell products to drivers), a distributor (who wants to sell products or services), or a retailer to mention a few examples. In one example, the advertisement generation request is applied and generates advertisement information. The advertisement information is used to form an advertisement. The advertisement information may include a product type, product specifications, offers, or inducements. As mentioned, the advertisement information may be used to create an advertisement or is the advertisement. The advertisement, in aspects, is in digital form and is to be transmitted to the driver of the vehicle.

It will be appreciated that the advertisements generated are tailored to the driving patterns or habits of a driver. For example, when it is determined that the brake pads are being worn or will be worn in a certain way, brake pad advertisements are rendered to the driver. These advertisements, in aspects, are proactive in that they anticipate the needs of the driver before even the driver realizes they have a need. For instance, the machine learning algorithm may predict that a part may wear out based upon the driving habits of the driver and may consequently produce an advertisement for brake pads before the current brake pads need replacement.

It will also be appreciated that the advertisements may be further tailored to a specific driver. For example, an advertisement may be formed using the favorite color and incorporating music genre of the driver. The advertisement may be rendered to the driver at particular times or days that comport with the schedule or other preferences of the driver. The machine learning algorithm may obtain data from various sources (including voluntary customer surveys) that obtains this information. Sensor data may also be used to derive this information, for example, indicating at what times the driver is in the vehicle, the radio stations tuned to by the driver, and other such information.

At step 2706 and using the output of the artificial intelligence/machine learning algorithms, top choices (e.g., the top 1, 2, 5, 10 or 20 product or service recommendations and optional corresponding ratings) are determined and these top choices may be reduced to a single product recommendation. These recommendations may, in aspects, be based upon the personal driving patterns of the driver. For example, the individualized performance requirements such as acceleration, cornering, braking, wear of individual vehicle components, the average trip time or length, the average speed or distance traveled or other factors relating to an individual and potentially unique pattern of a driver's vehicle use are taken into account to make individualized product or service recommendations by the artificial intelligence/machine learning algorithms.

At step 2708, the manufacturer of that product offers or contracts to pay advertising revenue to the operator of the machine learning algorithms for the recommending the manufacture's product(s). The operator, consequently, generates revenue by advertising their products when recommended to buyers such as drivers and vehicle owners.

At step 2710, the advertisements for products, vehicle entertainment system upgrades, or other products or services are sent to the driver and these are personalized based upon the driving patterns of the driver. These may be transmitted to user equipment of the driver such as the infotainment system or device, telematics, smartphone, cellular phone, laptop, or tablet of the driver or the vehicle control unit of the vehicle being driven by the driver.

At step 2712, the driver after purchasing the product can provide verified purchaser reviews to further improve the training and performance of the system. In aspects, the reviews themselves can be used to further train or improve machine learning algorithms such as neural networks. In one specific example, advertisements may be selected to include highly rated products rather than lower rated products. Resultant advertisements, predictions, or recommendations may include direct quotes from users who supplied the reviews and may include information, e.g., images, provided by these users. In one specific example, an advertisement for a highly rated tire may be created and include quotes from a specific person who reviewed the tire, as well as an image from the person of the actual tire from the person's vehicle that the person reviewed.

In other aspects, the approach of FIG. 27 may recommend products such as tires, brake pads, rotors, gasoline, fluids such as brake fluid, wiper fluid, coolant, gear lubricant, transmission fluid, EV charging, or other products in exchange for advertising revenue for these recommendations. The advertising rate charged by the operator can be based on whether the sale was completed, the frequency of referrals, buyer reviews, a ratio of purchases per recommendations, an effectiveness of recommendation score or any other suitable payment basis or combination. Among other advantages, the product recommendations are much more effective than conventional search engine recommendations because the product recommendations are highly customized based on extensive product testing, consumer and driver driving data and preferences and as described. As such approaches provide an optimal and thus a superior form of advertising and thus higher advertising revenue and monetization than conventional advertising.

It will be further appreciated that various physical actions can be taken by various entities with respect to the advertising. In one example, the driver responds to the advertisement by ordering a part. In one example, a control circuit receives the response and sends a control signal to a manufacturer causing the manufacturer to produce the part. The part is shipped to the driver and the driver installs the part on their vehicle. In still another example, the response from the driver to the advertisement may indicate that the driver desires a particular service that can be accomplished by the control circuit sending a control signal to the driver's vehicle that tunes, configures, or alters the operation of a component of the vehicle. For instance, when the user wishes to subscribe to a satellite radio service, GPS service, or vehicle tracking service the driver may respond to the advertisement indicating their desire, arranges payment, and then the control circuit sends a control signal to activate, configure, or tune the appropriate vehicle components (e.g., the vehicle's entertainment system, GPS devices, or vehicle tracking devices).

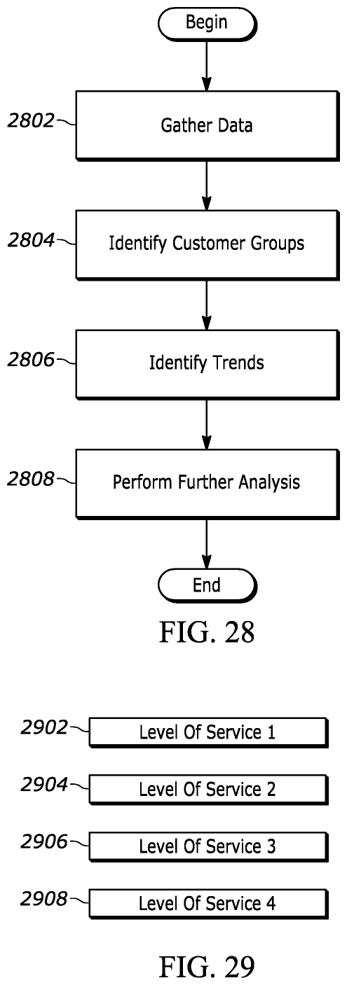

FIG. 28 is a diagram of identifying trends in accordance with some embodiments.

Referring now to FIG. 28, one example of an approach for identifying trends in data collected by vehicles is described. In one example, the approach described with respect to FIG. 28 is performed by an artificial intelligence algorithm (e.g., a neural network) at a central server, the driver may request more information, which is supplied by the control circuit and may use the machine learning algorithm.

At step 2802, data is gathered. The data may be gathered by various sensors at vehicles (e.g., cars or trucks). The data may relate to tire pressures, brake wear, speed, acceleration, or distance travelled to mention a few examples. In aspects, the data may identify a time and/or owner of the data (e.g., a particular vehicle or driver). In other aspects, the owners of the data have agreed to supply their data. For instance, drivers may be offered incentives to allow others to use the data. In other examples, the drivers are directly paid for their data.

At step 2804, groups of customers are identified based on similarities (e.g., vehicle make/model/package, time-of-day driving similarities, locations or types of locations (e.g., school, bank, coffee shop), and driving style (performance/sport/track/aggressive/normal/cautious, hard acceleration/braking/turning, etc.).

At step 2806, trends are identified in the data, for example, by the artificial intelligence algorithms or other algorithms. The trends may involve determining the change in the data and behaviors associated with the data over time. For example, trends in brake wear data may indicate new driving patterns for drivers of a particular subgroup (e.g., younger drivers). Trends might include increased wear with certain tires, increased travel distances made by vehicles, or increased travel during certain times of the day or under certain weather conditions to mention a few examples.

At step 2808 and using the trends associated with those subgroups (as determined by operation of this system or other market demographic information) to target further data interpretation and analysis of the vehicle data, allowing for improved forecasting of consumer interests and targeting of recommendations. For example, the artificial intelligence algorithms (e.g., neural networks) described herein can be further trained or refined with this data so that the output of these algorithms is more accurate. In one specific instance, the neural network may be trained or refined to account for more aggressive driving, which might cause greater wear on the brake pads. In this case, the components, weights, or other structures of the neural network are adjusted so that predictions concerning the lifetime of brake pads are adjusted, e.g., time to replace the pads is lowered, because of the identified trend.

In the training process, it will be appreciated that trends may be applied to different drivers considered by the neural network in different ways and that multiple trends may be applied to drivers. For example, a trend may be identified where urban drivers are driving more aggressively. The neural network may be trained such that the aggressive driving trend is only applied to calculations or determinations involving urban drivers and not rural drivers.

FIG. 29 is a diagram of providing different levels of service in accordance with some embodiments.

Referring now to FIG. 29, one example of providing different levels of service for drivers of vehicles and their vehicles is described. In one example, there are four levels of service 2902, 2904, 2906, and 2908. The levels of service 2902, 2904, 2906, and 2908 are provided to users or drivers of vehicles. The levels of service 2902, 2904, 2906, and 2908, in aspects, may be based on how much of their data is permitted to be accessed by a third party (e.g., the owner of machine learning algorithms). For instance, the driver may negotiate with or be given incentives by the third party for the third party to use their data.

In one example, level of service 2902 may correspond to or being associated with allowing access to all data. Level of service 2904 may correspond to allowing access to 100% of the data. Level of service 2906 may correspond to allowing access to 50% of the data. Level of service 2908 may correspond to allowing access to no data. The data may, in examples, be stored or collected at the driver's vehicle and may be stored in any electronic memory device. The electronic memory device may be at a cellular phone, smart phone, tablet, personal computer, or at the vehicle control unit of the vehicle to mention a few examples.

The levels of service 2902, 2904, 2906, and 2908 may also relate to products or services offered to the driver. For instance, level of service 2902 may include one service offered to drivers while level of service 2904 may include three services.

In other aspects, different charges are made to the customer based upon the level of service. For example, at level of service 2902 the service is free to the customer. But, at level 2908 a price is charged to the driver.

In one example, the levels of service 2902, 2904, 2906, and 2908 may relate to repair services. For example, when level of service 2902 is accepted by the driver it allows various types of repairs made to the vehicle at no charge to the driver in exchange for no fee to the driver. The other levels of service 2904, 2906, and 2908 may allow various different repairs to be performed and charged at varying rates. Other examples are possible.

It will be appreciated that the levels of services may be used as incentives to encourage the sharing of data. For example, a high level of service may be offered to drivers that share most or all of their data with other vehicles and/or with a central server offering services as have been described herein.

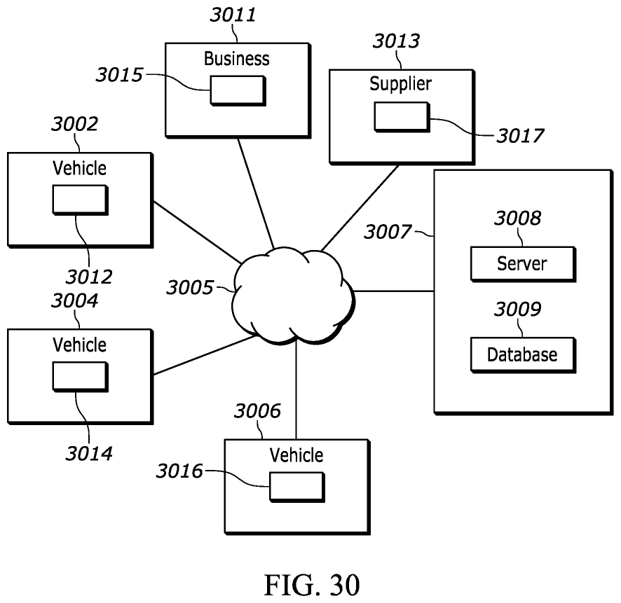

Referring now to FIG. 30, one example of a data pooling arrangement (e.g., collecting data from vehicles at a central data hub such as a central server) is described. Vehicles 3002, 3004, and 3006 travel in a wide variety of ways, across different areas, and include drivers that also have, carry, and/or are associated with user equipment 3012, 3014, and 3016.

A central data hub 3007 includes a central server 3008 (e.g., including electronic processing devices) and a database 3009. The vehicles 3002, 3004, and 3006 and user equipment 3012, 3014, and 3016 communicate with the hub 3007 using a network 3005. Artificial intelligence algorithms may be implemented by the central server 3008 and/or the database 3009. Businesses and/or suppliers 3011 and 3013 also connect to the central data hub via the network 3005. The businesses and/or suppliers 3011 and 3013 may communicate to the central data hub 3007 with user equipment 3015 and 3017.

The central server 3008 is any type of electronic processing device. The database 3009 is any type of electronic data storage device. The vehicles 3002, 3004, and 3006 may be any type of vehicles such as cars, trucks, ships, or aircraft to mention a few examples. The user equipment 3012, 3014, 3016, 3015, and 3017 may be smartphones, cellular phones, laptops, personal computers, or vehicle control units to mention a few examples.

In examples, the hub 3007 gathers the data and sells or offers it to another source. The hub 3007 may offer incentives for the drivers of the vehicles 3002, 3004, and 3006 to let the hub 3007 obtain and/or use the data. The businesses 3011 and 3013 can bid for the data with the best offer winning or securing the data. The businesses 3011 and 3013 can also pay the owner of the central server 3008 (or whoever obtains or processes the data) to process the data and obtain the results of the processing. In this way, data from various sources can be pooled at a central server and utilized by others.

As mentioned, incentives may be offered by the owner of the hub 3007 (or others) to cause drivers of the vehicles 3202, 3404, and 3406 to allow their data to be obtained and/or used. Direct monetary compensation or offers of free or discounted products or services are two examples of incentives. Other examples are possible.

The data can be used in other ways. The hub 3007 may also include machine learning algorithms such as neural networks. In aspects, the data can be used to create and tarin these neural networks, which may be stored in any appropriate electronic memory device. The businesses 3011 and 3013 may subscribe with the hub 3007 for different levels of services. For example, one level of service may be merely providing the data to the business 3011 and 3013. Another level of service may be to collect the data and train a neural network to provide advertisements for the business 3011 or 3013.

In other aspects, businesses 3011 and 3013 may subscribe with the hub 3007 for certain types of data. For example, businesses 3011 and 3013 may only be interested in certain data or may pay to receive certain types of data with the amount and types of data provided by the hub depending upon the level of payment (e.g., a lower payment may include drivers aged 18-24, but a higher payment may include data from drivers of all ages).

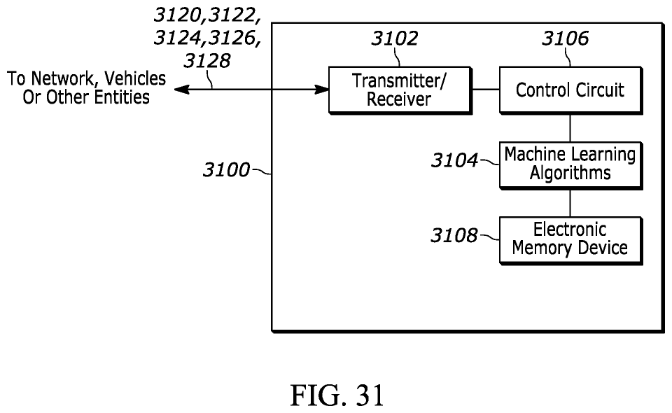

Referring now to FIG. 31, one example of a server 3100 is described. The server 3100 includes a transmitter and receiver (TX/RX) device 3102, machine learning algorithms 3104 (e.g., a neural network that has been trained with training data sets), a control circuit 3106, and an electronic memory device 3108 (e.g., potentially storing the machine learning algorithms or other data).

The transmitter and receiver device 3102 includes hardware and/or software to receive information from other entities and transmit information from other entities. The machine learning algorithms 3104 are any artificial intelligence approach such as neural networks as have been described herein. If neural networks are used, these neural networks can be trained with training data sets as described elsewhere herein. The training sets may be created from data received from multiple vehicles where the drivers of the vehicles have been given incentives to allow their data to be used in the training sets. The electronic memory device 3108 is any type of electronic memory device and, in one example, stores the machine learning algorithms 3104.

The control circuit 3106 is any type of electronic processing device as described herein. The control circuit 3106 is coupled to the transmitter and receiver device 3102, the machine leaning algorithms 3106 and the electronic memory device 3108.

In one example, the machine learning algorithms include one or more neural networks. These neural networks have been previously trained with sets of training data. The control circuit 3106 is configured to receive via the transmitter and receiver device 3102 one or more operational inputs from sensors of a vehicle, from a driver of the vehicle, or from an external source. Once received, the control circuit 3106 is configured to apply the one or more operational inputs to the trained neural network. Applying the operational inputs to the neural network yields an insight, recommendation, or prediction from the trained neural network concerning one or more of: (1) the components of the vehicle, (2) the upgrades to the components, (3) and the maintenance events related to the components.

As mentioned, the one or more operational inputs are applied to the neural network and the insight, recommendation, or prediction obtained, and the insight, recommendation, or prediction obtained includes or identifies an action. The control circuit 3106 and/or other electronic or non-electronic (e.g., human) components can implement the action.

In one example, the action is determining an upgrade of a first selected one of the components of the vehicle and sending first signals 3120 to the driver describing the recommended upgrade, wherein the upgraded first selected one of the components is installed in the vehicle. For example, an upgrade to the tires can be identified and the new tires installed on the vehicle.

In another example, the action is sending a control signal 3122 to a second selected vehicle component to control or change an operating parameter of the second vehicle component. For example, the speed of the engine can be adjusted, the lighting levels in the vehicle cabin can be adjusted, or the volume of an entertainment system in the vehicle can be adjusted.

In still another example, the action is recommending a product or service to the driver based upon the insight or prediction and sending second signals 3124 to the driver describing the recommended product or service. For example, an oil change service may be recommended and the driver, if they accept the offer, can drive their vehicle to the service center to have the oil changed.

In yet another example, the action is recommending maintenance of the vehicle to the driver based upon the insight or prediction and sending third signals 3126 to the driver describing the maintenance and the vehicle is serviced and at least one of the components changed according to the maintenance event. For example, a tire rotation maintenance event may be identified and the driver, if they accept an offer, may drive their vehicle to a service center to have their tires rotated.

In other examples, the action is forming a customer order 3128 for a part to be placed in the vehicle, the order transmitted to a manufacturer causing the part to be manufactured by a manufacturer. In one example, the order (of any suitable format) is transmitted to the manufacturer. The manufacturer receives the order, and the order causes manufacturing machinery at the manufacturer (or others) create the ordered component and/or ship the ordered component. The ordered component may be shipped to a service center or directly to the customer and the component may be installed in the vehicle.

It will be appreciated that the signals 3120, 3124, and 3126, control signal 3122, and customer order 3128 may be of any appropriate communication format or protocol. Moreover, the signals 3120, 3124, and 3126, control signal 3122, and customer order 3128 may be received at another entity and cause the entity to take a physical action such as replace a vehicle component, create or manufacture a component of a vehicle, transfer information or data, communicate with some other vehicle or other entity, or control the operation of a vehicle component to mention a few examples.

It will be appreciated that the installation, changing, or upgrading of a vehicle with new components alters, changes, or transforms the physical state of a vehicle. For example, a vehicle may be considered to be in a first state or of a first structure when the vehicle has worn tires since the performance of the vehicle will reflect the fact the vehicle has worn tires. However, the state and structure of the vehicle is transformed when new tires are added to the vehicle since the performance of the vehicle will change. Hence, replacing older and worn tires with new tires transforms the state of the vehicle from a first state to a second state, and from a first structure to a second structure.

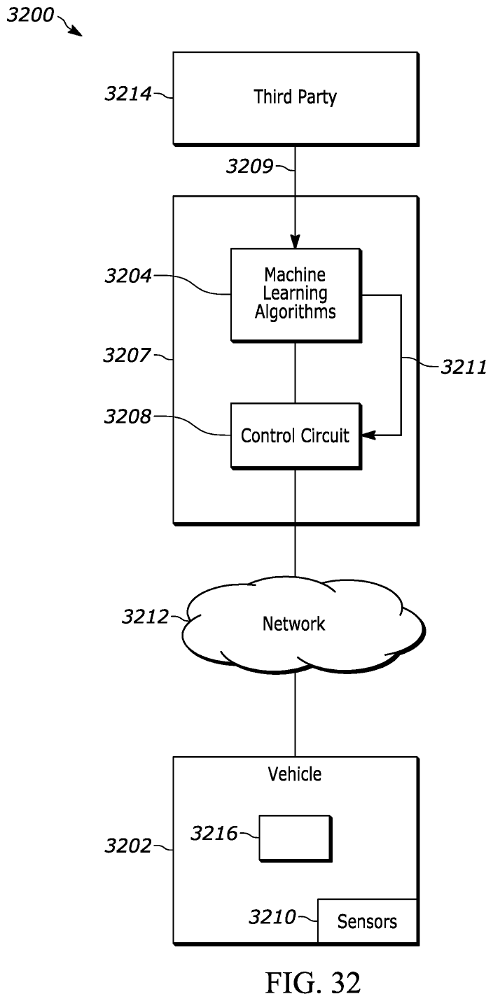

Referring now to FIG. 32, another example of system that creates targeted advertising using the present approaches is described. It will be appreciated that the approach of FIG. 32 is one example and that other examples of systems that generate advertisements are possible.

As previously mentioned, the output of machine learning algorithms (e.g., a neural network) can be used to create advertisements that are personalized for a specific driver. Advertising can be created by a control circuit and pushed to the drivers to inform the driver of recommendations or suggestions involving products or services.

In one example, an “operator” of a vehicle products and services system generates personalized recommendations in the form of personalized advertisements for tires to drivers before the drivers are even considering tire replacements. Tire manufacturers, distributors, retailers (web and brick and mortar/physical), could pay an advertising fee to the operator for providing product and service recommendations. In aspects and based on the output of the machine learning algorithms, the top choices (e.g., the top 1, 2, 5, 10 or 20 product recommendations) may be reduced to a single product recommendation, which could be rendered to a driver in the form of an advertisement. The manufacturer of that product could offer or contract to pay advertising revenue to the operator of the machine learning algorithms for the recommending the manufacture's product(s). The operator thus generates revenue by advertising the manufacturers' products when recommended to buyers such as drivers and vehicle owners.

In other examples, advertisements for vehicle entertainment system upgrades can be sent to the driver and these are personalized based upon the driving patterns of the driver. Advertisements may recommend other products such as brake pads, rotors, gasoline, fluids such as brake fluid, wiper fluid, coolant, gear lubricant, transmission fluid or other products in exchange for advertising revenue for these recommendations. The advertising rate can be based on whether the sale was completed, the frequency of referrals, buyer reviews, a ratio of purchases per recommendations, an effectiveness of recommendation score or any other suitable payment basis or combination. Among other advantages, the product recommendations presented in these advertisements are much more effective than conventional search engine recommendations because the product recommendations are highly customized based on extensive product testing, consumer and driver driving data, and preferences and as has been described elsewhere herein.

It will be appreciated that the advertisements generated are tailored to the driving patterns or habits of a driver. For example, when it is determined that the brake pads of a driver's vehicle are being worn or will be worn in a certain way, brake pad advertisements are rendered to the driver. These advertisements, in aspects, are proactive in that they anticipate the needs of the driver before even the driver realizes they have a need. For instance, the machine learning algorithm may predict that a part may wear out based upon the driving habits of the driver and may consequently produce an advertisement for brake pads before the current brake pads need replacement. The machine learning algorithm can also consider the wear-patterns, part life, and/or other characteristics of certain brake pads and compare this information to the driving patterns of an individual driver to make a recommendation for a particular brake pad that conforms to the driving pattern of an individual driver before the individual driver even knows the brake pad is in need of replacement and, indeed, before the brake pad itself becomes worn enough to need replacement.

It will also be appreciated that the appearance and presentation of advertisements may be further tailored to the specific aesthetic preferences of a specific driver. For example, an advertisement may be formed using the favorite color and when including, for example, background music, incorporating music genre of the driver. The advertisement may also be rendered to the driver at particular times or days that comport with the schedule, patterns, or other preferences of the driver. The machine learning algorithm may obtain data from various sources (including voluntary customer surveys) that obtains this information. Sensor data may also be used to derive this information, for example, indicating at what times the driver is in the vehicle, the radio stations tuned to by the driver, and other such information.

Turning now to the details of FIG. 32, a system 3200 includes a vehicle 3202 (e.g., a vehicle, ship, or aircraft to mention a few examples) with a driver or other human occupant. Machine learning algorithms 3204, for example, a neural network, are disposed at a central location 3207 (e.g., a home office or headquarters). A control circuit 3208 as described elsewhere herein is also disposed at the central location 3207.

The vehicle 3202 is driven by a driver and includes a plurality of sensors 3210. The sensors 3210 are configured to obtain data and the data describes conditions of components of the vehicle and defines an individual driving pattern of the driver. A network 3212 communicates with the vehicle 3202, the control circuit 3208, and the machine learning algorithms 3204. The network 3212 is any type of electronic communication network such as a wireless network, cellular network, the internet, a local area network, a wide area network, or a combination of these or other networks.

The data from the sensors 3210 may include one or more of weather data, road conditions, personal driving style data, vehicle chassis conditions, wear indicators for several parts. Other examples of data types are possible.

The sensors 3210 include one or more of radar, LIDAR sensors, cameras, ultrasonic sensors, GNSS sensors, accelerometers, ABS/ESC sensors, and vehicle environmental sensors. Other examples of sensors are possible.

As mentioned, the machine learning algorithms 3204 may be or include a neural network. The neural network is trained to produce advertisements or information used in advertisements. The training is made according to the data collected by the sensors 3210. However, other information from other vehicles, product specifications, historic data, and other information can also be used in training. The training is effective to structure the neural network such that the advertisements (or advertising information) being produced by the neural network are personalized to the individual driving pattern of the driver as defined by the data (that was used to train these algorithms). In other words, the data used in the training may be applied to the neural network so that the neural network learns how to create the personalized advertisements (or advertising information). As such, the structure of the neural network is changed during the training process.

After training, the trained neural network is subsequently deployed to a production or execution environment where advertisement generation requests 3209 are received and processed. The processing occurs as the advertisement generation requests 3209 (or other inputs) are applied to the trained neural network (e.g., by the control circuit 3208 or directly applied to the neural network) to produce an output 3211 (e.g., an advertisement or advertising information). The advertisement generation requests 3209 may be received from third party entities 3214. The entities 3214 may include manufacturers, distributors, retailers, other vehicles, and/or other businesses, to mention a few examples. The entities 3214 include electronic communication equipment (e.g., laptops, smartphones, personal computers) to create the requests 3209 and communicate with the network 3212 and then the central location including the control circuit 3208. The advertisement generation requests 3209 are in any appropriate electronic format and may include parameters indicating the type of target customer, identities of particular customers, or customer characteristics (e.g., age, income, or location) to mention some examples. The requests 3209 may also be automatically generated (e.g., every day or every week). The requests 3209 may also be custom generated based upon the occurrence of a specific event, or may be randomly generated.

The owner or operator of the machine learning algorithms 3204 (e.g., a neural network) may negotiate with the entities 3214. The entities 3214 may supply identities of drivers or other potential buyers or the owner or operator of the machine learning algorithms (e.g., a neural network) may determine or obtain these identities.

As with any of the other examples described herein, the identity of the driver (included, for example, in the requests 3209) may be determined in a number of different ways. For example, the driver may voluntarily agree or desire to receive information from a business or other advertiser. The driver may have supplied this information when making previous purchases (e.g., supplying their phone information or vehicle contact information) enabling the control circuit 3208 to communicate with the vehicle 3202. In other examples, the control circuit 3208 may obtain publicly available information such as phone numbers or addresses to determine an identity of the driver.

To take one specific example, publicly available vehicle registration information may be obtained and this includes the name and address of a driver. The control circuit 3208 may use this information or correlate this information with other information (information showing the mobile telephone number of a driver obtained from previous purchases or from other sources) to determine that the driver may be contacted at a particular phone number. For example, information may have from public sources identify John Smith as a particular advertising target. A retail store may have a purchase record showing John Smith purchased a brake pad and the purchase information may include John Smith's phone number. John Smith has agreed that he can be contacted using this number. Consequently, this phone number can be correlated with John Smith and used to send advertisements to John Smith.

In an example, where the machine learning algorithms 3204 are a trained neural network, the control circuit 3208 is configured to subsequently receive the advertisement generation request 3209 for the driver and apply the advertisement generation request 3209 to the trained neural network 3204. The application yields advertisement information 3211 associated with the driver and the advertisement information 3211 considers, incorporates, and/or is tailored to the driving patterns of the individual driver. The advertisement information 3211 may be a complete advertisement or information from which a complete advertisement can be generated. Once trained, the neural network 3204 can be further refined and retrained as new data arrives. The fine-tuning, in examples, can occur periodically or, in other examples, every time new data arrives.

When the output 3211 is advertisement information (i.e., not a complete advertisement), then an advertisement needs to be created. In aspects and in this case, the control circuit 3208 forms and sends an advertisement incorporating or conforming to the advertising information to the driver to display on a user interface 3216. The user interface 3216 may be a user electronic device such as a smartphone or personal computer, or a vehicle control unit screen to mention a few examples. The advertisement may be sent using the network 3212 or an alternative network (or combination of networks).

The control circuit 3208 subsequently receives an electronic response (to the advertisement) from the driver via the network 3212 or some alternative network. The driver may enter information in the interface 3216 in one example in response to receiving the advertisement. In aspects, the response directs, causes, or arranges the control circuit to take an action.

Various actions can be taken by the control circuit. In one example, the action is for the control circuit 3208 (after receiving a response from the driver) to determine or obtain additional information needed by the driver, send the additional information to the driver, and display the additional information to the driver via the user interface 3216. For instance, in response the driver may have a question about a product in the advertisement that may be answered by (or the answer obtained by) the control circuit 3208.

In another example, the control circuit 3208 sends a control signal to a selected vehicle component of the vehicle 3202 via the network 3212 to control or change an operating parameter of the vehicle component. The control signal may flip switches of the component or set parameters of electronic devices that comprise the components (e.g., set resistor values) in some examples.

In one specific example, a vehicle tracking service may be selected for purchase by the driver as a result of viewing an advertisement. The driver may order the service (including payment information), for example, using their smartphone or, in another example, using a display or touch screen associated with a vehicle control unit of the vehicle 3202. The order is received by the control circuit 3208, which after verifying the payment information, activates the service at the vehicle 3202. In aspects, the control circuit 3208 sends control signals that are subsequently received at the vehicle 3202.

Various components at the vehicle 3202 may be activated by the control signals. For instance, a preposition or predisposed tracking device may be activated. In another example, the tracking device is installed by a technician and then subsequently activated by the control circuit 3208. The tracking device may be, in examples, a transmitter that transmits the location of the vehicle 3202.

In another example, enhancements to a vehicle entertainment system such as a service that presents satellite radio to a driver (or particular channels or stations of satellite radio) and this service may be selected, purchased, an/or ordered by the driver as a result of viewing an advertisement. The driver may order the service (including payment information), for example, using their smartphone or, in another example, using a display or touch screen associated with a vehicle control unit. The order is received by the control circuit 3208. After verifying the payment information included in the order, the control circuit 3208 activates the service (e.g., a particular channel) at the vehicle 3202. In aspects, the control circuit 3208 sends control signals that are received at the vehicle 3202. These control signals activate, tune, or adjust components in the vehicle 3202. Components at the vehicle 3202 may be activated, tuned, or adjusted, for instance, to allow reception of certain frequencies or of particular radio stations. In another example, components (such as an antenna) are first installed by a technician and then activated by the control circuit 3208. Activation, in examples, may include the flipping and setting of switches to mention some examples.

In still other examples, the control circuit 3208, in combination with the machine learning algorithms 3204 may recommend additional products or services to the driver based upon the response and display the additional products or services to the driver via the user interface. For example, the driver may select a product and based upon this selection other products associated with the selected product may be suggested.

In yet other aspects, the control circuit 3208 may form a customer order for a part to be placed in the vehicle 3202, and the order is then transmitted to a manufacturer causing the part to be manufactured by a manufacturer. The order may instigate a control signal at the manufacturer that instigates the production machinery, e.g., activates machines, to manufacture the product.

In aspects, the advertisements created are tailored to the driving patterns and/or habits of the driver. In examples, the driving pattern comprises one or more of an average trip time or length of the driver, or an average speed or distance traveled by the driver. In some examples, each advertisement will be (or will potentially be) unique in that no two drivers will receive exactly the same advertisement. Advantageously, tailoring the advertisements to specific drivers yields higher positive responses (e.g., increased sales of products or services in the advertisements) since these advertisements are not mass transmissions but purposefully designed to appeal to individual drivers.

In other aspects, the driver after purchasing the product provides verified purchaser reviews. In still other aspects, the manufacturer of a product offers or contracts to pay advertising revenue to the operator of the neural network.

In other examples and when recommendations are being made, the control circuit 3208 uses the advertising information to generate top choices of product or a service recommendation. For example, a recommendation for vehicle tires may be requested by a tire store for a specific driver in the advertisement generation request 3209. The request 3209 is applied to a neural network 3204, which generates the advertising information 3211. The advertising information includes not a single tire choice, but multiple tire possibilities for the driver to select. In examples, the top choices are reduced to a single product recommendation by the control circuit 3208. For instance, the control circuit 3208 may deploy an algorithm that ranks the choices based upon predetermined criteria (e.g., cost, customer reviews, or other factors). In other examples, the neural network determines the top choices. In other aspects, all the top choices may be rendered to the driver. In still other examples, only the top choice among all the choices is rendered to the driver.

The examples herein assume that the advertisements are directed to a driver. Although the driver may be in their vehicle when receiving the advertisements, it will be understood that the driver need not be in their vehicle when this event or when other events described herein occur. For example, the advertisements may be directed to a smartphone or personal computer of the driver when the driver is not in the vehicle. In these regards, the network 3212 may be a cellular network, wireless network, or the internet (to mention a few examples) allowing the control circuit 3208 to communicate with these devices wherever the driver is located. Of course, the network 3212 may also allow the control circuit 3208 to communicate with the vehicle and components or systems within the vehicle. It will also be understood that although the approaches described herein refer to a “driver,” any person associated with a vehicle, e.g., passenger, owner, and so forth, can also be included by or utilize these approaches. For example, advertisements can also be directed to owners of vehicles that do not necessarily drive the vehicles.

The present approaches also provide for the tracking of reactions or feedback to the advertisements created. For example, the control circuit 3208 may track the driver's reaction to the advertisements, including how long the driver has the advertisement open, whether the driver engages any interface features in reaction to the advertisement (e.g., presses keys, issues a voice command, or asks a question using a voice activated service). In these regards, sensors at the vehicle or at a user device utilized by the driver may obtain the reactions of the driver or others. Such feedback data may be collected by the control circuit 3208 and analyzed. This information can also, in aspects, be used to further train or refine any of the machine learning algorithms 3204 (e.g., neural network). In still other examples, reactions from other drivers of other vehicles can be selectively used to train the machine learning algorithms 3204 (e.g., neural network) so that all drivers can benefit from the reactions of all other drivers. The owner of the machine learning algorithms 3204 (e.g., neural network) may charge or bill third party entity 3214 (selling products or services) for these enhancements or may charge the third-party entity 3214 for the information, which may be sent to the third-party entity 3214.

In other aspects, feedback provided by the driver to the control circuit 3208 may include questions, concerns, or inquiries. These questions may be directly answered by the control circuit 3208, forwarded by the control circuit 3208 for another party entity (e.g., the third-party entity 3214), or may be used to further refine the neural networks or machine learning algorithms. For example, the driver may express concern over the safety records of particular tires or brakes, and future advertisements may include sections that address these concerns, for example, showing safety testing or performance results. In another example, the driver may have a specific question that can be answered by the third-party entity 3214.

These approaches also provide the ability for a driver to select advertisements of interest or areas of interest based upon various factors and considerations. Drivers may enter specific preferences via a user electronic device that are received at the control circuit 3208. For example, some drivers may only wish to receive certain advertisements when they are at home, on certain days, under certain weather conditions, or when they are driving along certain routes. Sensors at a vehicle or at other locations may provide information as the driver operates the vehicle. Based upon this information, the control circuit 3208 selectively transmits the advertisements according to the preferences of the driver. In another example, the driver may have an interest in tires, and may wish to receive all advertisements for tires. Receipt of advertisements may be also directly linked to sensed vehicle parameters. For example, certain advertisements may be sent to drivers based on the mileage of the vehicle (e.g., when the vehicle reaches a certain mileage).

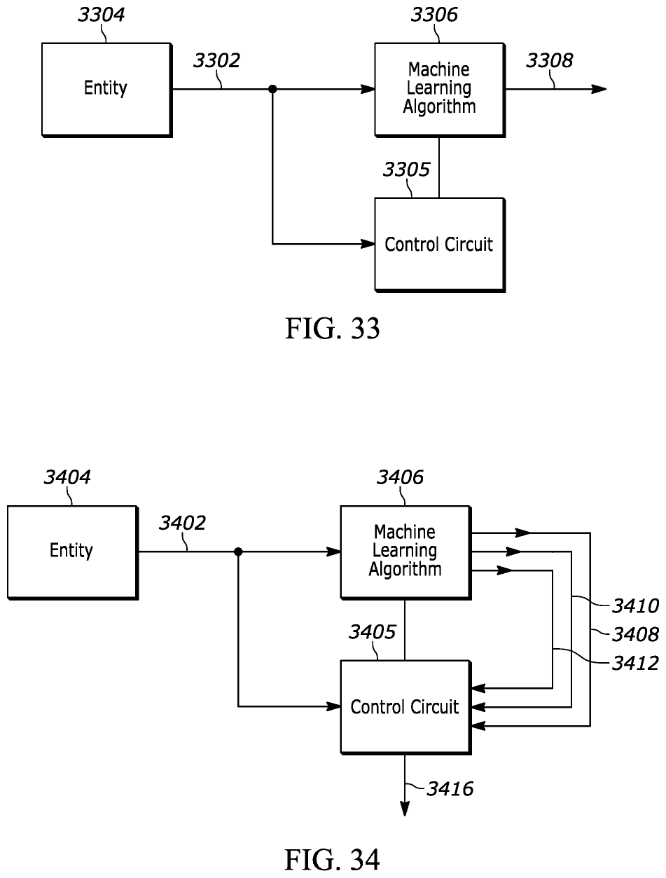

Referring now to FIG. 33, one example of formation of an advertisement is described. A request 3302 from an entity 3304 (e.g., a business) is applied to a machine learning algorithm 3306 (e.g., a trained neural network) directly or by a control circuit 3205. The request 3302 identifies a driver (or a list of multiple drivers) or specifies classes or characteristics of drivers to which a business wants to advertise. In examples, the request 3302 is in any file or message format. The trained neural network receives the request and translates the request into a format where it can be processed by the trained neural network. An advertisement 3308 is produced and this is sent to the driver (or drivers) specified in the request 3302, or drivers fitting the characteristics desired by the business. In other examples, the request is generated by the owner of the machine learning algorithm 3306, which has identified individuals, owners, passengers, or drivers to which the entity 3304 may wish to advertise.

In examples, the request may also be (or include) a photo of the driver (or of a class of drivers), photos of locations where the drivers may be located (e.g., photos of the driver's home or place of employment). In these cases, the trained neural network 3306 may process the photos to determine the identity of the driver or their likely identity.

In other examples, a business may wish to send advertisements to multiple individuals or drivers. For instance, it may wish to send advertisements to individuals in cities with warm climates driving a particular vehicle make and model and of a certain age. Photos of tropical cities with particular car makes and models with older humans may be applied to the neural network 3306, which generates appropriate advertisements. Drivers matching these characteristics can be identified by the control circuit 3305 and/or the trained neural network 3306. For instance, publicly available vehicle registration information for drivers of certain ages, with specific addresses of tropical cities, and with the drivers being of certain ages can be identified and/or correlated.

In other aspects, once each of the drivers in the group of identified drivers is identified, the individual driving habits (e.g., brake pad usage or driving distance) and/or other preferences (e.g., favorite color) are utilized by the control circuit 3305 and/or the trained neural network 3306 to create a custom advertisement for each of the drivers in the group of drivers. It will be appreciated that the use of a control circuit and/or trained neural network allows the quick and efficient processing of vast amounts of data. In other aspects, the control circuit 3305 may comprise parallel processors that implement a virtual machine thereby increasing processing power and allowing the fast and efficient processing of data and creation of customized advertisements for large amounts of individual drivers.

The control circuit 3305 may track the driver's reaction to the advertisement 3308, including how long the driver has the advertisement 3308 open, whether the driver engages any interface features (e.g., presses keys or asks a question using a voice activated service). Such data may be collected by the control circuit and analyzed. This information can also, in aspects, be used to further train or refine any of the neural networks. In still other examples, reactions from other drivers of other vehicles can be selectively used to train the respective neural networks so that all drivers can benefit from the reactions of all other drivers. The owner of the machine learning algorithms 3306 may charge or bill third parties (selling products or services) for these enhancements or may charge the third parties for the information, which may be sent to the third parties.

In other aspects, feedback provided by the driver may include questions, concerns, or inquiries. These questions may be directly answered by the control circuit 3305 or may be used to further refine the neural networks. For example, the driver may express concern over the safety records of particular tires, and future advertisements may include sections that address these concerns, for example, showing safety testing results.

In other examples and as mentioned, the advertisement includes different portions with information of different types. For example, the advertisement 3308 may include video, textual, and sound (e.g., music portions). These portions may be change over time and all portions may not change at the same time. For example, the textual portion of the advertisement 3308 may remain constant over time even as the background color or background music presented in the advertisement is changed by the neural networks, which are constantly being refined.

These approaches also provide the ability for a driver to select advertisements of interest based upon various factors and considerations. Drivers may enter preferences via a user electronic device that are received at the control circuit 3305. For example, some drivers may only wish to receive certain advertisements when they are at home, on certain days, under certain weather conditions, or when they are driving along certain routes. Sensors at a vehicle or at other locations may provide information as the driver operates the vehicle. Based upon this information, the control circuit 3305 selectively transmits the advertisements according to the preferences of the driver. As mentioned, advertisements can be triggered upon the occurrence of certain conditions at a vehicle (e.g., reaching a certain mileage on the odometer or reaching a certain tire pressure at a tire on the vehicle).

Referring now to FIG. 34, another example of formation of an advertisement is described. A request 3402 is received from an entity 3404 (e.g., a business) and is applied to a machine learning algorithm 3406 (e.g., a trained neural network) directly or by a control circuit 3405. The request 3402 specifies an individual driver (or a list of drivers), or classes or characteristics of drivers to which a business wants to advertise. The request can be of any format (e.g., file, text photo) as described elsewhere herein. In other aspects, the request 3402 is formed by the owner of the machine learning algorithm 3406. In this case, the request 3402 identifies drivers, passengers, or other individuals of interest.

Advertisement information 3408, 3410, and 3412 is produced by the application of the request 3402 to the trained neural network 3406. Each of the advertisement information 3408, 3410, and 3412 may be in any appropriate format such as textual day, image file or image type data, or video data to mention a few examples. The control circuit 3405 receives the advertisement information 3408, 3410, and 3412, performs any translations of the advertisement information 3408, 3410, and 3412, and assembles the information 3408, 3410, and 3410 into an advertisement 3416, which is sent to a driver. It will be appreciated the advertisement information 3408, 3410, and 3412 is specific to an individual driver and/or the driving habits of an individual driver. It will be appreciated that the advertisement 3416 may be of any electronic form an include text, video, music/sound, or other types of varieties of information that can be presented to drivers.

In examples, the advertisement information 3408 may specify, indicate, or describe a product (derived by the trained neural network 3406 based upon the driving habits of a driver), the advertisement information 3410 may specify colors preferred by the driver (e.g., the neural network 3406 may have learned from previous product purchases that the driver purchases a large amount of blue items indicating that the driver's favorite color is blue), and the advertisement information 3412 may specify preferred times during which a driver prefers or can be reached (e.g., the trained neural network 3406 may have learned that the driver communicates on the smartphone during certain times of the day or commutes in their vehicle during certain times of the day).

The control circuit 3405 forms the advertisement 3416 with the product using the colors for background preferred by the driver and sends this according to the time. In this way, an advertisement of a product predicted to be needed in the future by the driver according to individual driving patterns of the driver is presented to the driver at times desired by the driver or known in a format designed to get the most optimal or advantageous response from the driver.

Various training approaches can be used to obtain the trained neural network 3406. In addition, once trained, the trained neural network 3406 can be further refined when further operational data is received. As mentioned elsewhere herein, the training process physically alters a neural network to produce the trained neural network. As also mentioned, the training can be performed as supervised learning or as unsupervised learning.

Training data sets can be used to obtain the trained neural network 3406. For example, vehicle registration information and repair information can be used to applied to train the neural network of particular driving patterns of particular drivers. Previous product orders from customers can be used to determine color, size, or other aesthetic preferences for particular drivers.

As mentioned, the trained neural network 3406 can be constantly refined. For instance, the color preferences of a driver may change over time. In other examples, the favored route of the driver may also change. Advantageously, the approaches described herein are dynamic in that they provide the most up-to-date output from the trained neural network 3406 resulting in the most up-to-date and effective advertisements. For example, the trained neural network may be refined daily to account for the changing preferences of the driver.

It will be also appreciated that in the examples mentioned herein one neural network (or machine learning algorithm) is used. It will be understood, however, that multiple neural networks (or other combinations of machine learning algorithms) can also be used. In one particular example, a first trained neural network may produce the advertisement information 3408, a second trained neural network may produce the advertisement information 3410, and a third trained neural network may produce the advertisement information 3412 (all after receiving the input 3402). Such structure for the neural networks may allow the first, second, and third neural networks to operate in parallel advantageously further increasing operating speed and efficiency. In the case of using parallel neural networks, this arrangement results in the creation of a virtual neural network. When multiple neural networks are used, each can be used to receive and/or produce different types or formats of information. For example, one neural network may receive photos showing a particular driver to be sent an advertisement and produce information that will format an advertisement according to particular aesthetic preferences of the driver (e.g., color preferences or background music preferences of the driver). This structure of using multiple neural networks can be applied to any of the approaches described herein.

It will be realized that this is one example and that other formatting concerns or preferences of the driver can be incorporated into the advertisement. In addition, it will be appreciated that various ways or approaches can be used to bill and generate income for the advertisement. For example, the owner of the machine learning algorithms 3406 and control circuit 3405 can engage in a service that charges third parties a price based upon how many advertisements (for products or services offered by the third parties) are sent, when these are sent, a level of service (based upon driver information used), or the number of successful advertisements or advertisements responded to by drivers to mention a few examples.

Once a driver or other person is presented with the advertisement 3416, still other actions may occur. For example, the control circuit 3405 may track the driver's reaction to the advertisement 3416, including how long the driver has the advertisement open or is viewing the advertisement, whether the driver engages any interface features (e.g., presses keys or asks a question using a voice activated service). Such data may be collected by the control circuit and analyzed. This information can also, in aspects, be used to further train or refine any of the neural networks. In still other examples, reactions from other drivers of other vehicles can be selectively used to train the respective neural networks so that all drivers can benefit from the reactions of all other drivers. The owner of the machine learning algorithms 3406 may charge or bill third parties (selling products or services) for these enhancements or may charge the third parties for the information, which may be sent to the third parties.

In other aspects, feedback provided by the driver may include questions, concerns, or inquiries. These questions may be directly answered by the control circuit 3405 or may be used to further refine the neural networks. For example, the driver may express concern over the safety records of particular tires, and future advertisements may include sections that address these concerns, for example, showing safety testing results.

In other examples and as mentioned, the advertisement includes different portions, sub-areas, parts, features, or segments with information of different types. For example, the advertisement 3416 may include video, textual, and sound (e.g., music portions). These portions may be change over time and all portions may not change at the same time. For example, the textual portion of the advertisement 3416 may remain constant over time even as the background color or background music presented in the advertisement is changed by the neural networks, which are constantly being refined.

These approaches also provide the ability for a driver to select advertisements of interest based upon various factors and considerations. Drivers may enter preferences via a user electronic device that are received at the control circuit 3405. For example, some drivers may only wish to receive certain advertisements when they are at home, on certain days, under certain weather conditions, or when they are driving along certain routes. Sensors at a vehicle or at other locations may provide information as the driver operates the vehicle. Based upon this information, the control circuit 3405 selectively transmits the advertisements according to the preferences of the driver. As mentioned, advertisements can be triggered upon the occurrence of certain conditions at a vehicle (e.g., reaching a certain mileage on the odometer or reaching a certain tire pressure at a tire on the vehicle).

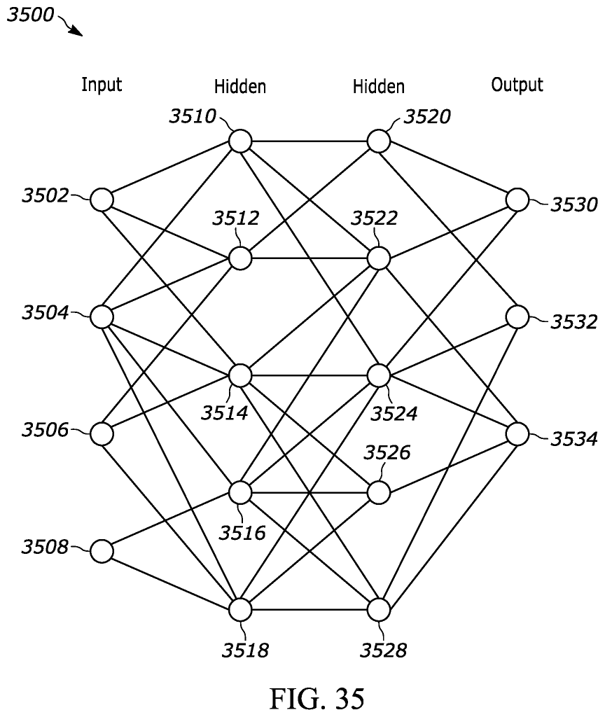

Referring now to FIG. 35, one example of a neural network 3500 is described. The neural network 3500 includes nodes 3502, 3504, 3506, and 3508 that form an input layer. The network 3500 includes nodes 3510, 3512, 3514, 3516, and 3518 that form a first hidden layer. The network 3500 includes nodes 3520, 3522, 3524, 3526, and 3528 that form a second hidden layer. The network 3500 includes nodes 3530, 3532, and 3534 that form an output layer.

Various connections are made between the various nodes. Each node receives a signal in the form of a real number and processes the signal. These outputs may be computed by a non-linear function based upon inputs to the nodes. Weights are assigned to the connections and these may be adjusted in a learning or training process. Inputs are applied to the nodes of the input layer, and these traverse through the network 3500 to produce outputs at the nodes 3530, 3532, and 3534 of the output layer.

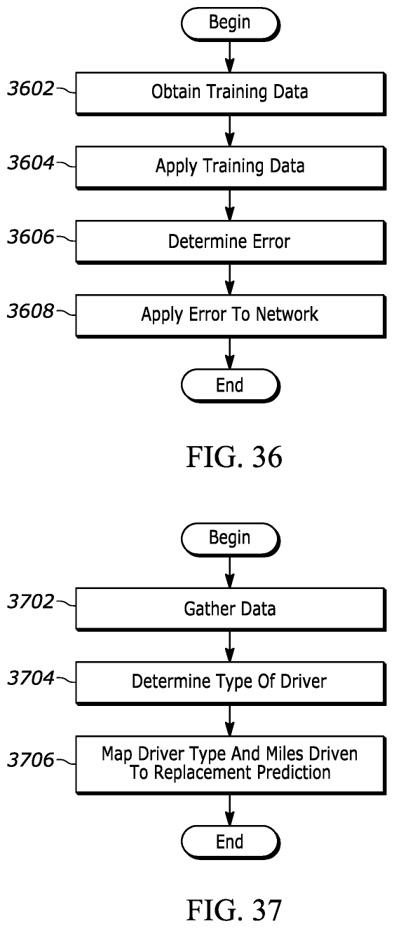

Referring now to FIG. 36, one example of a training or learning process is described. At step 3602, test or training data is obtained. The training data may be obtained and The training data may be selected from larger groups of training data based upon the quality, amount, sources, or cost of the training data to mention a few examples. selected from vehicles and may also include specifications for vehicle components such as tires. At step 3604, the training data is applied to the neural network that is to be trained. At step 3606, an error is determined as between the expected or desired output and the actual output. At step 3608, the error is applied to the network that is being trained. For example, the error may adjust weights in the neural network. This approach seeks to change the weights so that the next evaluation reduces the error. In examples, it is desired to minimize the error and a loss function is used to calculate the error or loss.

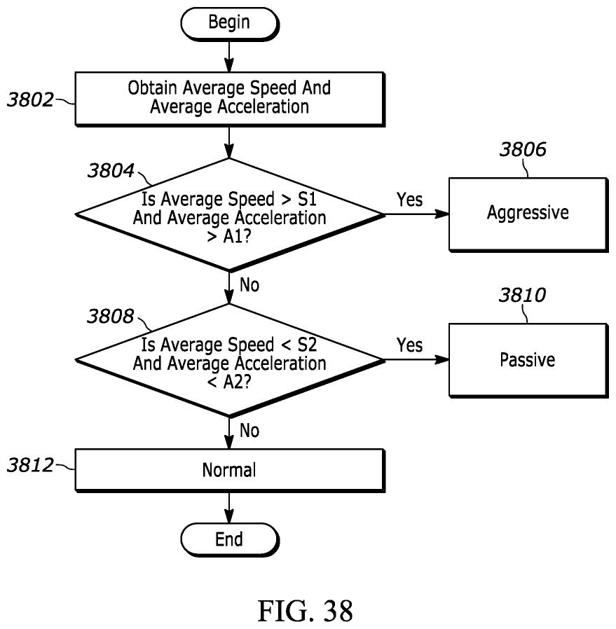

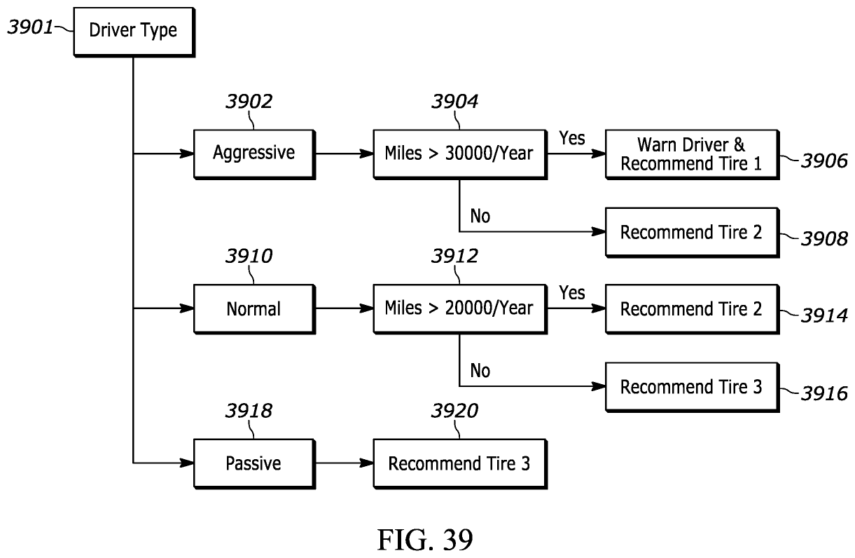

Referring now to FIG. 37, one example of an algorithmic approach for making a prediction based upon receiving and analyzing various types of data is described. It will be appreciated that this is one specific example of determining predictions, suggestions, recommendations, advertisements, or the like and that other examples are possible. For example, the types of values used and how these parameters are evaluated can vary. The determinations made can also change depending upon the needs of the user, the system, customers, and so forth. The approach of FIG. 37 utilizes algorithms described In FIG. 38 and FIG. 39.

The algorithms of FIG. 37, FIG. 38, and FIG. 39 may be implemented by any appropriate computer instructions that are executed on a processing device. The algorithms may also use different types of data structures such as mapping tables, lookup tables, linked lists, charts, or graphs to mention a few examples. It will also be understood that these examples form recommendations for vehicle tires, but that other products are services can also have recommendations made according to these and/or other algorithms. Additionally, other vehicle components such as braking systems or entertainment systems may have recommendations formed. These algorithms may be deployed at a central location, on a mobile device, at the vehicle, or at combinations of these locations.

Turning now to FIG. 37, at step 3702 data is gathered or obtained. In one example, this is vehicle data such as data from sensors of a vehicle or from other sensors disposed at other vehicles. This data may be stored and an average speed and an average acceleration for the driver obtained. The number of miles driven by the vehicle is also obtained. These values may be stored in any appropriate electronic memory storage device. In other aspects, data from produce or services models, or external data may also be obtained and used.

At step 3704, the type of driver or the driving style of the driver is determined. One algorithmic approach for determining the type of driver or the driving style of the driver is described with respect to FIG. 38. This approach determines whether the driver type or driver style is aggressive, normal, or passive and returns an answer at step 3704. It will be appreciated that these are three possible classifications and that other classifications are possible.

At step 3706, the driver type or driving style that has been determined at step 3704 is mapped, along with the average miles driven, to a prediction as to whether a tire replacement is needed. A recommendation as to the type of replacement tire is also made. In some examples, the prediction may be a prediction as to how long the tire will last (with an appropriate message or alert to the driver). In other examples, the recommendation may specify the brand and/or model of tire. In aspects, the algorithm of FIG. 39 may be used or called to determine the prediction and/or recommendation.

As a result of the prediction or recommendation made at step 3706, various actions may be taken. For example, advertisements may be created, alerts created and transmitted, device parameters changed, devices controlled, or any of the other actions described herein may be performed.

Referring now to FIG. 38, one example of an algorithmic approach to determining driver type or driving style is described. It will be appreciated that this is one example of such an approach and that other examples are possible. The algorithm of FIG. 38 is used or called by the algorithm of FIG. 37.

At step 3802, the average speed and average acceleration for the driver of the vehicle is obtained. The average speed may be determined by taking the average of multiple instantaneous speed readings from sensors on the vehicle and obtaining an average. The average acceleration may be determined by taking the average of multiple instantaneous average acceleration readings from sensors.

At step 3804, a determination is made as to whether the average speed is greater than S1 and the average acceleration is greater than A1. If the answer is affirmative, at step 3806 the driver type or driving style is determined to be aggressive. If the answer is negative, execution continues with step 3808.

At step 3803, a determination is made as to whether the average speed is less than S2 and the average acceleration is less than A1. If the answer is affirmative, at step 3810 the driver type or driving style is determined to be passive. If the answer is negative, execution continues with step 3812. If step 3812 is reached, the driver type or driving style is determined to be normal. The determination of driver type or driving style can then be used by the algorithm of FIG. 37.

It will be appreciated that the values for S1, S2, and A1 may be fixed or changeable. The values selected may be based upon speed and/or acceleration values previously found to result in excessive tire wear either by the driver or a larger group of drivers.

Referring now to FIG. 39, one example of an algorithmic approach for making a prediction, recommendation, or suggestion is described. This approach may include generation of other outputs such as control signals, alerts, or advertisements to mention a few examples. The algorithm of FIG. 39 is used or called by the algorithm of FIG. 37. The result produced by the algorithm of FIG. 39 may be a prediction that the tire needs to be replaced soon and/or a recommendation to as a tire brand and model to use. In this example, these brands and models are referred to as Tire 1, Tire 2, and Tire 3. Each of these different tires may be from a particular manufacturer and have characteristics, parameters, or features that favor or are suited to specific driving styles or driving types. Alerts and recommendations may be presented to customers on user electronic devices or on electronic devices fixed in the vehicle based upon the predictions.

At step 3901, the driver type or driving style is obtained and used to determine which of three execution paths to follow. If the determined type or style is aggressive, the execution path beginning with step 3902 is followed. If the driver type or style is determined to be normal, the execution path beginning with step 3910 is followed. If the driver type or style is determined to be passive, the execution path beginning with step 3918 is followed. Each of these paths is now described.

At step 3902, the driver type or style has been determined to be aggressive. At step 3904, it is determined whether the average number of miles driven is greater than 30000 per year. If the answer is affirmative, then at step 3906 a warning to the driver is made based upon a prediction that the tire needs to be changed and a recommendation to use Tire 1 is made. If the answer negative, at step 3908 a recommendation for the customer to purchase Tire 2 is made. It will be appreciated that the value of 30000 may be changed according to data describing when excessive tire wear occurs.

At step 3910, the driver type or style has been determined to be normal. At step 3912, it is determined whether the average number of miles driven is greater than 20000 per year. If the answer is affirmative, then at step 3914 a recommendation to use Tire 2 is made. If the answer negative, at step 3916 a recommendation for the customer to purchase Tire 3 is made. It will be appreciated that the value of 20000 may be changed according to data describing when excessive tire wear occurs.

At step 3918, the driver type or style has been determined to be passive. Next, at step 3920, a recommendation for the customer to purchase Tire 3 is made.

It will be appreciated that predictions may also include, consider, or utilize component parameters such as dimensions, test results, weights, or strengths. In the case of tires, test results might be considered in the recommendation. For example, a particular brand of tire might be recommended for an aggressive tire where test results show that this particular tire is suited for aggressive drivers.

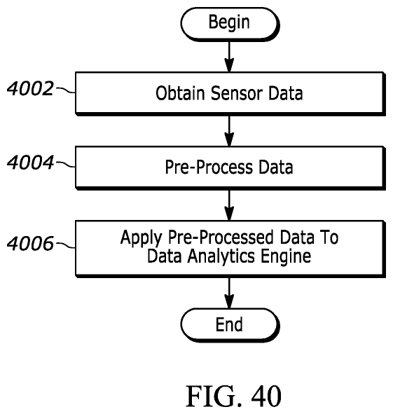

Referring now to FIG. 40, one example of a system that uses machine learning and pre-processing is described.

At step 4002, data from sensors is obtained. The sensors may be located at the vehicle and may include tire sensors, brake sensors, and so forth. The sensor data may be obtained from sensors at the driver's vehicle. The sensors may also be located at the vehicles of other drivers. In addition to sensor data, data regarding component specifications, test results, reviews, or other similar types of data.

At step 4004, pre-processing of the data is performed. In aspects, pre-processing filters and/or organizes the raw data from the various sensors into a more usable format, such as some optimized dataset stored in a local database. In one example, pre-processing includes data aggregation (e.g., consolidating voluminous data into a smaller dataset), data normalization (e.g., simplifying the data: I/O, high/low, etc.), and data categorization (e.g., organizing the data to perform quicker analysis). The pre-processing may be performed locally, for example in a vehicle, given the amount of data, but offloading the data to an external server at a central location for pre-processing is also possible. When the server is located at the central location, the server may pre-process data from multiple vehicles.

The pre-processing of data could include the definition of specific events to be detected, and determination of whether the detection of each event is based on data from a single sensor or multiple sensors. Specific events may be both normal events (e.g., successful startup of the vehicle engine) and abnormal events (e.g., electronic stability control activation due to tire slippage).

Pre-processing could also include the definition of algorithms and thresholds to be applied to the pre-processing, which may include rate calculations (e.g., first or second derivatives of the event magnitude or frequency over time), comparison of normal events to abnormal events, or other calculations that may be applied to the data from normal and abnormal events over time.

Pre-processing could additionally include optional identification of voluntary and assumed data, such as owner preferences for high-performance, speed-rated tires, or average driver performance as measured and aggregated across multiple owners of the same or similar vehicle in the same or similar geographic area or conditions.

Pre-processing could also include combining the results of the algorithms and thresholds results with the voluntary and assumed data, providing the input into the AI engine for identification of further correlations or trends that could be applicable to improved selection of future products, prognostics for failures or end-of-life, optimizations (such as for cost-benefit recommendations), or advice (such as recommendations for the driver or owner).

At step 4006, the pre-processed data is applied to the data analytics engine (described elsewhere herein), which makes a prediction or recommendation, generate an advertisement, or any of the other outputs as described elsewhere herein. The output of the data analytics engine can be utilized to perform various actions as described herein.

In the context of large amounts of vehicle and user data that is received by the data analytics engine, the output of the engine relates to performance characteristics of the product. In the case of a tire and in one example, all this data needs to be weighted, filtered and processed. The pre-processing may make it easier for the data analytics engine to make predictions, recommendations, and so forth.

For example, tire grip is based on g forces on the tire in the forward, back, right and left directions in different conditions and according to different driver inputs. The acceleration information can be read from an accelerometer in the car or in the tire pressure monitoring system (TPMS) sensor and correlated with tire slip to determine the coefficient of friction for static and dynamic conditions that the car and driver require. If the requirements exceed the tire's capability, then a tire with better grip in the wet, snow, dry, gravel and so forth is recommended by the data analytics engine. In aspects, the pre-processing is applied the available sensor information and the sensor information is weighted according to performance criteria for the particular component.

The example above can be applied to other products like gasoline by detecting knock to see of the driver is exceeding the performance capability of the engine and the octane rating of the fuel used. Other example products where these approaches could be applied include oil products where various information is processed including oil sensor information along with rpm, age, viscosity, the amount of dirt, soot and contaminants in the oil and so forth. The car battery could be monitored to determine if it is likely to fail soon based on the processing of aging information, voltage history, current draw, computed internal battery resistance and the output could be to replace the battery to avoid being stranded.

Once the pre-processing is complete, the pre-processed data can be applied to the data analytics engine. Various algorithms and machine learning approaches can be used to accomplish the pre-processing of data. For example, various types of data compression algorithms can be utilized to compress data. In other aspects, training data can also be pre-processed before being used to train a machine learning algorithm such as a neural network,

One or more embodiments of the application are described above. It should be noted that these and any other embodiments are exemplary and are intended to be illustrative of the application rather than limiting. While the application is widely applicable to various types of systems, a skilled person will recognize that it is impossible to include all of the possible embodiments and contexts of the application in this disclosure. Upon reading this disclosure, many alternative embodiments of the present application will be apparent to persons of ordinary skill in the art.

The previous description of the disclosed embodiments is provided to enable any person skilled in the art to make or use the present application. Various modifications to these embodiments will be readily apparent to those skilled in the art, and the generic principles defined herein may be applied to other embodiments without departing from the spirit or scope of the application. Thus, the present application is not intended to be limited to the embodiments shown herein but is to be accorded the widest scope consistent with the principles and novel features disclosed herein.

The benefits and advantages that may be provided by the present application have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations that follow those terms. Accordingly, a system, method, or other embodiment that comprises a set of elements is not limited to only those elements and may include other elements not expressly listed or inherent to the claimed embodiment.

While the present application has been described with reference to particular embodiments, it should be understood that the embodiments are illustrative and that the scope of the application is not limited to these embodiments. Many variations, modifications, additions and improvements to the embodiments described above are possible. It is contemplated that these variations, modifications, additions and improvements fall within the scope of the application as detailed within the following claims.

What is claimed is:

1. A system for generating advertisements targeted to specific vehicles or drivers, the system comprising:
a vehicle driven by a driver, the vehicle including a plurality of sensors, the sensors configured to obtain data, the data describing conditions of vehicle components of the vehicle and defining an individual driving pattern of the driver;
an electronic memory that includes data representing a trained neural network that has been trained to produce advertisements or information used in advertisements, the training being made according to the data, the advertisements being personalized to the individual driving pattern of the driver as defined by the data;
a control circuit coupled to the trained neural network in the electronic memory;
wherein the trained neural network is subsequently deployed and the control circuit is configured to subsequently:
receive an advertisement generation request for the driver and apply the advertisement generation request to the trained neural network, the applying yielding advertisement information associated with the driver and considering the driving patterns of the driver;
form and send an advertisement incorporating the advertising information to the driver to display on a user interface;
receive a response from the driver, the response directing or causing the control circuit to take an action the action being one or more of:
determine additional information needed by the driver and display the additional information to the driver via the user interface;
send a control signal to a selected vehicle component to control or change an operating parameter of the vehicle component;
recommend additional products or services to the driver based upon the response and display the additional products or services to the driver via the user interface;
form a customer order for a part to be placed in the vehicle, the order transmitted to a manufacturer causing the part to be manufactured by a manufacturer.

2. The system of claim 1, wherein the driving pattern comprises one or more of an average trip time or length of the driver, or an average speed or distance traveled by the driver.

3. The system of claim 1, wherein the driver after purchasing the product provides verified purchaser reviews.

4. The system of claim 1, wherein the manufacturer of a product offers or contracts to pay advertising revenue to the operator of the neural network.

5. The system of claim 1, wherein the control circuit uses the advertising information to generate top choices of product or a service recommendation.

6. The system of claim 1, wherein the top choices are reduced to a single product recommendation.

7. The system of claim 1, wherein the trained neural network is refined to reflect the continued changes to the driving pattern of the driver.

8. The system of claim 1 wherein the neural network is deployed at a central location.

9. The system of claim 1, wherein the data from the sensors includes one or more of weather data, road conditions, personal driving style data, vehicle chassis conditions, wear indicators for several parts.

10. The system of claim 1, wherein the sensors comprise one or more of radar, LIDAR sensors, cameras, ultrasonic sensors, GNSS sensors, accelerometers, ABS/ESC sensors, and vehicle environmental sensors.

11. The system of claim 1, wherein the advertisement generation request is from a manufacturer, a part supplier, or a retailer.

12. A method for generating advertisements targeted to specific vehicles or drivers, the method comprising:
obtaining, from a plurality of sensors of a vehicle, data describing conditions of components of a vehicle and defining an individual driving pattern of a driver of the vehicle;
training a neural network to create a trained neural network, the trained neural network effective to produce advertisements or information used in advertisements, the training being made according to the data, the advertisements being personalized to the individual driving pattern of the driver as defined by the data;
subsequently deploying the trained neural network;
operating a control circuit to perform operations, the operations including:
receiving an advertisement generation request for the driver and applying the advertisement generation request to the trained neural network, the applying yielding advertisement information associated with the driver and considering the driving patterns of the driver;
forming and sending an advertisement incorporating the advertising information to the driver to display on a user interface;
receiving a response from the driver, the response directing or causing the control circuit to take an action the action being one or more of:
determining additional information needed by the driver and display the additional information to the driver via the user interface;
sending a control signal to a selected vehicle component of the vehicle to control or change an operating parameter of the vehicle component of the vehicle;
recommending additional products or services to the driver based upon the response and display the additional products or services to the driver via the user interface; and
forming a customer order for a part to be placed in or utilized by the vehicle, the order transmitted to a manufacturer causing the part to be manufactured by a manufacturer.

13. The method of claim 12, wherein the driving pattern comprises one or more of an average trip time or length of the driver, or an average speed or distance traveled by the driver.

14. The method of claim 12, further comprising, by the driver after purchasing the product, providing verified purchaser reviews.

15. The method of claim 12, offering or contracting by the manufacturer of a product to pay advertising revenue to the operator of the neural network.

16. The method of claim 12, further comprising, by the control circuit, generating top choices of product or a service recommendation using the advertising information.

17. The method of claim 16, wherein the top choices are reduced to a single product recommendation by the control circuit.

18. The method of claim 12, further comprising refining the trained neural network to reflect the continued changes to the driving pattern of the driver.

19. The method of claim 12, wherein the neural network is deployed at a central location.

20. The method of claim 12, wherein the data from the sensors includes one or more of weather data, road conditions, personal driving style data, vehicle chassis conditions, wear indicators for several parts.

21. The method of claim 12, wherein the sensors comprise one or more of radar, LIDAR sensors, cameras, ultrasonic sensors, GNSS sensors, accelerometers, ABS/ESC sensors, and vehicle environmental sensors.

22. The method of claim 12, wherein the advertisement generation request is from a manufacturer, a part supplier, or a retailer.

23. The method of claim 12, wherein the steps are claimed in a patent and the patent is asserted in a patent infringement action.
